(19) United States
(12) Patent Application Publication
(10) Pub. No.: US 2011/0155564 A1
(43) Pub. Date: Jun. 30, 2011

(54) SYSTEM FOR ELECTROCOAGULATIVELY REMOVING CONTAMINANTS FROM CONTAMINATED WATER

(75) Inventor: Semyon Oifman, Holon (IL)

(73) Assignee: P2W LTD., Rishon-LeZion (IL)

(21) Appl. No.: 12/997,083

(22) PCT Filed: Jun. 9, 2009
(86) PCT No.: PCT/IL09/00575

§ 371 Date: Dec. 9, 2010

Related U.S. Application Data
(60) Provisional application No. 61/129,174, filed on Jun. 9, 2008.

(51) Int. Cl. C02F 1/463; C25B 9/00; B01D 21/02

(52) U.S. Cl. 204/230.2; 204/275.1; 210/255

(57) ABSTRACT

System (10) for electrocoagulatively removing contaminants from contaminated water (13), electrocoagulation reactor unit (16), and sedimentation column (302). Electrocoagulation reactor unit (16) includes reactor housing assembly (102) having: lower pair of integrally configured, and complementary upper pair of removably and replaceably configured, electrode positioning, spacing, holding elements, and, two wall electrode or electrode wall electrocoagulatively unreactive zones, each having an interior face of a side wall configured flush against and directly contacting adjacent, nearest neighboring, electrode face, for preventing water flowing and making contact therebetween. Sedimentation column (302) includes first sediments-water separator assembly having a water/sediments distributor assembly, and second sediments water separator assembly having downward flow multi-conduit assembly. Invention overcomes design, construction, and operation, limitations of electrocoagulation reactor housing assemblies, and, of ‘gravity type’ sedimentation, settling, or [water] clarification, columns. Applicable for removing heavy metal, or/and non-metal, contaminants from water produced by a wide variety of different high volume throughput commercial scale industrial processes.

### FIELD OF THE INVENTION

The present invention relates to electrocoagulatively, removing contaminants from contaminated water, and more particularly, to a system for electrocoagulatively removing contaminants from contaminated water. The present invention also relates particularly to two main components of the electrocoagulative water contaminant removal system, being an electrocoagulation reactor unit, and a (‘gravity type’, primary) sedimentation column.

The present invention is particularly applicable for electrocoagulatively removing contaminants from contaminated water produced during a high volume throughput (for example, on the order of at least about 1000 liters per hour (l/hr) [1 cubic meter per hour (m³/hr)]) commercial scale industrial process, involving, for example, metallic electro-etching, plating, or coating, of materials or components; manufacturing of electrical, electronic, or semiconductor, materials or components; mining or/and processing of minerals or metals; or, manufacturing or/and processing of pulp or paper. The present invention, although particularly directed to, and applicable for, removing heavy metal type contaminants composed of or including heavy metals (such as chromium, copper, nickel, zinc, tin, antimony, aluminum, lead, manganese, cobalt, tungsten, and cadmium) from contaminated water, is also directed to, and applicable for, removing non-metallic type contaminants composed of or including non-metals (such as organic chemical species [e.g., hydrocarbons—oils, fats, greases] or/and biological species [e.g., microorganisms—bacteria]) from contaminated water. The present invention is readily commercially applicable, practical, and economically feasible to implement.

### BACKGROUND OF THE INVENTION

Theories, principles, and practices thereof, and, related and associated applications and subjects thereof, relating to electrochemical and electrolytic techniques, in general, and electrocoagulative techniques, in particular, of treating, purifying, or removing contaminants (particularly, heavy metals) from, water (particularly, wastewater), and relating to electrochemistry, electrolysis, electrocoagulation, coagulation, electroflocculation, flocculation (flake formation), precipitation, aggregation, agglomeration, clumping, water clarification, sedimentation, settling, and sludge formation, are well known and taught about in scientific, technical, and patent, literature, and currently practiced in a wide variety of numerous different fields and areas of technology. For the purpose of establishing the scope, meaning, and fields or areas of application, of the present invention, the following background includes selected ‘representative’ definitions and exemplary usages of terminology which are relevant to, and used for, disclosing the present invention.

Contaminated Water, and Contaminants therein, Particularly Heavy Metals

The phrase ‘contaminated water’, as used herein, generally refers to water which contains any combination of any number of a wide variety of different types, kinds, or forms, of contaminants, in a form of an aqueous solution, colloid, suspension, or emulsion. In general, the (water) contaminants are composed of inorganic or/and organic chemical species in the forms of (metallic or/and non-metallic) elements, ions, radicals, or/and compounds. The contaminants may include at least one type, kind, or form, of a ‘heavy metal specie’, where the phrase ‘heavy metal specie’, as used herein, generally refers to a heavy metal (such as chromium, copper, nickel, zinc, tin, antimony, lead, manganese, or cadmium) in the form of a free element (i.e., a free elemental form), a free ion (i.e., a free positively charged ion or cation), or/and in the form of a compound, radical, or/and ion (such as an inorganic or organic complex compound, radical, or/and ion, containing at least one heavy metal atom). The contaminants may alternatively, or additionally, include at least one type, kind, or form, of a non-metal, such as an organic chemical specie (e.g., a hydrocarbon—oil, fat, or grease) or/and a biological specie (e.g., a microorganism—bacterium). The phrase ‘contaminated water’, as used herein, is considered equivalent to, and synonymous with, the term ‘wastewater’ and the phrase ‘waste water’ (i.e., water containing waste(s)), the phrase ‘impure water’ (i.e., water containing impurity(ies)), and the phrase ‘polluted water’ (i.e., water containing pollutant(s)).

It is well known that essentially any contaminant (particularly, a heavy metal specie or heavy metal type contaminant), at sufficiently high concentration, is toxic or potentially toxic inside of living organisms (humans, animals, plants). Governmental environmental and health regulatory agencies in most countries throughout the world typically have standard requirements limiting the levels of many types of contaminants (particularly, heavy metal species or heavy metal type contaminants) in primary water sources (such as ground water, surface water, and above-surface water, types of reservoirs) which supply water for drinking, bathing, agricultural, and other direct or indirect uses by living organisms, as well as in secondary water sources (such as industrial or commercial, and residential, types of wastewater) which actively or potentially, directly or indirectly, come into contact with primary water sources. For many types of contaminants (particularly, heavy metal species or heavy metal type contaminants), such limiting levels are as low as on the order of 1 milligram per liter (mg/l) [1 part per million (ppm)], and may even be as low as on the order of 1 microgram per liter (μg/l) [1 part per billion (ppb)]. Accordingly, any such primary or secondary water source should have a total concentration of contaminants (particularly, heavy metal species or heavy metal type contaminants) within the limiting levels established by governmental environmental and health regulatory agencies. As a result, such primary and secondary water sources need to be monitored for contaminants (particularly, heavy metal species or heavy metal type contaminants), and if necessary, subjected to treatment or purification for removing the contaminants (particularly, heavy metal species or heavy metal type contaminants), so that the treated or purified water contains contaminants (particularly, heavy metal species or heavy metal type contaminants) within acceptable established levels, before such water is directly or indirectly used by living organisms.

Electrocoagulation (Electroflocculation), and Using thereof for Removing Contaminants from Contaminated Water

In a most basic and general manner, electrocoagulation (commonly abbreviated as EC) may be defined as an electrochemical (electrolytic) process whereby solid (particulate), solid-like (particulate-like), or even emulsive, matter in a solution, colloid, suspension, or emulsion, type of aqueous medium, is electrochemically (electrolytically) coagulated, flocculated (flaked), precipitated, aggregated, agglomerated, or/and clumped, via any number and types of processes and mechanisms based on, or involving, coagulation, flocculation (flake formation), precipitation, aggregation, agglomeration, or/and clumping, respectively, for producing various different types, kinds, and forms, of solid and solid-like electrocoagulation reaction products [i.e., coagulates, flocculates (flocs or flakes), precipitates, aggregates (aggregations), agglomerates (agglomerations), or/and clumps), respectively] in the aqueous medium. The solid (particulate), solid-like (particulate-like), or emulsive, matter can be essentially any type or kind originating from essentially any source. The solid (particulate), solid-like (particulate-like), or emulsive, matter can be inorganic or/and organic matter which is obtained, derived, or originating from, naturally existing (mineral or biological types of) non-living matter or living matter, or synthetically manufactured. Depending upon the actual technical context, the term ‘electrocoagulation’ is often also referred to as, and considered synonymous with, the term ‘electroflocculation’ (i.e., electrochemical flocculation). Hereinafter, for convenience, and brevity, only the term ‘electrocoagulation’ is used.

There are extensive teachings [e.g., 1-31] of electrocoagulation, and of using electrocoagulation for removing contaminants from contaminated water. Selected examples of such teachings are provided herein.

Wikipedia® [1] includes the following selected sections in their web page entry for ‘electrocoagulation’.

“Electrocoagulation is based upon scientific principles involving the responses of water-based contaminants to strong electric fields and electrically induced oxidation and reduction reactions. The process is able to remove over 99% of some heavy cations, and also appears to be able to electrocute microorganisms in the water. Colloids are charged and precipitated. Significant amounts of other ions and colloids are also removed. Oily emulsions are broken”.

“Treatment of wastewater by EC (electrocoagulation) has been practiced for most of the 20th century with limited success and popularity. In the last decade, this technology has been increasingly used in South America and Europe for treatment of industrial wastewater containing metals. It has also been noted that in North America EC has been used primarily to treat wastewater from pulp and paper industries, mining and metal-processing industries. In addition, EC has been applied to treat water containing foodstuff waste, oil wastes, dyes, suspended particles, chemical and mechanical polishing waste, organic matter from landfill leachates, defluorination of water, synthetic detergent effluents, mine wastes and heavy metal containing solution”.

“In the EC process, the coagulant is generated in situ by electrolytic oxidation of an appropriate anode material. In this process, charged ionic species—metals or otherwise—are removed from wastewater by allowing it to react with an ion having an opposite charge, or with floc of metallic hydroxides generated within the effluent”.

“The technology removes metals, colloidal solids and particles, and soluble inorganic pollutants from aqueous media by introducing highly charged polymeric metal hydroxide species. These species neutralize the electrostatic charges on suspended solids and oil droplets to facilitate agglomeration or coagulation and resultant separation from the aqueous phase. The treatment prompts the precipitation of certain metals and salts”.

“During electrolysis, the positive side undergoes anodic reactions, while on the negative side, cathodic reactions are encountered. Consumable metal plates, such as iron or aluminum, are usually used as sacrificial electrodes to continuously produce ions in the water. The released ions neutralize the charges of the particles and thereby initiate coagulation. The released ions remove undesirable contaminants either by chemical reaction and precipitation, or by causing the colloidal materials to coalesce, which can then be removed by flotation. In addition, as water containing colloidal particulates, oils, or other contaminants move through the applied electric field, there may be ionization, electrolysis, hydrolysis, and free-radical formation which can alter the physical and chemical properties of water and contaminants. As a result, the reactive and excited state causes contaminants to be released from the water and destroyed or made less soluble”.

Powell Water Systems, Inc. (Colorado, USA) [2] includes the following selected sections in their web page section link entitled: “Electrocoagulation Technology”.

“Electrocoagulation is the process of destabilizing suspended, emulsified or dissolved contaminants in an aqueous medium by introducing an electrical current into the medium. The electrical current provides the electromotive force to drive the chemical reactions. When reactions are driven or forced, the elements or compounds will approach the most stable state. Generally, this state of stability produces a solid that is either less colloidal and less emulsified (or soluble) than the compound at equilibrium values. As this occurs, the contaminants form hydrophobic entities that precipitate and can easily be removed by a number of secondary separation techniques”.

“In the electrocoagulation process, the electrical current is introduced into water via parallel plates constructed of various metals that are selected to optimize the removal process. The two most common plate materials are iron and aluminum. In accordance with Faraday's Law, metal ions will be split off or sacrificed into the liquid medium. These metal ions tend to form metal oxides that electromechanically attract to the contaminants that have been destabilized”.

Renaud, C. P., et al. [3] introduce and describe electrocoagulation and electroflocculation as follows.

“The art of electrocoagulation and electroflocculation has received much attention in the last few years, and may be perceived as ‘new’ technology. In truth, the idea has been around for over one hundred years. Quite simply, electrocoagulation and electroflocculation are means of de-stabilising (coagulating) and agglomerating (flocculating) charged colloidal suspensions using electricity and a consumable electrode. One of the first recorded trials was performed in London in 1889; the technology used there was revived in Japan in the 1990s. One of the first patents was awarded in the United States in the early years of the twentieth century, but the technology was abandoned due to high operating costs. Further work has been done since, with a myriad of reactors, cells, processes, patents, etc., being produced, mostly with limited applicability or purely academic results”.

Robinson [4] distinguishes between electroflocculation and electrocoagulation as follows.

“Electroflocculation uses sacrificial electrodes to generate the coagulating agent, but also uses the bubbles liberated at the electrodes to float the contaminants to the surface. Electrocoagulation also involves the use of sacrificial electrodes to generate the coagulating agent—usually aluminum or iron ions. Once the water has been treated, it is either filtered, allowed to settle or sent to a gas or air flotation unit to remove the contaminants”.

Morkovsky, et al. [5, 6] introduce and describe electrocoagulation as follows.

“Wastewater, such as wastewater from factories or manufacturing plants, must be treated for contaminants before it is discharged into the environment. Water for use in industrial or other manufacturing process often requires treatment before use to alter its chemical or physical characteristics. Electrocoagulation is an electrochemical process that simultaneously removes heavy metals, suspended solids, organic and other contaminates from water using electricity instead of expensive chemical reagents. Electrocoagulation was first used to treat bilge water from ships. The Electrocoagulation process passes contaminated water between metal plates charged with direct current”.

Stephenson, et al. [7] introduce and describe electrocoagulation as follows.

“While it was known that the purification of waste streams, and in particular the coagulation of contaminants without the addition of chemicals, could be accomplished through electrolytic treatment in a process called electrocoagulation, the wide range of contaminants, varying contaminant concentrations and large and variable volumes of wastewater in the industrial waste streams generally discouraged its use. However, patents directed to electrolytic treatment apparatuses, methods and systems can be found dating back to the early part of this century. Electrocoagulation is the process of de-stabilizing suspended, emulsified or dissolved contaminants in an aqueous medium by introducing an electrical current into the medium. Electrocoagulation generally takes place inside a substantially sealed treatment chamber, where the impurities are coagulated out of the aqueous medium”.

Arnaud [8, 9] introduces and describes electrocoagulation as follows.

“Many attempts using various methods have been made to process wastewater on the sites where it is generated. Previous attempts to remove metals from wastewater have included electrocoagulation (a process where iron or aluminum plates, configured as sets of cascaded electrodes, are consumed by electrolysis as waste water passes over them) systems. It is known that typical electrocoagulation reactors employ electrodes of non-hazardous metals, such as iron (Fe⁺⁺⁺) and aluminum (Al⁺⁺⁺), that go into solution. Wastewater having hazardous metals is passed between the electrodes and a current is applied to the electrodes. The electrodes then form positive ions that can replace the ions of hazardous metals in compounds that keep them in-solution, so both the hazardous and non-hazardous metals can precipitate together (known as adsorption and co-precipitation). In this way, the metals are separated from the wastewater as solids”.

Berrak, A., et al. [10] introduce and describe electrocoagulation as follows.

“Electrocoagulation is a process based on scientific principles in which contaminants from the effluent are treated with strong electrical fields, thus inducing oxidation and reduction reactions. This process can remove more than 99 percent of certain heavy metal cations. In addition, the electrical field that is applied makes it possible, under certain conditions, to obtain a bactericidal effect. The process also permits to precipitate charged colloids and to remove important quantities of other ions, colloids and emulsions.

Although the electrocoagulation mechanism is much like that involving chemical coagulation, the cationic species that are responsible for neutralizing the surface of the charges and the characteristics of the electrocoagulated flocs differ in each of these processes. An electrocoagulated floc has a tendency to contain less bound water, it is more resistant against shearing and can be more easily filtered. Electrocoagulation is often capable of neutralizing ions and particle charges, thus allowing contaminants and polluting material to precipitate. It is thus possible to reduce the contaminant content to concentrations lower than those that can be reached via chemical precipitation processes. At the same time, it is sometimes possible to replace and/or to reduce the use of costly chemical agents such as polymers or metallic salts”.

Gavrel, et al. [11] introduce and describe electrocoagulation as follows.

“Electrocoagulation is a process by which electrolysis is combined with precipitation and flocculation to remove contaminates from wastewater. In this process, an electric current is used to neutralize, reduce and/or oxidize ionic, particulate or other dissolved species and contaminates, thereby allowing such contaminants to be precipitated and removed from stable suspensions and emulsions, such as in wastewater fluids. The electric current (voltage) provides the electromotive force required to drive the chemical reactions. The reactor utilized in the process contains a series of substantially parallel electrolytic plates or electrodes through which the wastewater to be treated travels in a serpentine path while being exposed to a strong electric field or voltage.

The electromotive force present in the reactor overcomes the Stem's forces disrupting the outer electron orbitals of dissolved ionic species and neutralizes colloidal particulate charges resulting in the destabilization of contaminants. The principal cathodic reaction is the reduction of hydrogen ion to hydrogen gas and the reduction of the valence state of some dissolved species. The anode sacrifices metallic ions into solution in accordance with Faraday's Law and liberates oxygen gas. The newly formed compounds may be precipitated as acid resistant metallic oxide complexes that may be agglomerated or flocculated and removed by conventional liquid-solids separation methodologies”.

Denton, M. S. [12] describes electrocoagulation as follows (in the context of the disclosed invention).

“The electro-coagulation (EC) process of the invention works on an electricity-based technology that passes an electric current through radioactive waste waters. Thus, electro-coagulation utilizes electrical direct current (DC) to provide cations from the sacrificial metal electrode ions (e.g., Fe or Al) that agglomerate and thereby precipitate out undesirable contaminates, including dissolved metals and non-metals, e.g., antimony (Sb). The electrical DC current is introduced into the aqueous feed stream, for example, via parallel plates constructed of the sacrificial metal of choice. This process avoids the use of undesirable chemical additions (e.g., ferric chloride).

Moreover, the anode and cathode will hydrolyze water molecules, liberating oxygen and hydrogen, respectively, as tiny bubbles, the latter combining with many of the dissolved ions in the water to form insoluble oxides. The oxygen and hydrogen also will cause small, light particles to float and flocculate (e.g., oils and greases) so that they can also be skimmed off or filtered out. Some of these lighter particles are biological particles such as bacteria that have been destroyed by electro-osmotic shock.

In addition to radionuclides, the waste waters may be contaminated by one or more of heavy metals, colloids, clay, dirt, surfactants, cleaners, oils, greases, biologicals, and the like. As these contaminated waste waters are passed through one or more EC cells, the following four treatment reactions occur:

1. Coagulation—ions, colloids and suspended solids will remain suspended indefinitely in solution due to their like charges, which are usually negative. Thus, they repel each other and do not allow coagulation or floccing. As contaminated water passes through the cell assembly, DC power is applied continuously, or is pulsed, to the cell electrodes. Metallic ions from the positive cell electrodes (anodes) slough off and provide bridging seeds to the suspended solids and other contaminates present. Only as much electrode seed material is supplied as there are dissolved, colloidal and/or suspended solids present, thus controlling the solids addition. The metallic seed ions cause the charge of suspended or dissolved solids, colloids, oils and greases, and the like, to be neutralized. This charge neutralization causes the contaminants to coagulate, or floc, so that they become large enough to settle or float or be filtered by standard filtration media, ultra-filtration (UF), or reverse osmosis (RO), or, if magnetic, by electro-magnetic filtration (EMF) or High Gradient Magnetic Separation (HGMS) filtration. This coagulation process does not require the addition of chemicals with the exception of those for adjusting the pH or conductivity, if required.

2. Oxidation—as waste water contaminated by heavy and/or radioactive metals is passed through the EC cell(s), the metals are reduced to an oxide. The metal ions are thereby changed from a dissolved state to a suspended state and then are precipitated from the water.

3. Aeration—a natural byproduct of this EC process is aeration. No air or any other gases need to be injected into the process, as the dissociation products of water form tiny bubbles giving the coagulated contaminants buoyancy. Thus, after treatment of the waste water, oils and greases therein can either be skimmed off, or re-mixed and settled or filtered with the rest of the coagulated sludge.

4. Biologicals—a further advantage of this EC Process is that it is a natural biocidal process because it ruptures microorganisms and the like by electro-osmotic shock”.

Current Significant Problems or Limitations of Electrocoagulatively Removing Contaminants from Contaminated Water

Despite the plethora of extensive teachings of electrocoagulatively removing contaminants from contaminated water, there currently still exist significant problems or limitations thereof, particularly, with respect to commercial applicability, practicality, or/and economical feasibility of implementation, especially for a high volume throughput (for example, on the order of at least about 1000 liters per hour (l/hr) [1 cubic meter per hour (m³/hr)]) commercial scale industrial process, involving, for example, metallic electro-etching, plating, or coating, of materials or components; manufacturing of electrical, electronic, or semiconductor, materials or components; mining or/and processing of minerals or metals; or, manufacturing or/and processing of pulp or paper.

Of the many possible significant problems or limitations associated with current teachings of electrocoagulatively removing contaminants from contaminated water, the scope, and fields or areas of application, of the present invention, are directed to appropriately addressing, and overcoming, several significant problems or limitations relating to design, construction, and operation, of and within an electrocoagulation reactor housing assembly included in an electrocoagulation reactor unit, and, of and within a ‘gravity-type’ sedimentation, settling, or [water] clarification, column, of an overall electrocoagulative water contaminant removal system. Specifically, three significant problems or limitations associated with current teachings of electrocoagulatively removing contaminants from contaminated water, which are appropriately addressed and overcome by the present invention, relate to: (1) impractical or/and process interfering configurations of positioning, spacing, and holding electrodes inside an electrocoagulation reactor housing assembly, (2) existence of electrocoagulatively unreactive zones inside an electrocoagulation reactor housing assembly (containing electrodes), and (3) inefficient structure and operation (limited separation performance, efficiency) of a ‘gravity-type’ sedimentation, settling, or [water] clarification, column. Each of these three significant limitations is described as follows.

(1) Impractical or/and Process Interfering Configurations of Positioning, Spacing, and Holding Electrodes Inside an Electrocoagulation Reactor Housing Assembly

The first significant problem or limitation relates to impractical or/and process interfering configurations of positioning, spacing, and holding electrodes inside an electrocoagulation reactor housing assembly included in a more encompassing electrocoagulation reactor unit. The first significant problem or limitation particularly pertains to those types or kinds of electrocoagulative water removal systems wherein the electrocoagulation reactor housing assembly is configured and functions for containing a plurality of plate, slab, or sheet, type shaped electrodes which are configured or positioned vertically [i.e., with electrode faces vertically lined up in parallel from one (e.g., left or right) end side wall to an opposite (e.g., right or left, respectively) end side wall], or horizontally [i.e., with electrode faces horizontally stacked in parallel from the top end wall to the bottom end wall]. Inside such types or kinds of electrocoagulative water removal systems, water flows and circulates, and contacts the electrodes, throughout the region (herein, briefly and generally referred to as the ‘water flowing and contacting region’) wherein take place the various electrocoagulation reactions and associated physicochemical processes, inside the electrocoagulation reactor housing assembly (containing electrodes).

Inside the preceding described types or kinds of electrocoagulative water removal systems, there are currently two well known main types of configurations, i.e., a groove type configuration, and a spacer type configuration, which are designed, constructed, and used for positioning, spacing, and holding electrodes inside the electrocoagulation reactor housing assembly of the electrocoagulation reactor unit. Each type of configuration is briefly described, along with problems or limitations thereof.

### Groove Type Configuration

The ‘groove type configuration’ is based on having a number of parallel and oppositely positioned and facing ‘paired’ non-conducting grooves (i.e., walled channels) which are (permanently or immovably) configured within or protruding from, and extending along (i.e., as part of), the inner walls of the electrocoagulation reactor housing assembly, where each electrode is positioned and held by a single pair of grooves. Each non-conducting groove (walled channel) is (permanently or immovably) configured within or protruding from, and vertically or horizontally (according to a respective vertical or horizontal configuration or positioning of the electrodes) extends along most of the respective height or width of an inner wall of the electrocoagulation reactor housing assembly. Thus, according to at least the number of electrodes which are to be positioned, spaced, and held inside the electrocoagulation reactor housing assembly, there is designed and constructed a corresponding number of vertically or horizontally extending parallel and oppositely positioned and facing ‘paired’ non-conducting grooves, which are (permanently or immovably) configured or positioned vertically [i.e., for positioning, spacing, and holding electrodes with electrode faces vertically lined up in parallel from one (e.g., left or right) end side wall to an opposite (e.g., right or left, respectively) end side wall], or horizontally [i.e., for positioning, spacing, and holding electrodes with electrode faces horizontally stacked in parallel from the top end wall to the bottom end wall], respectively, within the electrocoagulation reactor housing assembly. Types, kinds, forms, of materials of construction, geometrical shape and size dimensions, and, number, of the grooves can widely vary, and are selected according to a particular design, construction, and intended operation, of the electrodes, of the electrocoagulation reactor housing assembly, and of the more encompassing electrocoagulation reactor unit.

For the ‘groove type configuration’, a well known significant problem or limitation is based on the phenomenon that during routine operation of the electrocoagulation reactor unit, a portion of the various different types, kinds, and forms, of solid (particulate), solid-like (particulate-like), or even emulsive, matter of the contaminated water, or/and of the various different types, kinds, and forms, of solid and solid-like electrocoagulation reaction products [i.e., coagulates, flocculates (flocs or flakes), precipitates, aggregates (aggregations), agglomerates (agglomerations), or/and clumps)] of the electrocoagulatively treated contaminated water, which flow and circulate, and contact the electrodes, throughout the inside of the electrocoagulation reactor housing assembly, and which are involved in the various electrocoagulation processes taking place therein, gets stuck or/and adheres, accumulates, and remains lodged along the groove walls which are (permanently or immovably) configured within or protruding from, and extending along, the inner walls of the electrocoagulation reactor housing assembly.

Such phenomenon and consequent problem or limitation, make it exceptionally difficult, impractical, or/and economically unfeasible, to maintain (i.e., clean, remove, replace, etc.) ‘individual’ electrodes of the electrode set inside the electrocoagulation reactor housing assembly. Such phenomenon, also, undesirably perturbs and interferes with the flow field and related fluid flow properties, characteristics, and behavior of the contaminated water which will be, is, or/and has been, electrocoagulatively treated inside the electrocoagulation reactor housing assembly of the electrocoagulation reactor unit. This additional interfering type of phenomenon translates into lower efficiency and less than optimal behavior and performance of the electrocoagulation reactor unit for electrocoagulatively removing contaminants from the contaminated water.

### Spacer Type Configuration

The ‘spacer type configuration’ is based on having a number of non-conducting insulating spacers or separating elements positioned (sandwiched) in between the electrodes located at and extending along the inner walls of the electrocoagulation reactor housing assembly. Specifically, a single non-conducting insulating spacer or separating element is positioned (sandwiched) in between each pair of two adjacent, nearest-neighboring, parallel and oppositely facing, and oppositely charged, faces (surfaces) of a respective pair of two adjacent, nearest-neighboring, parallel and oppositely facing, (monopolar-monopolar, monopolar-bipolar, or bipolar-bipolar) electrodes. The entire set of electrodes and insulating spacers or separating elements positioned therebetween are typically supported or held by a non-conducting electrode-spacer supporting element (e.g., a rod, tube, or beam). The non-conducting electrode-spacer supporting element passes through a hole configured in the upper portion of each electrode and through a corresponding hole configured in each spacer or separating element, and extends horizontally [i.e., for holding electrodes with electrode faces horizontally lined up in parallel from one (e.g., left or right) end side wall to an opposite (e.g., right or left, respectively) end side wall], or vertically [i.e., for holding electrodes with electrode faces vertically stacked in parallel from the top end wall to the bottom end wall], respectively, within the electrocoagulation reactor housing assembly. Types, kinds, forms, of materials of construction, geometrical shape and size dimensions, and, number, of the non-conducting insulating spacers or separating elements, and of the non-conducting electrode-spacer supporting element, can widely vary, and are selected according to a particular design, construction, and intended operation, of the electrodes, of the electrocoagulation reactor housing assembly, and of the more encompassing electrocoagulation reactor unit.

For the ‘spacer type configuration’, a well known significant problem or limitation is the need to lift the entire electrode-spacer supporting element up and out of the electrocoagulation reactor housing assembly in order to remove even one electrode from the entire electrode set inside the electrocoagulation reactor housing assembly. As for the ‘groove type configuration’, such a problem or limitation makes it exceptionally difficult, impractical, or/and economically unfeasible, to maintain (i.e., clean, remove, replace, etc.) ‘individual’ electrodes of the electrode set inside the electrocoagulation reactor housing assembly.

Additionally, it is common to have a case of a particular design, construction, and intended operation, of the electrodes, and of the electrocoagulation reactor housing assembly, wherein either part, or the entirety, of the non-conducting electrode-spacer supporting element is positioned in the region wherein the water flows and circulates, and contacts the electrodes, wherein take place the various electrocoagulation reactions and associated physicochemical processes, inside the electrocoagulation reactor housing assembly. In such a case, the non-conducting electrode-spacer supporting element may undesirably perturb and interfere with the flow field and related fluid flow properties, characteristics, and behavior of the contaminated water which will be, is, or/and has been, electrocoagulatively treated inside the electrocoagulation reactor housing assembly of the electrocoagulation reactor unit. As for the ‘groove type configuration’, this additional interfering type of phenomenon translates into lower efficiency and less than optimal behavior and performance of the electrocoagulation reactor unit for electrocoagulatively removing contaminants from the contaminated water.

Accordingly, the preceding described problems or limitations associated with using a groove type configuration, or a spacer type configuration, for positioning and holding electrodes inside the electrocoagulation reactor housing assembly of an electrocoagulation reactor unit, are the basis of the above stated first significant problem or limitation relating to impractical or/and process interfering configurations of positioning and holding electrodes inside an electrocoagulation reactor housing assembly of the electrocoagulation reactor unit, associated with current teachings of electrocoagulatively removing contaminants from contaminated water.

(2) Existence of Electrocoagulatively Unreactive Zones within the Electrocoagulation Reactor Housing Assembly (Containing Electrodes)

The second significant problem or limitation relates to existence of electrocoagulatively unreactive zones within an electrocoagulation reactor housing assembly (containing electrodes) included in a more encompassing electrocoagulation reactor unit. The second significant problem or limitation also particularly pertains to the above described types or kinds of electrocoagulative water removal systems, wherein the electrocoagulation reactor housing assembly is configured and functions for containing a plurality of plate, slab, or sheet, type shaped electrodes which are configured or positioned vertically [i.e., with electrode faces vertically lined up in parallel from one (e.g., left or right) end side wall to an opposite (e.g., right or left, respectively) end side wall], or horizontally [i.e., with electrode faces horizontally stacked in parallel from the top end wall to the bottom end wall].

As stated hereinabove, inside such types or kinds of electrocoagulative water removal systems, water flows and circulates, and contacts the electrodes, throughout the ‘water flowing and contacting region’ wherein take place the various electrocoagulation reactions and associated physicochemical processes, inside the electrocoagulation reactor housing assembly (containing electrodes). The ‘total’ water flowing and contacting region can be considered to generally include two types of sub-regions: a first, major, electrode-electrode (inter-electrode) ‘electrocoagulatively reactive’ sub-region within which there takes place essentially all of the electrocoagulation of the contaminated water, and a second, minor, end wall-electrode or electrode-end wall ‘electrocoagulatively unreactive’ sub-region within which there takes place essentially none of the electrocoagulation of the contaminated water.

The first, major, electrode-electrode (inter-electrode) ‘electrocoagulatively reactive’ sub-region is defined by, and encompasses, the sum of all the individual water flowing and contacting electrode-electrode (inter-electrode) ‘zones’ located inside the electrocoagulation reactor housing assembly, whose volume takes up a relatively large portion (i.e., the major portion being most, but not all) of the total water flowing and contacting volume inside the electrocoagulation reactor housing assembly of the electrocoagulation reactor unit. In the first, major, sub-region, each water flowing and contacting electrode-electrode (inter-electrode) zone is made up of, and occupies, the volumetric space spanning in between a pair of two adjacent, nearest-neighboring, parallel and oppositely facing, and oppositely charged, faces (surfaces) of a respective pair of two adjacent, nearest-neighboring, parallel and oppositely facing, (monopolar-monopolar, monopolar-bipolar, or bipolar-bipolar) electrodes. Accordingly, since each individual water flowing and contacting electrode-electrode (inter-electrode) zone contains a pair of two adjacent, nearest-neighboring, parallel and oppositely facing, and oppositely charged, electrode faces (surfaces), therefore, during operation of the electrocoagulation reactor unit, each such individual water flowing and contacting electrode-electrode (inter-electrode) zone located inside the electrocoagulation reactor housing assembly is ‘electrocoagulatively reactive’ for electrocoagulatively removing contaminants from the contaminated water.

The second, minor, end wall-electrode or electrode-end wall ‘electrocoagulatively unreactive’ sub-region is defined by, and encompasses, the sum of (ordinarily) two individual water flowing and contacting end wall-electrode or electrode-end wall ‘zones’ located inside the electrocoagulation reactor housing assembly, whose volume takes up a relatively small portion (i.e., the minor portion) of the total water flowing and contacting volume inside the reactor housing assembly of the electrocoagulation reactor unit. In the second, minor, sub-region, each water flowing and contacting end wall-electrode or electrode-end wall zone is made up of, and occupies, the volumetric space spanning in between the (non-conductive, non-charged) interior face (surface) of one (e.g., left, right, top, or bottom) end side wall, and an adjacent, nearest-neighboring, parallel and oppositely facing, and (positively or negatively) charged, face (surface) of an adjacent, nearest-neighboring, parallel and oppositely facing, and (positively or negatively) charged, (monopolar) electrode. Accordingly, since each individual water flowing and contacting end wall-electrode or electrode-end wall zone contains the (non-conductive, non-charged) interior face (surface) of one (e.g., left, right, top, or bottom) end side wall, and only one adjacent, nearest-neighboring, parallel and oppositely facing, and (positively or negatively) charged, electrode face (surface), there is essentially no electrical or electrolytic activity (i.e., no conduction or charge flow [current] existing between electrode faces, since there is only one electrode face in the end wall-electrode or electrode-end wall zone). Therefore, during operation of the electrocoagulation reactor unit, each such individual water flowing and contacting end wall-electrode or electrode-end wall zone located inside the electrocoagulation reactor housing assembly is ‘electrocoagulatively unreactive’ and does not participate in, or contribute to, electrocoagulatively removing contaminants from the contaminated water.

During operation of the electrocoagulation reactor unit, contaminated water flows and circulates, and contacts electrodes, throughout the total water flowing and contacting region, and preceding described two types of sub-regions thereof. Contaminated water flows and circulates, and contacts (intermediately positioned, non-end side wall) electrodes, throughout the electrocoagulatively reactive zones of the first, major, electrode-electrode (inter-electrode) ‘electrocoagulatively reactive’ sub-region within which there takes place essentially all of the electrocoagulation of the contaminated water, within the volume that takes up the relatively large (major) portion of the total water flowing and contacting volume inside the reactor housing assembly of the electrocoagulation reactor unit. At the same time, contaminated water also flows and circulates, and contacts (end side wall) electrodes, throughout the two electrocoagulatively unreactive zones of the second, minor, end wall-electrode or electrode-end wall ‘electrocoagulatively unreactive’ sub-region within which there takes place essentially none of the electrocoagulation of the contaminated water, and whose volume takes up the relatively small (minor) portion of the total water flowing and contacting volume inside the reactor housing assembly of the electrocoagulation reactor unit. Alternatively stated, at the same time, the contaminated water which also flows and circulates, and contacts (end side wall) electrodes, throughout the two electrocoagulatively unreactive zones of the second, minor, end wall-electrode or electrode-end wall ‘electrocoagulatively unreactive’ sub-region, is not subjected to electrocoagulation processes, and therefore, is not electrocoagulatively treated.

From the above description, it is clearly understood that during operation of the electrocoagulation reactor unit, essentially all of the electrocoagulation of the contaminated water is effected within the first, major, electrode-electrode (inter-electrode) ‘electrocoagulatively reactive’ sub-region (and zones thereof) inside the electrocoagulation reactor housing assembly, while, by strong contrast, at the same time, essentially none of the electrocoagulation of the contaminated water is effected within the second, minor, end wall-electrode or electrode-end wall ‘electrocoagulatively unreactive’ sub-region (and zones thereof) inside the electrocoagulation reactor housing assembly.

For the purpose of studying, and analyzing, the preceding described phenomena, the applicant/assignee of the present invention performed extensive experimentation, and analyzed extensive amounts of experimental data and information, of electrocoagulatively removing contaminants from contaminated water using the above described known types or kinds of electrocoagulative water removal systems and electrocoagulation reactor units. The applicant/assignee observed and concluded that the existence of the second, minor, end wall-electrode or electrode-end wall ‘electrocoagulatively unreactive’ sub-region (and zones thereof) inside the electrocoagulation reactor housing assembly of the electrocoagulation reactor unit, in addition to not participating in, or contributing to, the overall electrocoagulation of the contaminated water, also, undesirably interferes with the flow field and related fluid flow properties, characteristics, and behavior of the contaminated water which will be, is, or/and has been, electrocoagulatively treated within neighboring ‘electrocoagulatively reactive’ zones of the first, major, electrode-electrode (inter-electrode) ‘electrocoagulatively reactive’ sub-region inside the electrocoagulation reactor housing assembly of the electrocoagulation reactor unit. The applicant/assignee observed and concluded that this additional interfering type of phenomenon translates into lower efficiency and less than optimal behavior and performance of the total water flowing and contacting region inside the electrocoagulation reactor housing assembly of the electrocoagulation reactor unit, for electrocoagulatively removing contaminants from the contaminated water.

Accordingly, the existence, and characteristics, of the second, minor, end wall-electrode or electrode-end wall ‘electrocoagulatively unreactive’ sub-region (and two zones thereof), inside an electrocoagulation reactor housing assembly of an electrocoagulation reactor unit, are the basis of the above stated second significant problem or limitation relating to existence of electrocoagulatively unreactive zones within the electrocoagulation reactor housing assembly (containing electrodes), associated with current teachings of electrocoagulatively removing contaminants from contaminated water.

### (3) Inefficient Structure and Operation (Limited Separation Performance, Efficiency) of a ‘Gravity-Type’ Sedimentation, Settling, or [Water] Clarification, Column

The third significant problem or limitation relates to inefficient structure and operation (limited separation performance, efficiency) of a ‘gravity-type’ sedimentation, settling, or [water] clarification, column. The third significant problem or limitation particularly pertains to those types or kinds of electrocoagulative water removal systems which include downstream, post-electrocoagulation reactor unit equipment and procedures for receiving and forwarding the electrocoagulatively treated contaminated water which exits the electrocoagulation reactor unit to at least one type of ‘secondary’ or ‘tertiary’ solid-liquid separation process based on ‘gravity-type’ sedimentation, settling, or [water] clarification.

Via operation of such ‘gravity-type’ sedimentation, settling, or [water] clarification, equipment and procedures, a portion or fraction of the various different types, kinds, and forms, of solid and solid-like electrocoagulation reaction products [i.e., coagulates, flocculates (flocs or flakes), precipitates, aggregates (aggregations), agglomerates (agglomerations), or/and clumps)], produced and contained within the electrocoagulatively treated contaminated water, is separated (i.e., sedimented, settled, or clarified) out from the electrocoagulatively treated contaminated water, for forming various possible different electrocoagulative water removal system output ‘preliminary’ separation (purification) products. Such ‘preliminary’ separation (purification) products contain, singly or in combination, different degrees, types, and forms (e.g., mixtures, suspensions, solutions), of (i) solid and solid-like (waste) matter (i.e., sediments, settled solids and semi-solids) mixed with, suspended in, or/and dissolved in, a relatively small amount of water, commonly known as ‘sludge’, (ii) partially cleaned, purified, or clarified, electrocoagulatively treated contaminated water with relatively small amounts of solid and solid-like (waste) matter (i.e., sediments, settled solids and semi-solids), and (iii) fully cleaned, purified, or clarified, water.

Typically, the various possible different electrocoagulative water removal system output ‘preliminary’ separation (purification) products, singly or in combination, are then subjected to any number of various further downstream collection, or/and additional ‘secondary’ or ‘tertiary’ (solid-liquid or/and solid-solid) separation, and water treatment or purification, processes, for ultimately forming various possible different electrocoagulative water removal system output ‘final’ separation (purification) products. Such ‘final’ separation (purification) products contain, singly, different degrees, types, and forms of (i) sludge, being the solid and solid-like (waste) matter (i.e., sediments, settled solids and semi-solids) mixed with, suspended in, or/and dissolved in, a relatively small amount of water, and (ii) fully cleaned, purified, or clarified, water.

As part of the preceding described types or kinds of electrocoagulative water removal systems, such ‘gravity-type’ sedimentation, settling, or [water] clarification, equipment ordinarily includes at least one main component being a large vessel or container, ordinarily designed, constructed, and operating, as a column or tank, within which takes place the various ‘gravity-type’ sedimentation, settling, or [water] clarification, processes. Accordingly, such a column or tank, type of large vessel or container, can be generally referred to as a ‘gravity-type’ sedimentation vessel or container, settling vessel or container, or [water] clarification vessel or container, which, in turn, are commonly specifically known and referred to by the following alternative phrases: sedimentation column, sedimentation tank; settling column, settling tank; or, [water] clarification, clarifying, or clarifier column, [water] clarification, clarifying, or clarifier tank, or briefly, as a [water] clarifier. For brevity, while maintaining generality, the phrase “gravity-type’ sedimentation, settling, or [water] clarification, column’, is used in the following discussion.

Included in the plethora of extensive teachings of electrocoagulatively removing contaminants from contaminated water, is a corresponding plethora of extensive teachings of designing, constructing, and operating, ‘gravity-type’ sedimentation, settling, or [water] clarification columns. In general, for effecting the various ‘gravity-type’ sedimentation, settling, or [water] clarification, processes, there are teachings of essentially innumerable different ways of designing, constructing, and operating, a ‘gravity-type’ sedimentation, settling, or [water] clarification column, with corresponding innumerable different types, kinds, forms, of materials of construction, geometrical shapes and size dimensions, and number, of the components and elements therein, which are selected according to a particular design, construction, and intended operation, of the overall electrocoagulative water removal system.

Nevertheless, in general, the inside of a ‘gravity-type’ sedimentation, settling, or [water] clarification column, is typically designed, constructed, and operates, with a variety of different types, kinds, and forms, of ‘gravity-type’ solid-liquid transfer, regulating, and separating, assemblies, components, and elements, such as, for example, chambers, compartments, walls, partitions, partitioners, separations, separators, barriers, conduits, channels, passageways, pipes, tubes, rods, plates, slabs, sheets, baffles, agitators, distributors, connectors, brackets, supporters, adaptors, valves, and vents, which are configured in any number of different ‘gravity-type’ solid-liquid transfer, regulating, or/and separating, zones, regions, and sections throughout the inside of the ‘gravity-type’ sedimentation, settling, or [water] clarification column.

A given particular design and construction of the inside of a ‘gravity-type’ sedimentation, settling, or [water] clarification column, directly influence the various aspects and parameters relating to the flow field and related fluid flow properties, characteristics, and behavior, of the electrocoagulatively treated contaminated water, in general, and of the various different types, kinds, and forms, of solid and solid-like electrocoagulation reaction products [i.e., coagulates, flocculates (flocs or flakes), precipitates, aggregates (aggregations), agglomerates (agglomerations), or/and clumps)], produced and contained therein.

These aspects and parameters, in turn, directly influence the various aspects and parameters relating to physicochemical characteristics and behavior of the various ‘gravity-type’ sedimentation, settling, or [water] clarification, solid-liquid separation processes which take place inside of the sedimentation, settling, or [water] clarification column.

All of the preceding aspects and parameters collectively, ultimately influence the overall operating characteristics, behavior, performance, and efficiency, of the sedimentation, settling, or [water] clarification column, for effecting separation (sedimentation, settling, clarification) of the solid and solid-like electrocoagulation reaction products out from the electrocoagulatively treated contaminated water, for forming the above described various possible different electrocoagulative water removal system output ‘preliminary’ and ‘final’ separation (purification) products.

In general, performance, and efficiency, of a sedimentation, settling, or [water] clarification column, can be characterized by a (sedimentation, settling, clarification) separation efficiency parameter which is defined as the ratio of: (a) the weight of sludge, being the solid and solid-like (waste) matter (i.e., sediments, settled solids and semi-solids) with a relatively small amount of water, output from the sedimentation, settling, or [water] clarification column, and (b) the ‘total’ weight of solid and solid-like electrocoagulation reaction products [i.e., coagulates, flocculates (flocs or flakes), precipitates, aggregates (aggregations), agglomerates (agglomerations), or/and clumps)] of the electrocoagulatively treated contaminated water, input to the sedimentation, settling, or [water] clarification column.

During operation of an overall electrocoagulative water removal system, it is a clear objective and goal to have a value of the (sedimentation, settling, clarification) separation efficiency parameter be as close as possible to 1.0, which, of course, ultimately translates into contributing to achieving as high as possible overall performance, and efficiency, of the overall electrocoagulative water removal system for electrocoagulatively removing the contaminants from the contaminated water.

For a typical ‘gravity-type’ sedimentation, settling, or [water] clarification column, the (sedimentation, settling, clarification) separation efficiency parameter has a value in the range of between about 0.50 and about 0.85. This means that of the total weight of the solid and solid-like electrocoagulation reaction products produced and contained in the electrocoagulatively treated contaminated water which is input to the sedimentation, settling, or [water] clarification column, between about 50% and about 85% is, and between about 50% and about 15%, respectively, is not, separated (i.e., sedimented, settled, or clarified) out from the electrocoagulatively treated contaminated water inside of, and eventually output from, the sedimentation, settling, or [water] clarification column.

Based on the above discussion, it is clearly understood that a typical ‘gravity-type’ sedimentation, settling, or [water] clarification column has a (sedimentation, settling, clarification) separation efficiency parameter whose value can be quite far from the ideal value of 1.0. This, then, corresponds to a significant problem or limitation of the overall operating characteristics, behavior, performance, and efficiency, of a typical currently designed, constructed, and used, ‘gravity-type’ sedimentation, settling, or [water] clarification column, which, in turn, translates into a significant problems or limitation of the overall performance, and efficiency, of the overall electrocoagulative water removal system for electrocoagulatively removing the contaminants from the contaminated water. Moreover, it is also understood from the above discussion that these significant problems or limitations are, therefore, directly traceable back to significant problems or limitations relating to the design and construction of the inside of a ‘gravity-type’ sedimentation, settling, or [water] clarification column.

Accordingly, the preceding described significant problems or limitations are the basis of the above stated third significant problem or limitation relating to inefficient structure and operation (limited separation performance, efficiency) of a ‘gravity type’ sedimentation, settling, or [water] clarification, column, associated with current teachings of electrocoagulatively removing contaminants from contaminated water.

As expected, any of the above indicated extensive teachings [e.g., 1-31] of electrocoagulation, and of using electrocoagulation for removing contaminants from contaminated water, may have unique advantages or/and disadvantages, particularly with respect to commercial applicability, practicality, or/and economical feasibility of implementation. However, such teachings include at least one of the just described three significant problems or limitations associated with electrocoagulatively removing contaminants from contaminated water, or/and introduce at least one other significant problem or limitation so as to become commercially inapplicable, impractical, or/and economically unfeasible to implement, especially for a high volume throughput (for example, on the order of at least about 1000 liters per hour (l/hr) [1 cubic meter per hour (m³/hr)]) commercial scale industrial process, involving, for example, metallic electro-etching, plating, or coating, of materials or components; manufacturing of electrical, electronic, or semiconductor, materials or components; mining or/and processing of minerals or metals; or, manufacturing or/and processing of pulp or paper.

As briefly stated hereinabove, it is well established and understood that there is a continuous need for monitoring and removing contaminants (particularly, heavy metal species or heavy metal type contaminants) from contaminated water, typically produced during commercial scale industrial processes, to environmentally acceptable levels before such sources of water come in direct or indirect contact with living organisms. Despite the existence of extensive teachings in the fields and areas of application encompassing the subjects of electrocoagulation, and of using electrocoagulation for removing contaminants from contaminated water, and in view of the above described three significant problems or limitations relating to design, construction, and operation, of and within an electrocoagulation reactor housing assembly included in an electrocoagulation reactor unit, and, of and within a ‘gravity-type’ sedimentation, settling, or [water] clarification, column, of an overall electrocoagulative water removal system, associated with such teachings, there is an on-going need for designing, developing, and implementing, improved or/and new electrocoagulative water removal systems for removing contaminants from contaminated water.

There is thus a need for, and it would be highly advantageous to have a system for electrocoagulatively removing contaminants from contaminated water. There is also a need for such an invention which, in addition to the overall electrocoagulative water contaminant removal system, also particularly relates to two main components of the electrocoagulative water contaminant removal system, being an electrocoagulation reactor unit, and a (‘gravity type’, primary) sedimentation column. There is also a need for such an invention wherein the two main components, namely, an electrocoagulation reactor unit, and a (‘gravity type’, primary) sedimentation column, although included and operative as integral parts of the electrocoagulative water contaminant removal system of the present invention, can also be included and operative, either singly or in combination, as parts of other electrocoagulative water contaminant removal systems.

There is need for such an invention which is particularly applicable for electrocoagulatively removing contaminants from contaminated water produced during a high volume throughput (for example, on the order of at least about 1000 liters per hour (l/hr) [1 cubic meter per hour (m³/hr)]) commercial scale industrial process, involving, for example, metallic electro-etching, plating, or coating, of materials or components; manufacturing of electrical, electronic, or semiconductor, materials or components; mining or/and processing of minerals or metals; or, manufacturing or/and processing of pulp or paper. There is also need for such an invention, which, although particularly directed to, and applicable for, removing heavy metal type contaminants composed of or including heavy metals (such as chromium, copper, nickel, zinc, tin, antimony, aluminum, lead, manganese, cobalt, tungsten, and cadmium) from contaminated water, is also directed to, and applicable for, removing non-metallic type contaminants composed of or including non-metals (such as organic chemical species [e.g., hydrocarbons—oils, fats, greases] or/and biological species [e.g., microorganisms—bacteria]) from contaminated water. There is further need for such an invention which is readily commercially applicable, practical, and economically feasible to implement.

Moreover, there is also need for such an invention whose scope, and fields or areas of application, are directed to appropriately addressing and overcoming several significant problems or limitations associated with current teachings of electrocoagulatively removing contaminants from contaminated water. Particularly, the above described significant problems or limitations relating to design, construction, and operation, of and within an electrocoagulation reactor housing assembly included in an electrocoagulation reactor unit, and, of and within a ‘gravity-type’ sedimentation, settling, or [water] clarification, column, of an overall electrocoagulative water removal system.

### SUMMARY OF THE INVENTION

The present invention relates to electrocoagulatively, removing contaminants from contaminated water, and more particularly, to a system for electrocoagulatively removing contaminants from contaminated water. The present invention also relates particularly to two main components of the electrocoagulative water contaminant removal system, being an electrocoagulation reactor unit, and a (‘gravity type’, primary) sedimentation column. These two main components, namely, an electrocoagulation reactor unit, and a (‘gravity type’, primary) sedimentation column, although included and operative as integral parts of the electrocoagulative water contaminant removal system of the present invention, can also be included and operative, either singly or in combination, as parts of other electrocoagulative water contaminant removal systems.

The present invention is particularly applicable for electrocoagulatively removing contaminants from contaminated water produced during a high volume throughput (for example, on the order of at least about 1000 liters per hour (l/hr) [1 cubic meter per hour (m³/hr)]) commercial scale industrial process, involving, for example, metallic electro-etching, plating, or coating, of materials or components; manufacturing of electrical, electronic, or semiconductor, materials or components; mining or/and processing of minerals or metals; or, manufacturing or/and processing of pulp or paper. The present invention, although particularly directed to, and applicable for, removing heavy metal type contaminants composed of or including heavy metals (such as chromium, copper, nickel, zinc, tin, antimony, aluminum, lead, manganese, cobalt, tungsten, and cadmium) from contaminated water, is also directed to, and applicable for, removing non-metallic type contaminants composed of or including non-metals (such as organic chemical species [e.g., hydrocarbons—oils, fats, greases] or/and biological species [e.g., microorganisms—bacteria]) from contaminated water. The present invention is readily commercially applicable, practical, and economically feasible to implement.

The scope, and fields or areas of application, of the present invention, are directed to appropriately addressing and overcoming several significant problems or limitations relating to design, construction, and operation, of and within an electrocoagulation reactor housing assembly included in an electrocoagulation reactor unit, and, of and within a ‘gravity-type’ sedimentation, settling, or [water] clarification, column, of an overall electrocoagulative water contaminant removal system. Specifically, as described hereinabove in the ‘Background’ section, and further discussed hereinbelow in the ‘Invention Description’ section, three specific significant problems or limitations associated with current teachings of electrocoagulatively removing contaminants from contaminated water, which are appropriately addressed and overcome by the present invention, relate to: (1) impractical or/and process interfering configurations of positioning, spacing, and holding electrodes inside an electrocoagulation reactor housing assembly, (2) existence of electrocoagulatively unreactive zones inside an electrocoagulation reactor housing assembly (containing electrodes), and (3) inefficient structure and operation (limited separation performance, efficiency) of a ‘gravity-type’ sedimentation, settling, or [water] clarification, column.

Thus, according to a main aspect of the present invention, there is provided a system for electrocoagulatively removing contaminants from contaminated water, comprising: an input unit, suitable for receiving and transporting the contaminated water; an electrocoagulation reactor unit operatively connected to the input unit, suitable for receiving and electrocoagulatively treating the contaminated water, for forming electrocoagulatively treated contaminated water; an output unit operatively connected to the electrocoagulation reactor unit, suitable for receiving and transporting the electrocoagulatively treated contaminated water, and for separating solid and solid-like electrocoagulation reaction products out from the electrocoagulatively treated contaminated water, for forming sludge and cleaned water; and a power supply and process control unit, suitable for supplying power to, and controlling processes of, the input unit, the electrocoagulation reactor unit, and the output unit; wherein the electrocoagulation reactor unit includes an electrocoagulation reactor housing assembly having therein: (i) a lower pair of electrode positioning, spacing, and holding elements, integrally configured and oppositely facing each other along lower sections of two oppositely facing walls of the electrocoagulation reactor housing assembly, and (ii) a complementary upper pair of electrode positioning, spacing, and holding elements, removably and replaceably configured and oppositely facing each other along upper sections of the two oppositely facing walls of the electrocoagulation reactor housing assembly.

According to some embodiments of the present invention, the integrally configured lower pair of electrode positioning, spacing, and holding elements, and, the complementary removably and replaceably configured upper pair of electrode positioning, spacing, and holding elements, are made of non-conductive materials.

According to some embodiments of the present invention, the integrally configured lower pair of electrode positioning, spacing, and holding elements, includes grooves for positioning, spacing, and holding electrodes at electrode bottom end portions thereof.

According to some embodiments of the present invention, the removably and replaceably configured upper pair of electrode positioning, spacing, and holding elements, includes grooves for positioning, spacing, and holding electrodes at electrode top end portions thereof.

According to some embodiments of the present invention, the integrally configured lower pair of electrode positioning, spacing, and holding elements, and, the complementary removably and replaceably configured upper pair of electrode positioning, spacing, and holding elements, are for positioning, spacing, and holding electrodes with electrode faces vertically lined up in parallel from one end side wall to an opposite end side wall within the electrocoagulation reactor housing assembly.

According to some embodiments of the present invention, the electrocoagulation reactor housing assembly has therein an end wall-electrode or electrode-end wall electrocoagulatively unreactive sub-region, wherein each of two individual water ‘non-flowing’ and ‘non-contacting’ zones in the unreactive sub-region comprises a non-conductive, non-charged interior face of one end side wall configured flush against and directly contacting adjacent, nearest-neighboring, parallel and oppositely facing, and charged, face of an adjacent, nearest-neighboring, parallel and oppositely facing, and charged, monopolar electrode, thereby preventing the contaminated water and the electrocoagulatively treated contaminated water from flowing and making contact therebetween.

According to some embodiments of the present invention, the output unit includes at least one gravity-type sedimentation, settling, or [water] clarification column, suitable for effecting the separating solid and solid-like electrocoagulation reaction products out from the electrocoagulatively treated contaminated water.

According to some embodiments of the present invention, the sedimentation, settling, or [water] clarification column is suitable for: (i) receiving and separating the electrocoagulatively treated contaminated water into a first portion of sludge, and a first portion of water-with-sediments, (ii) separating the first portion of water-with-sediments into a second portion of water-with-sediments, and a portion of cleaned water, and (iii) separating the second portion of water-with-sediments into a second portion of sludge, and partially cleaned water.

According to some embodiments of the present invention, the sedimentation, settling, or [water] clarification column includes: a first sediments-water separator assembly, suitable for (i) receiving and separating the electrocoagulatively treated contaminated water into a first portion of sludge, and a first portion of water-with-sediments, and (ii) separating the first portion of water-with-sediments into a second portion of water-with-sediments, and a portion of cleaned water; and a second sediments-water separator assembly, suitable for receiving and separating the second portion of water-with-sediments into a second portion of sludge, and partially cleaned water.

According to some embodiments of the present invention, the sedimentation, settling, or [water] clarification column includes a sediments-water separator assembly having a water/sediments distributor assembly suitable for receiving, and, laterally and circularly distributing the electrocoagulatively treated contaminated water throughout bottom section of the sediments-water separator assembly.

According to some embodiments of the present invention, the water/sediments distributor assembly is configured as a cylindrical geometrical shape or form.

According to some embodiments of the present invention, the water/sediments distributor assembly includes a plurality of water distributing elements suitable for effecting the distributing the electrocoagulatively treated contaminated water throughout the bottom section of the sediments-water separator assembly.

According to some embodiments of the present invention, the water distributing elements are angularly spaced apart from each other.

According to some embodiments of the present invention, the water distributing elements are structurally fixed and, rigid or/and flexible.

According to some embodiments of the present invention, the water distributing elements are hollow cylindrical or tubular geometrically shaped or formed.

According to some embodiments of the present invention, the open end portions of two adjacent, nearest-neighboring the water distributing elements are spaced apart by an angle of at least about 10 degrees.

According to some embodiments of the present invention, the sedimentation, settling, or [water] clarification column includes a sediments-water separator assembly having a downward flow multi-conduit assembly suitable for receiving a portion of water-with-sediments of the electrocoagulatively treated contaminated water, and, for directing downward flow of the portion of water-with-sediments to bottom section of the sediments-water separator assembly.

According to some embodiments of the present invention, the first sediments-water separator assembly includes a water/sediments distributor assembly suitable for receiving, and, laterally and circularly distributing the electrocoagulatively treated contaminated water throughout bottom section of the first sediments-water separator assembly.

According to some embodiments of the present invention, the water/sediments distributor assembly includes a plurality of water distributing elements suitable for effecting the distributing the electrocoagulatively treated contaminated water throughout the bottom section of the first sediments-water separator assembly.

According to some embodiments of the present invention, the second sediments-water separator assembly includes a downward flow multi-conduit assembly suitable for effecting the receiving the second portion of water-with-sediments, and, for directing downward flow of the second portion of water-with-sediments to bottom section of the second sediments-water separator assembly.

According to some embodiments of the present invention, the additional sedimentation, settling, or [water] clarification column is suitable for receiving and separating the partially cleaned water into a third portion of sludge, and an additional portion of cleaned water.

According to some embodiments of the present invention, the additional sedimentation, settling, or [water] clarification column includes a sludge collection assembly suitable for effecting the separating the partially cleaned water into the third portion of sludge, and the additional portion of cleaned water.

According to some embodiments of the present invention, the output unit includes two gravity-type sedimentation, settling, or [water] clarification columns, suitable for effecting the separating solid and solid-like electrocoagulation reaction products out from the electrocoagulatively treated contaminated water.

According to some embodiments of the present invention, the first or primary sedimentation, settling, or [water] clarification column is suitable for: (i) receiving and separating the electrocoagulatively treated contaminated water into a first portion of sludge, and a first portion of water-with-sediments, (ii) separating the first portion of water-with-sediments into a second portion of water-with-sediments, and a first portion of cleaned water, and (iii) separating the second portion of water-with-sediments into a second portion of sludge, and partially cleaned water.

According to some embodiments of the present invention, the first or primary sedimentation, settling, or [water] clarification column includes: a first sediments-water separator assembly, suitable for (i) receiving and separating the electrocoagulatively treated contaminated water into a first portion of sludge, and a first portion of water-with-sediments, and (ii) separating the first portion of water-with-sediments into a second portion of water-with-sediments, and a portion of cleaned water; and a second sediments-water separator assembly, suitable for receiving and separating the second portion of water-with-sediments into a second portion of sludge, and partially cleaned water.

According to some embodiments of the present invention, the first or primary sedimentation, settling, or [water] clarification column includes a sediments-water separator assembly having a water/sediments distributor assembly suitable for receiving, and, laterally and circularly distributing the electrocoagulatively treated contaminated water throughout bottom section of the sediments-water separator assembly.

According to some embodiments of the present invention, the water/sediments distributor assembly includes a plurality of water distributing elements suitable for effecting the distributing the electrocoagulatively treated contaminated water throughout the bottom section of the sediments-water separator assembly.

According to some embodiments of the present invention, the first or primary the sedimentation, settling, or [water] clarification column includes a sediments-water separator assembly having a downward flow multi-conduit assembly suitable for receiving a portion of water-with-sediments of the electrocoagulatively treated contaminated water, and, for directing downward flow of the portion of water-with-sediments to bottom section of the sediments-water separator assembly.

According to some embodiments of the present invention, the first sediments-water separator assembly includes a water/sediments distributor assembly suitable for receiving, and, laterally and circularly distributing the electrocoagulatively treated contaminated water throughout bottom section of the first sediments-water separator assembly.

According to some embodiments of the present invention, the water/sediments distributor assembly includes a plurality of water distributing elements suitable for effecting the distributing the electrocoagulatively treated contaminated water throughout the bottom section of the first sediments-water separator assembly.

According to some embodiments of the present invention, the second sediments-water separator assembly includes a downward flow multi-conduit assembly suitable for effecting the receiving the second portion of water-with-sediments, and, for directing downward flow of the second portion of water-with-sediments to bottom section of the second sediments-water separator assembly.

According to some embodiments of the present invention, the second or secondary sedimentation, settling, or [water] clarification column is suitable for receiving and separating the partially cleaned water into a third portion of sludge, and a second portion of cleaned water.

According to some embodiments of the present invention, the second or secondary sedimentation, settling, or [water] clarification column includes a sludge collection assembly suitable for effecting the separating the partially cleaned water into the third portion of sludge, and the second portion of cleaned water.

According to another main aspect of the present invention, there is provided an electrocoagulation reactor unit for electrocoagulatively treating contaminated water, comprising: a reactor housing input assembly, suitable for receiving the contaminated water; an electrocoagulation reactor housing assembly operatively connected to the reactor housing input assembly, suitable for housing a set of electrodes, and wherein takes place electrocoagulative treatment of the contaminated water, for forming electrocoagulatively treated contaminated water; and a reactor housing output assembly, operatively connected to the electrocoagulation reactor housing assembly, suitable for receiving and outputting the electrocoagulatively treated contaminated water; wherein the electrocoagulation reactor housing assembly includes: (i) a lower pair of electrode positioning, spacing, and holding elements, integrally configured and oppositely facing each other along lower sections of two oppositely facing walls of the electrocoagulation reactor housing assembly, and (ii) a complementary upper pair of electrode positioning, spacing, and holding elements, replaceably configured and oppositely facing each other along upper sections of the two oppositely facing walls of the electrocoagulation reactor housing assembly.

According to some embodiments of the present invention, the integrally configured lower pair of electrode positioning, spacing, and holding elements, and, the complementary removably and replaceably configured upper pair of electrode positioning, spacing, and holding elements, are made of non-conductive materials.

According to some embodiments of the present invention, the integrally configured lower pair of electrode positioning, spacing, and holding elements, includes grooves for positioning, spacing, and holding electrodes at electrode bottom end portions thereof.

According to some embodiments of the present invention, the removably and replaceably configured upper pair of electrode positioning, spacing, and holding elements, includes grooves for positioning, spacing, and holding electrodes at electrode top end portions thereof.

According to some embodiments of the present invention, the integrally configured lower pair of electrode positioning, spacing, and holding elements, and, the complementary removably and replaceably configured upper pair of electrode positioning, spacing, and holding elements, are for positioning, spacing, and holding electrodes with electrode faces vertically lined up in parallel from one end side wall to an opposite end side wall within the electrocoagulation reactor housing assembly.

According to some embodiments of the present invention, the electrocoagulation reactor housing assembly has therein an end wall-electrode or electrode-end wall electrocoagulatively unreactive sub-region, wherein each of two individual water ‘non-flowing’ and ‘non-contacting’ zones in the unreactive sub-region comprises a (non-conductive, non-charged) interior face (surface) of one (left or right) end side wall configured flush against and directly contacting adjacent, nearest-neighboring, parallel and oppositely facing, and (positively or negatively) charged, face (surface) of an adjacent, nearest-neighboring, parallel and oppositely facing, and (positively or negatively) charged, (monopolar) electrode, thereby preventing the contaminated water and the electrocoagulatively treated contaminated water from flowing and making contact therebetween.

According to another main aspect of the present invention, there is provided a sedimentation, settling, or [water] clarification column for separating solid and solid-like electrocoagulation reaction products out from electrocoagulatively treated contaminated water, comprising: a first sediments-water separator assembly, suitable for (i) receiving and separating the electrocoagulatively treated contaminated water into a first portion of sludge, and a first portion of water-with-sediments, and (ii) separating the first portion of water-with-sediments into a second portion of water-with-sediments, and a portion of cleaned water; and a second sediments-water separator assembly, suitable for receiving and separating the second portion of water-with-sediments into a second portion of sludge, and partially cleaned water.

According to some embodiments of the present invention, the first sediments-water separator assembly includes a water/sediments distributor assembly suitable for receiving, and, laterally and circularly distributing the electrocoagulatively treated contaminated water throughout bottom section of the first sediments-water separator assembly.

According to some embodiments of the present invention, the water/sediments distributor assembly includes a plurality of water distributing elements suitable for effecting the distributing the electrocoagulatively treated contaminated water throughout the bottom section of the first sediments-water separator assembly.

According to some embodiments of the present invention, the water distributing elements are angularly spaced apart from each other.

According to some embodiments of the present invention, the water distributing elements are structurally fixed and, rigid or/and flexible.

According to some embodiments of the present invention, the water distributing elements are hollow cylindrical or tubular geometrically shaped or formed.

According to some embodiments of the present invention, the open end portions of two adjacent, nearest-neighboring the water distributing elements are spaced apart by an angle of at least about 10 degrees.

According to some embodiments of the present invention, the second sediments-water separator assembly includes a downward flow multi-conduit assembly suitable for effecting the receiving the second portion of water-with-sediments, and, for directing downward flow of the second portion of water-with-sediments to bottom section of the second sediments-water separator assembly.

The present invention is implemented by performing steps or procedures, and sub-steps or sub-procedures, in a manner selected from the group consisting of manually, semi-automatically, fully automatically, and a combination thereof, involving use and operation of system units, system sub-units, devices, assemblies, sub-assemblies, mechanisms, structures, components, and elements, and, peripheral equipment, utilities, accessories, and materials. Moreover, according to actual steps or procedures, sub-steps or sub-procedures, system units, system sub-units, devices, assemblies, sub-assemblies, mechanisms, structures, components, and elements, and, peripheral equipment, utilities, accessories, and materials, used for implementing a particular embodiment of the disclosed invention, the steps or procedures, and sub-steps or sub-procedures, are performed by using hardware, software, or/and an integrated combination thereof, and the system units, sub-units, devices, assemblies, sub-assemblies, mechanisms, structures, components, and elements, and, peripheral equipment, utilities, accessories, and materials, operate by using hardware, software, or/and an integrated combination thereof.

For example, software used, via an operating system, for implementing the present invention can include operatively interfaced, integrated, connected, or/and functioning written or/and printed data, in the form of software programs, software routines, software sub-routines, software symbolic languages, software code, software instructions or protocols, software algorithms, or a combination thereof. For example, hardware used for implementing the present invention can include operatively interfaced, integrated, connected, or/and functioning electrical, electronic or/and electromechanical system units, sub-units, devices, assemblies, sub-assemblies, mechanisms, structures, components, and elements, and, peripheral equipment, utilities, accessories, and materials, which may include one or more computer chips, integrated circuits, electronic circuits, electronic sub-circuits, hard-wired electrical circuits, or a combination thereof, involving digital or/and analog operations. The present invention can be implemented by using an integrated combination of the just described exemplary software and hardware.

In exemplary embodiments of the present invention, steps or procedures, and sub-steps or sub-procedures, can be performed by a data processor, such as a computing platform, for executing a plurality of instructions. Optionally, the data processor includes volatile memory for storing instructions or/and data, or/and includes non-volatile storage, for example, a magnetic hard-disk or/and removable media, for storing instructions or/and data. Optionally, exemplary embodiments of the present invention include a network connection. Optionally, exemplary embodiments of the present invention include a display device and a user input device, such as a keyboard or/and ‘mouse’.

### BRIEF DESCRIPTION OF THE DRAWINGS

Embodiments of the present invention are herein described, by way of example only, with reference to the accompanying drawings. With specific reference now to the drawings in detail, it is stressed that the particulars shown are by way of example and for purposes of illustrative description of embodiments of the present invention. In this regard, the description taken together with the accompanying drawings make apparent to those skilled in the art how the embodiments of the present invention may be practiced.

In the drawings:

FIG. 1 is a schematic diagram illustrating a cut-away side view of an exemplary embodiment of the system for electrocoagulatively removing contaminants from contaminated water (‘the electrocoagulative water contaminant removal system’), in accordance with the present invention;

FIG. 2 is a schematic diagram illustrating a perspective view of an exemplary embodiment of a (anode or cathode) monopolar electrode and of a bipolar electrode, which are representative of electrodes included in an electrode set of the electrocoagulation reactor unit included in the electrocoagulative water contaminant removal system illustrated in FIG. 1, and which are positioned, spaced, and held, via the complementary pairs of bottom and top electrode positioning, spacing, and holding elements, in (the bottom section of) the electrocoagulation reactor housing assembly illustrated in FIG. 3, and in accordance with the present invention;

FIG. 3 is a schematic diagram illustrating a perspective view of (part of) an exemplary embodiment of the bottom section of the electrocoagulation reactor housing assembly, [highlighting (i) an exemplary embodiment of the lower pair of integrally configured and oppositely facing electrode positioning, spacing, and holding elements, and an exemplary embodiment of the complementary upper pair of removably and replaceably configured and oppositely facing electrode positioning, spacing, and holding elements, therein, and (ii) an exemplary embodiment of one zone of the two zones of the end wall-electrode or electrode-end wall ‘electrocoagulatively unreactive’ sub-region therein], being part of the electrocoagulation reactor unit included in the electrocoagulative water contaminant removal system illustrated in FIG. 1, in accordance with the present invention;

FIG. 4 is a schematic diagram illustrating a perspective view of (part of) an exemplary embodiment of a series parallel (spatial-electrical) configuration of (anode and cathode) monopolar electrodes and bipolar electrodes of a series parallel (spatially-electrically) configured electrode set, inside (the bottom section of) the electrocoagulation reactor housing assembly illustrated in FIG. 3, being part of the electrocoagulation reactor unit included in the electrocoagulative water contaminant removal system illustrated in FIG. 1, for additionally illustrating special technical (structural and functional) features and characteristics of the exemplary embodiments highlighted in FIG. 3, in accordance with the present invention;

FIG. 5 is a schematic diagram illustrating a perspective view of (part of) an exemplary embodiment of a series (spatial-electrical) configuration of (anode and cathode) monopolar electrodes and bipolar electrodes of a series (spatially-electrically) configured electrode set, inside (the bottom section of) the electrocoagulation reactor housing assembly illustrated in FIG. 3, being part of the electrocoagulation reactor unit included in the electrocoagulative water contaminant removal system illustrated in FIG. 1, for additionally illustrating special technical (structural and functional) features and characteristics of the exemplary embodiments highlighted in FIG. 3, in accordance with the present invention;

FIG. 6 is a schematic diagram illustrating a perspective view of (part of) an exemplary embodiment of a parallel (spatial-electrical) configuration of (anode and cathode) monopolar electrodes (without bipolar electrodes) of a parallel (spatially-electrically) configured electrode set, inside (the bottom section of) the electrocoagulation reactor housing assembly illustrated in FIG. 3, being part of the electrocoagulation reactor unit included in the electrocoagulative water contaminant removal system illustrated in FIG. 1, for additionally illustrating special technical (structural and functional) features and characteristics of the exemplary embodiments highlighted in FIG. 3, in accordance with the present invention;

FIG. 7 is a schematic diagram illustrating a cut-away side view of an exemplary embodiment of a series parallel (spatial-electrical) configuration of (anode and cathode) monopolar electrodes and bipolar electrodes of a series parallel (spatially-electrically) configured electrode set, inside the electrocoagulation reactor housing assembly illustrated in FIG. 3, which is associated with the spatial-electrical configuration illustrated in FIG. 4, in accordance with the present invention;

FIG. 8 is a schematic diagram illustrating a cut-away side view of an exemplary embodiment of a series (spatial-electrical) configuration of (anode and cathode) monopolar electrodes and bipolar electrodes of a series (spatially-electrically) configured electrode set, inside the electrocoagulation reactor housing assembly illustrated in FIG. 3, which is associated with the spatial-electrical configuration illustrated in FIG. 5, in accordance with the present invention;

FIG. 9 is a schematic diagram illustrating a cut-away side view of an exemplary embodiment of a parallel (spatial-electrical) configuration of (anode and cathode) monopolar electrodes (without bipolar electrodes) of a parallel (spatially-electrically) configured electrode set, inside the electrocoagulation reactor housing assembly illustrated in FIG. 3, which is associated with the spatial-electrical configuration illustrated in FIG. 6, in accordance with the present invention;

FIG. 10 is a schematic diagram illustrating a cut-away side view of an exemplary embodiment of the (first or primary) ‘gravity-type’ sedimentation, settling, or [water] clarification column, (Primary Sedimentation Column (SC1)), [highlighting an exemplary embodiment of the main components of the internal structure and operation thereof, for effecting the various (primary) ‘gravity-type’ sedimentation, settling, or [water] clarification, solid-liquid separation processes therein], being part of the output unit included in the electrocoagulative water contaminant removal system illustrated in FIG. 1, in accordance with the present invention;

FIG. 11 is a schematic diagram illustrating a cut-away top view (A) of an exemplary embodiment of the water/sediments distributor assembly [highlighting special technical (structural and functional) features and characteristics thereof], included in the first sediments-water separator assembly configured inside the (first or primary) ‘gravity-type’ sedimentation, settling, or [water] clarification column, (Primary Sedimentation Column (SC1)) illustrated in FIG. 10, in accordance with the present invention; and

FIG. 12 is a schematic diagram illustrating a cut-away side view of an exemplary embodiment of the (second or secondary) ‘gravity-type’ sedimentation, settling, or [water] clarification column, (Secondary Sedimentation Column (SC2)), [highlighting an exemplary embodiment of the main components of the internal structure and operation thereof, for effecting the various (secondary) ‘gravity-type’ sedimentation, settling, or [water] clarification, solid-liquid separation processes therein], being part of the output unit included in the electrocoagulative water contaminant removal system illustrated in FIG. 1, in accordance with the present invention.

### DESCRIPTION OF SPECIFIC EMBODIMENTS OF THE INVENTION

The present invention relates to electrocoagulatively, removing contaminants from contaminated water, and more particularly, to a system for electrocoagulatively removing contaminants from contaminated water. The present invention also relates particularly to two main components of the electrocoagulative water contaminant removal system, being an electrocoagulation reactor unit, and a (‘gravity type’, primary) sedimentation column. These two main components, namely, an electrocoagulation reactor unit, and a (‘gravity type’, primary) sedimentation column, although included and operative as integral parts of the electrocoagulative water contaminant removal system of the present invention, can also be included and operative, either singly or in combination, as parts of other electrocoagulative water contaminant removal systems.

The present invention is particularly applicable for electrocoagulatively removing contaminants from contaminated water produced during a high volume throughput (for example, on the order of at least about 1000 liters per hour (l/hr) [1 cubic meter per hour (m³/hr)]) commercial scale industrial process, involving, for example, metallic electro-etching, plating, or coating, of materials or components; manufacturing of electrical, electronic, or semiconductor, materials or components; mining or/and processing of minerals or metals; or, manufacturing or/and processing of pulp or paper. The present invention, although particularly directed to, and applicable for, removing heavy metal type contaminants composed of or including heavy metals (such as chromium, copper, nickel, zinc, tin, antimony, lead, manganese, and cadmium) from contaminated water, is also directed to, and applicable for, removing non-metallic type contaminants composed of or including non-metals (such as organic chemical species [e.g., hydrocarbons—oils, fats, greases] or/and biological species [e.g., microorganisms—bacteria]) from contaminated water. The present invention is readily commercially applicable, practical, and economically feasible to implement.

The scope, and fields or areas of application, of the present invention, are directed to appropriately addressing and overcoming several significant problems or limitations relating to design, construction, and operation, of and within an electrocoagulation reactor housing assembly included in an electrocoagulation reactor unit, and, of and within a ‘gravity-type’ sedimentation, settling, or [water] clarification, column, of an overall electrocoagulative water contaminant removal system. Specifically, three specific significant problems or limitations associated with current teachings of electrocoagulatively removing contaminants from contaminated water, which are appropriately addressed and overcome by the present invention, relate to: (1) impractical or/and process interfering configurations of positioning, spacing, and holding electrodes inside an electrocoagulation reactor housing assembly, (2) existence of electrocoagulatively unreactive zones inside an electrocoagulation reactor housing assembly (containing electrodes), and (3) inefficient structure and operation (limited separation performance, efficiency) of a ‘gravity-type’ sedimentation, settling, or [water] clarification, column. These three significant problems or limitations are described hereinabove in the ‘Background’ section.

A main aspect of the present invention is provision of a system for electrocoagulatively removing contaminants from contaminated water, the system including the following main components and functionalities thereof: (a) an input unit, for receiving and transporting the contaminated water; (b) an electrocoagulation reactor unit operatively connected to the input unit, for receiving and electrocoagulatively treating the contaminated water, for forming electrocoagulatively treated contaminated water; (c) an output unit operatively connected to the electrocoagulation reactor unit, for receiving and transporting the electrocoagulatively treated contaminated water, and for separating solid and solid-like electrocoagulation reaction products out from the electrocoagulatively treated contaminated water, for forming sludge and cleaned water; and (d) a power supply and process control unit, for supplying power to, and controlling processes of, the input unit, the electrocoagulation reactor unit, and the output unit.

In the system for electrocoagulatively removing contaminants from contaminated water (herein, for brevity, also referred to as ‘the electrocoagulative water contaminant removal system’), the electrocoagulation reactor unit includes an electrocoagulation reactor housing assembly having therein: (i) a lower pair of electrode positioning, spacing, and holding elements, integrally configured and oppositely facing each other along lower sections of two oppositely facing walls of the electrocoagulation reactor housing assembly, and (ii) a complementary upper pair of electrode positioning, spacing, and holding elements, removably and replaceably configured and oppositely facing each other along upper sections of the two oppositely facing walls of the electrocoagulation reactor housing assembly.

By way of the electrocoagulation reactor unit being a main component and sub-combination of the electrocoagulative water contaminant removal system, the present invention also features a device, corresponding to the electrocoagulation reactor unit, for electrocoagulatively treating contaminated water. Thus, another main aspect of the present invention is provision of an electrocoagulation reactor unit for electrocoagulatively treating contaminated water, including the following main components and functionalities thereof: (a) a reactor housing input assembly, for receiving the contaminated water; (b) an electrocoagulation reactor housing assembly operatively connected to the reactor housing input assembly, for housing a set of electrodes, and wherein takes place electrocoagulative treatment of the contaminated water, for forming electrocoagulatively treated contaminated water; and (c) a reactor housing output assembly, operatively connected to the electrocoagulation reactor housing assembly, for receiving and outputting the electrocoagulatively treated contaminated water.

As for the electrocoagulative water contaminant removal system, in the electrocoagulation reactor unit, the electrocoagulation reactor housing assembly has therein: (i) a lower pair of electrode positioning, spacing, and holding elements, integrally configured and oppositely facing each other along lower sections of two oppositely facing walls of the electrocoagulation reactor housing assembly, and (ii) a complementary upper pair of electrode positioning, spacing, and holding elements, removably and replaceably configured and oppositely facing each other along upper sections of the two oppositely facing walls of the electrocoagulation reactor housing assembly.

By way of the output unit being a main component, and sub-combination of the electrocoagulative water contaminant removal system, the present invention also features another device, corresponding to the (first or primary) sedimentation, settling, or [water] clarification column (Primary Sedimentation Column (SC1)) of the output unit, for separating solid and solid-like electrocoagulation reaction products out from electrocoagulatively treated contaminated water. Thus, another main aspect of the present invention is provision of a sedimentation, settling, or [water] clarification column for separating solid and solid-like electrocoagulation reaction products out from electrocoagulatively treated contaminated water, including the following main components and functionalities thereof: (a) a first sediments-water separator assembly, for (i) receiving and separating the electrocoagulatively treated contaminated water into a first portion of sludge, and a first portion of water-with-sediments, and (ii) separating the first portion of water-with-sediments into a second portion of water-with-sediments, and a portion of cleaned water; and (b) a second sediments-water separator assembly, for receiving and separating the second portion of water-with-sediments into a second portion of sludge, and partially cleaned water.

Embodiments of the present invention include several special technical features, and, aspects of novelty and inventiveness over prior art teachings of electrocoagulatively removing contaminants from contaminated water. Embodiments of the present invention are particularly directed to appropriately addressing and overcoming several significant problems or limitations relating to design, construction, and operation, of and within an electrocoagulation reactor housing assembly included in an electrocoagulation reactor unit, and, of and within a ‘gravity-type’ sedimentation, settling, or [water] clarification, column, of an overall electrocoagulative water contaminant removal system. Specifically, three significant problems or limitations associated with current teachings of electrocoagulatively removing contaminants from contaminated water, which are appropriately addressed and overcome by embodiments of the present invention, relate to: (1) impractical or/and process interfering configurations of positioning, spacing, and holding electrodes inside an electrocoagulation reactor housing assembly, (2) existence of electrocoagulatively unreactive zones inside an electrocoagulation reactor housing assembly (containing electrodes), and (3) inefficient structure and operation (limited separation performance, efficiency) of a ‘gravity-type’ sedimentation, settling, or [water] clarification, column.

For appropriately addressing and overcoming (1), the first significant problem or limitation relating to impractical or/and process interfering configurations of positioning, spacing, and holding electrodes inside an electrocoagulation reactor housing assembly included in a more encompassing electrocoagulation reactor unit, herein, a special technical feature of embodiments of the present invention is that in the electrocoagulative water contaminant removal system, and in the electrocoagulation reactor unit, the electrocoagulation reactor housing assembly has therein: (i) a lower pair of electrode positioning, spacing, and holding elements, integrally configured and oppositely facing each other along lower sections of two oppositely facing walls of the electrocoagulation reactor housing assembly, and (ii) a complementary upper pair of electrode positioning, spacing, and holding elements, removably and replaceably configured and oppositely facing each other along upper sections of the two oppositely facing walls of the electrocoagulation reactor housing assembly.

For appropriately addressing and overcoming (2), the second significant problem or limitation relating to existence of electrocoagulatively unreactive zones inside an electrocoagulation reactor housing assembly (containing electrodes), herein, a special technical feature of embodiments of the present invention is that in the electrocoagulative water contaminant removal system, and in the electrocoagulation reactor unit, the electrocoagulation reactor housing assembly has therein a wall-electrode or electrode-wall electrocoagulatively unreactive sub-region, wherein each of two individual water ‘non-flowing’ and ‘non-contacting’ zones in the electrocoagulatively unreactive sub-region includes a (non-conductive, non-charged) interior face (surface) of one (e.g., left or right) end side wall configured flush against and directly contacting adjacent, nearest-neighboring, parallel and oppositely facing, and (positively or negatively) charged, face (surface) of an adjacent, nearest-neighboring, parallel and oppositely facing, and (positively or negatively) charged, (monopolar) electrode, thereby preventing the contaminated water and the electrocoagulatively treated contaminated water from flowing and making contact therebetween.

For appropriately addressing and overcoming (3), the third significant problem or limitation relating to inefficient structure and operation (limited separation performance, efficiency) of a ‘gravity-type’ sedimentation, settling, or [water] clarification, column, herein, a special technical feature of embodiments of the present invention is that the sedimentation, settling, or [water] clarification column, for separating solid and solid-like electrocoagulation reaction products out from electrocoagulatively treated contaminated water, includes: (a) a first sediments-water separator assembly, for receiving and separating the electrocoagulatively treated contaminated water into a first portion of sludge, a first portion of water-with-sediments, a second portion of water-with-sediments, and a portion of cleaned water; and (b) a second sediments-water separator assembly, for receiving and separating the second portion of water-with-sediments into a second portion of sludge, and partially cleaned water.

Also for appropriately addressing and overcoming (3), another special technical feature of embodiments of the present invention is that in the sedimentation, settling, or [water] clarification column, the first sediments-water separator assembly includes a water/sediments distributor assembly for receiving, and, laterally and circularly distributing the electrocoagulatively treated contaminated water throughout bottom section of the first sediments-water separator assembly. Moreover, the water/sediments distributor assembly includes a plurality of water distributing elements for effecting the distributing the electrocoagulatively treated contaminated water throughout the bottom section of the first sediments-water separator assembly.

Also for appropriately addressing and overcoming (3), another special technical feature of embodiments of the present invention is that in the sedimentation, settling, or [water] clarification column, the second sediments-water separator assembly includes a downward flow multi-conduit assembly for effecting the receiving the second portion of water-with-sediments, and, for directing downward flow of the second portion of water-with-sediments to bottom section of the second sediments-water separator assembly.

Additional special technical feature of embodiments of the present invention are apparent throughout the following illustrative description.

It is to be understood that the present invention is not limited in its application to the details of type, composition, construction, arrangement, order, and number, of the system units, system sub-units, devices, assemblies, sub-assemblies, mechanisms, structures, components, elements, and configurations, and, peripheral equipment, utilities, accessories, chemical reagents, and materials, of the system and main components thereof, or to the details of the order or sequence, number, of steps or procedures, and sub-steps or sub-procedures, of operation of the electrocoagulative water removal system and main components thereof (i.e., particularly, the electrocoagulation reactor unit, and the primary sedimentation column), set forth in the following illustrative description, accompanying drawings, and examples, unless otherwise specifically stated herein. For example, the following illustrative description includes detail of an exemplary specific embodiment of the system for electrocoagulatively removing contaminants from contaminated water, and includes detail of exemplary specific embodiments of the two main components of the electrocoagulative water contaminant removal system, being the electrocoagulation reactor unit, and the primary sedimentation column, in order to illustrate implementation of the present invention. Moreover, for example, these two main components, namely, the electrocoagulation reactor unit, and the (‘gravity type’, primary) sedimentation column, which are included and operative as integral parts of the electrocoagulative water contaminant removal system of the present invention, can also be included and operative, either singly or in combination, as parts of other electrocoagulative water contaminant removal systems. Accordingly, the present invention can be practiced or implemented according to various other alternative embodiments and in various other alternative ways.

Moreover, as stated hereinabove, the present invention is particularly directed to, and applicable for, removing heavy metal type contaminants composed of or including heavy metals (such as chromium, copper, nickel, zinc, tin, antimony, lead, manganese, and cadmium) from contaminated water. It is to be fully understood that the present invention is also directed to, and applicable for, removing non-metallic type contaminants composed of or including non-metals (such as organic chemical species [e.g., hydrocarbons—oils, fats, greases] or/and biological species [e.g., microorganisms—bacteria]) from contaminated water.

It is also to be understood that all technical and scientific words, terms, or/and phrases, used herein throughout the present disclosure have either the identical or similar meaning as commonly understood by one of ordinary skill in the art to which this invention belongs, unless otherwise specifically defined or stated herein. Phraseology, terminology, and, notation, employed herein throughout the present disclosure are for the purpose of description and should not be regarded as limiting. Moreover, all technical and scientific words, terms, or/and phrases, introduced, defined, described, or/and exemplified, in the above ‘Field’ and ‘Background’ sections, are equally or similarly applicable in the illustrative description of the exemplary embodiments, examples, and appended claims, of the present invention. Immediately following are selected definitions and exemplary usages of words, terms, or/and phrases, which are used throughout the illustrative description of the exemplary embodiments, examples, and appended claims, of the present invention, and are especially relevant for understanding thereof.

The phrase ‘contaminated water’, as used herein, generally refers to water which contains any combination of any number of a wide variety of different types, kinds, or forms, of contaminants, in a form of an aqueous solution, colloid, suspension, or emulsion. In general, the (water) contaminants are composed of inorganic or/and organic chemical species in the forms of (metallic or/and non-metallic) elements, ions, radicals, or/and compounds. The contaminants may include at least one type, kind, or form, of a ‘heavy metal specie’, where the phrase ‘heavy metal specie’, as used herein, generally refers to a heavy metal (such as chromium, copper, nickel, zinc, tin, antimony, lead, manganese, or cadmium) in the form of a free element (i.e., a free elemental form), a free ion (i.e., a free positively charged ion or cation), or/and in the form of a compound, radical, or/and ion (such as an inorganic or organic complex compound, radical, or/and ion, containing at least one heavy metal atom). The contaminants may alternatively, or additionally, include at least one type, kind, or form, of a non-metal, such as an organic chemical specie (e.g., a hydrocarbon—oil, fat, or grease) or/and a biological specie (e.g., a microorganism—bacterium). The phrase ‘contaminated water’, as used herein, is considered equivalent to, and synonymous with, the term ‘wastewater’ and the phrase ‘waste water’ (i.e., water containing waste(s)), the phrase ‘impure water’ (i.e., water containing impurity(ies)), and the phrase ‘polluted water’ (i.e., water containing pollutant(s)).

The term ‘electrocoagulation’ (abbreviated as EC), as used herein, refers to an electrochemical (electrolytic) process whereby solid (particulate), solid-like (particulate-like), or even emulsive, matter in a solution, colloid, suspension, or emulsion, type of aqueous medium, is electrochemically (electrolytically) coagulated, flocculated (flaked), precipitated, aggregated, agglomerated, or/and clumped, via any number and types of processes and mechanisms based on, or involving, coagulation, flocculation (flake formation), precipitation, aggregation, agglomeration, or/and clumping, respectively, for producing various different types, kinds, and forms, of solid and solid-like electrocoagulation reaction products [i.e., coagulates, flocculates (flocs or flakes), precipitates, aggregates (aggregations), agglomerates (agglomerations), or/and clumps), respectively] in the aqueous medium. The solid (particulate), solid-like (particulate-like), or emulsive, matter can be essentially any type or kind originating from essentially any source. The solid (particulate), solid-like (particulate-like), or emulsive, matter can be inorganic or/and organic matter which is obtained, derived, or originating from, naturally existing (mineral or biological types of) non-living matter or living matter, or synthetically manufactured. Depending upon the actual technical context, the term ‘electrocoagulation’ is often also referred to as, and considered synonymous with, the term ‘electroflocculation’ (i.e., electrochemical flocculation). Hereinafter, for convenience, and brevity, the term ‘electrocoagulation’, and the corresponding abbreviation ‘EC’, are used.

The phrase ‘electrocoagulatively treated contaminated water’, as used herein, refers to contaminated water, as just defined and described, that is provided by an external source; followed by being fed into and transported through the input unit; followed by being fed into, transported through, and electrocoagulatively treated or processed by the electrocoagulation reactor unit; followed by being fed into the output unit. Accordingly, the contaminated water is electrocoagulatively treated and transported via synchronized operation of the input unit, the electrocoagulation reactor unit, the output unit, and, the power supply and process control unit, for forming the ‘electrocoagulatively treated contaminated water’. Electrocoagulatively treated contaminated water is formed when the solid (particulate), solid-like (particulate-like), or even emulsive, matter in a solution, colloid, suspension, or emulsion, form in the contaminated water, is electrochemically (electrolytically) coagulated, flocculated (flaked), precipitated, aggregated, agglomerated, or/and clumped, via any number and types of processes and mechanisms based on, or involving, coagulation, flocculation (flake formation), precipitation, aggregation, agglomeration, or/and clumping, respectively, for producing various different types, kinds, and forms, of solid and solid-like electrocoagulation reaction products [i.e., coagulates, flocculates (flocs or flakes), precipitates, aggregates (aggregations), agglomerates (agglomerations), or/and clumps), respectively] in the contaminated water.

The term ‘sludge’, as used herein, refers to solid and solid-like (waste) matter (i.e., sediments, settled solids and semi-solids) mixed with, suspended in, or/and dissolved in, a relatively small amount of water. Sludge is formed as (final) separation (purification) product output by each of the first, primary sedimentation, settling, or [water] clarification, column, and the second, secondary sedimentation, settling, or [water] clarification, column, of the output unit which separates solid and solid-like electrocoagulation reaction products out from the electrocoagulatively treated to contaminated water fed thereto. Sludge so formed is pumped into, and collected in, a sludge collection tank of the output unit.

The phrase ‘water-with-sediments’, as used herein, refers to water containing a relatively small amount of (mixed, suspended, or/and dissolved) solid and solid-like (waste) matter (i.e., sediments, settled solids and semi-solids), compared to the electrocoagulatively treated contaminated water. Water-with-sediments is formed as a (preliminary or intermediate) separation (purification) product by the first, primary sedimentation, settling, or [water] clarification, column, of the output unit. Water-with-sediments so formed is subjected to further separation (purification) within the first, primary sedimentation, settling, or [water] clarification, column of the output unit.

The phrase ‘partially cleaned water’, as used herein, refers to water containing a relatively smaller amount of (mixed, suspended, or/and dissolved) solid and solid-like (waste) matter (i.e., sediments, settled solids and semi-solids), compared to ‘water-with-sediments’. Partially cleaned water is formed as a (final) separation (purification) product output by the first, primary sedimentation, settling, or [water] clarification, column, of the output unit. Partially cleaned water so formed is subjected to further separation (purification) within the second, secondary sedimentation, settling, or [water] clarification, column of the output unit. Partially cleaned water is also referred to by the phrases ‘partially purified water’, and ‘partially clarified water’.

The phrase ‘cleaned water’, as used herein, refers to water containing a relatively smaller amount of (mixed, suspended, or/and dissolved) solid and solid-like (waste) matter (i.e., sediments, settled solids and semi-solids), compared to ‘partially cleaned water’. Cleaned water is formed as (final) separation (purification) product output by each of the first, primary sedimentation, settling, or [water] clarification, column, and the second, secondary sedimentation, settling, or [water] clarification, column, of the output unit. Cleaned water so formed is pumped into, and collected in, a cleaned water tank of the output unit. Cleaned water is also referred to by the phrases ‘purified water’, ‘clarified water’, ‘fully cleaned water’, ‘fully purified water’, and ‘fully clarified water’.

The phrase ‘operatively connected’, as used herein, equivalently refers to the corresponding synonymous phrases ‘operatively joined’, and ‘operatively attached’, where the operative connection, operative joint, or operative attachment, is according to a physical, or/and electrical, or/and electronic, or/and mechanical, or/and electro-mechanical, manner or nature, involving various types and kinds of hardware or/and software equipment and components. With respect to operatively connected components which are structured and function for holding, mixing, transferring (e.g., pumping), measuring a parameter of, electrocoagulatively treating, separating solid and solid-like matter out from, or/and collecting, a fluid, such as contaminated water or any of the various different types, kinds, and forms, of electrocoagulation reaction products thereof, and separation (purification) products thereof, then, the phrase ‘operatively connected’, and corresponding synonyms thereof, as used herein, mean that the operatively connected components are in fluid communication with each other.

Each of the following terms: ‘includes’, ‘including’, ‘has’, ‘having’, ‘comprises’, and ‘comprising’, and, their derivatives and conjugates, means ‘including, but not limited to’.

Each of the phrases ‘consisting of’ and ‘consists of’ means ‘including and limited to’.

Each of the following terms written in singular grammatical form: ‘a’, ‘an’, and ‘the’, may also refer to, and encompass, a plurality of the stated entity or object, unless otherwise specifically defined or stated herein, or, unless the context clearly dictates otherwise. For example, the phrases ‘a device’, ‘an assembly’, ‘a mechanism’, ‘a component’, and ‘an element’, may also refer to, and encompass, a plurality of devices, a plurality of assemblies, a plurality of mechanisms, a plurality of components, and a plurality of elements, respectively.

The term ‘about’ refers to ±10% of the stated numerical value.

The phrase ‘room temperature’ refers to a temperature in a range of between about 20° C. and about 25° C.

Herein, distance is expressed in units of millimeters (mm), centimeters (cm), and meters (m).

Herein, area is expressed in units of square centimeters (cm²), and square meters (m²).

The phrase ‘milligram(s) per liter’, as used herein, refers to concentration of an indicated species (typically, a heavy metal type contaminant) expressed in terms of mass (weight) (i.e., milligrams) of the indicated species, per unit volume (i.e., liter) of water (e.g., in the form of contaminated water, electrocoagulatively treated contaminated water, or cleaned water), and is herein abbreviated as ‘mg/l’. The phrase ‘part(s) per million’, as used herein, refers to concentration of an indicated species (typically, a heavy metal type contaminant) expressed in terms of part(s) of the indicated species per one million parts of water (e.g., in the form of contaminated water, electrocoagulatively treated water, or cleaned water), and is herein abbreviated as ‘ppm’. With respect to concentration of an indicated species, the phrases ‘milligram(s) per liter’ and ‘part(s) per million’, as used herein, are synonymous and equivalent.

The phrase ‘liters per hour’, as used herein, refers to volumetric flow rate of water (e.g., in the form of contaminated water, electrocoagulatively treated contaminated water, or cleaned water) expressed in terms of (liquid) volume (i.e., liters) of the water per unit time (i.e., hour), and is herein abbreviated as ‘l/hr’. The phrase ‘cubic meters per hour’, as used herein, refers to volumetric flow rate of water (e.g., in the form of contaminated water, electrocoagulatively treated contaminated water, or cleaned water) expressed in terms of (spatial) volume (i.e., cubic meters) per unit time (i.e., hour), and is herein abbreviated as ‘m³/hr’. With respect to volumetric flow rate of the different forms of water, since 1000 liters per hour (l/hr)=1 cubic meter per hour (m³/hr), therefore, the phrases ‘1000 liters per hour’ and ‘1 cubic meter per hour’, as used herein, are synonymous and equivalent.

Throughout the illustrative description of the embodiments, the examples, and the appended claims, of the present invention, a numerical value of a parameter, feature, object, or dimension, may be stated or described in terms of a numerical range format. It is to be fully understood that the stated numerical range format is provided for illustrating implementation of the present invention, and is not to be understood or construed as inflexibly limiting the scope of the present invention. Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably. For example, for stating or describing the numerical range of room temperature, the phrase ‘room temperature refers to a temperature in a range of between about 20° C. and about 25° C.’, is considered equivalent to, and meaning the same as, the phrase ‘room temperature refers to a temperature in a range of from about 20° C. to about 25° C.’.

System units, system sub-units, devices, assemblies, sub-assemblies, mechanisms, structures, components, elements, and configurations, and, peripheral equipment, utilities, accessories, chemical reagents, and materials, steps or procedures, sub-steps or sub-procedures, as well as operation, and implementation, of exemplary embodiments, alternative exemplary embodiments, specific configurations, and, additional and optional aspects, characteristics, or features, thereof, of the electrocoagulative water removal system and main components thereof (i.e., particularly, the electrocoagulation reactor unit, and the primary sedimentation column) for electrocoagulatively removing contaminants from contaminated water, according to the present invention, are better understood with reference to the following illustrative description and accompanying drawings. Throughout the following illustrative description and accompanying drawings, same reference notation and terminology (i.e., numbers, letters, or/and symbols), refer to same system units, system sub-units, devices, assemblies, sub-assemblies, mechanisms, structures, components, elements, and configurations, and, peripheral equipment, utilities, accessories, chemical reagents, and materials, components, elements, or/and parameters.

According to a main aspect of the present invention, there is provision of a system for electrocoagulatively removing contaminants from contaminated water.

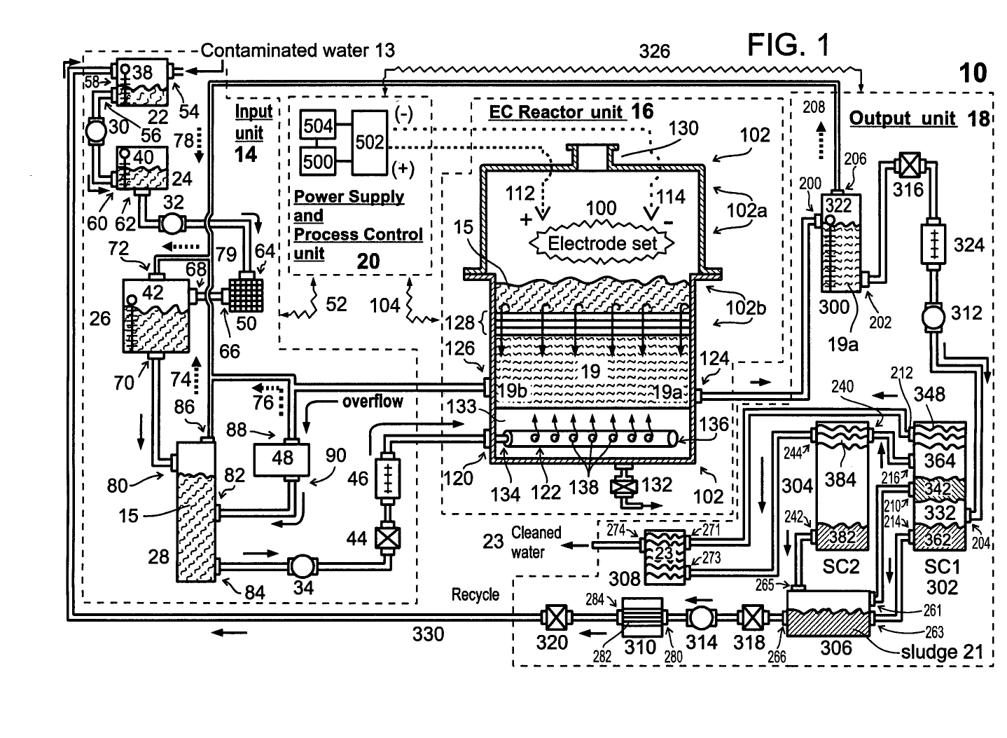

Referring now to the drawings, FIG. 1 is a schematic diagram illustrating a cut-away side view of an exemplary embodiment of the system 10 for electrocoagulatively removing contaminants from contaminated water 13, herein, also referred to as electrocoagulative water contaminant removal system 10.

As illustrated in FIG. 1, electrocoagulative water contaminant removal system 10 includes the following main components and functionalities thereof: (a) an input unit 14, for receiving and transporting the contaminated water 13; (b) an electrocoagulation (EC) reactor unit 16 operatively connected to the input unit 14, for receiving and electrocoagulatively treating the contaminated water 13, for forming electrocoagulatively treated contaminated water 19 (including first portion 19a, and second portion 19b); (c) an output unit 18 operatively connected to the electrocoagulation reactor unit 16, for receiving and transporting the electrocoagulatively treated contaminated water 19 (i.e., first portion 19a thereof), and for separating solid and solid-like electrocoagulation reaction products out from the electrocoagulatively treated contaminated water 19a, for forming sludge 21 and cleaned water 23; and (d) a power supply and process control unit 20, for supplying power to, and controlling processes of, the input unit 14, the electrocoagulation (EC) reactor unit 16, and the output unit 18. Structure/function (operation) of each main component, and components thereof, of electrocoagulative water contaminant removal system 10 are illustratively described as follows.

Contaminated Water, and Contaminants therein, Particularly Heavy Metals

Contaminated water 13 is supplied by an external source, and is fed into input unit 14 of electrocoagulative water contaminant removal system 10, for example, via a valve located between the outlet of the external source and the input of input unit 14. The external source, in general, is essentially any type of source or supply of water which contains contaminants, such as that defined and referred to herein as contaminated water 13. The external source, typically, is a source or supply of contaminated water 13 which is most commonly produced during an industrial process. Without limiting implementation of the present invention, well known and currently employed types of industrial processes which involve the production of contaminated water 13 are high volume throughput (for example, on the order of at least about 1000 liters per hour (l/hr) [1 cubic meter per hour (m³/hr)]) commercial scale industrial processes, involving, for example, metallic electro-etching, plating, or coating, of materials or components; manufacturing of electrical, electronic, or semiconductor, materials or components; mining or/and processing of minerals or metals; or, manufacturing or/and processing of pulp or paper. Electrocoagulative water contaminant removal system 10 of the present invention can be implemented for electrocoagulatively removing contaminants from contaminated water 13 produced by any of the just stated types of industrial processes.

Contaminated water 13 which is supplied from the external source and fed into input unit 14, generally refers to water which contains any combination of any number of a wide variety of different types, kinds, or forms, of contaminants, in a form of an aqueous solution, colloid, suspension, or emulsion. In general, the (water) contaminants are composed of inorganic or/and organic chemical species in the forms of (metallic or/and non-metallic) elements, ions, radicals, or/and compounds. The contaminants may include at least one type, kind, or form, of a ‘heavy metal specie’, where the phrase ‘heavy metal specie’ generally refers to a heavy metal (such as chromium, copper, nickel, zinc, tin, antimony, lead, manganese, or cadmium) in the form of a free element (i.e., a free elemental form), a free ion (i.e., a free positively charged ion or cation), or/and in the form of a compound, radical, or/and ion (such as an inorganic or organic complex compound, radical, or/and ion, containing at least one heavy metal atom). The contaminants may alternatively, or additionally, include at least one type, kind, or form, of a non-metal, such as an organic chemical specie (e.g., a hydrocarbon—oil, fat, or grease) or/and a biological specie (e.g., a microorganism—bacterium). Contaminated water 13, as used herein, is considered equivalent to, and synonymous with, the term ‘wastewater’ and the phrase ‘waste water’ (i.e., water containing waste(s)), the phrase ‘impure water’ (i.e., water containing impurity(ies)), and the phrase ‘polluted water’ (i.e., water containing pollutant(s)).

In contaminated water 13 which is supplied from the external source and fed into input unit 14, the actual form or forms of a particular contaminant, possible components thereof, and relative concentrations thereof, are determined by, and are direct functions of, the physicochemical properties, parameters, and characteristics, of the particular contaminant, of the possible components thereof, and of contaminated water 13. Primary physicochemical properties, parameters, and characteristics, are: (i) solubilities of the particular contaminant, and possible components thereof, (ii) temperature of contaminated water 13, (iii) pH of contaminated water 13, and (iv) the different types, kinds, or forms, of the other contaminants, being in one or more forms of solution, colloid, suspension, or/and emulsion, in contaminated water 13. In turn, these primary physicochemical properties, parameters, and characteristics, are determined by, and are direct functions of, the physicochemical properties, parameters, characteristics, and operating conditions, of the particular industrial process which produces contaminated water 13.

Contaminated water 13 which is supplied from the external source and fed into input unit 14, and which may contain any combination of any number of a wide variety of different forms of heavy metal species, may have exemplary ‘typical’ input heavy metal species concentrations as follows: 320 milligrams per liter (mg/l) [320 parts per million (ppm)] chromium [Cr]; 160 milligrams per liter (mg/l) [160 parts per million (ppm)] copper [Cu]; 100 milligrams per liter (mg/l) [100 parts per million (ppm)] nickel [Ni]; 100 milligrams per liter (mg/l) [100 parts per million (ppm)] zinc [Zn]; 100 milligrams per liter (mg/l) [100 parts per million (ppm)] tin [Sn]; 100 milligrams per liter (mg/l) [100 parts per million (ppm)] antimony [Sb]; 30 milligrams per liter (mg/l) [30 parts per million (ppm)] aluminum [Al]; 60 milligrams per liter (mg/l) [60 parts per million (ppm)] lead [Pb]; 15 milligrams per liter (mg/l) [15 parts per million (ppm)] manganese [Mn]; 12 milligrams per liter (mg/l) [12 parts per million (ppm)] molybdenum [Mo]; 12 milligrams per liter (mg/l) [12 parts per million (ppm)] cobalt [Co]; and 12 milligrams per liter (mg/l) [12 parts per million (ppm)] tungsten [W].

Contaminated water 13 which is supplied from the external source and fed into input unit 14, has a temperature, preferably, in a range of between about 5° C. and about 80° C., more preferably, in a range of between about 15° C. and about 40° C., and most preferably, in a range of between about 20° C. and about 30° C.

Contaminated water 13 which is supplied from the external source and fed into input unit 14, has a pH, preferably, larger than about 3. The pH of contaminated water which is supplied from the external source and fed into input unit 14 is determined by, and a direct function of, the physicochemical properties, parameters, and characteristics, of the particular contaminant(s), of the possible components thereof, and of the externally produced and supplied contaminated water 13, as well as determined by, and a direct function of, the physicochemical properties, parameters, and characteristics, and operating conditions, of the particular industrial process which produces contaminated water 13. The desired operating pH of contaminated water 13 which is ultimately fed into electrocoagulation reactor unit 16 is determined, and if necessary, adjusted, according to the particular contaminant(s), and possible components thereof, which are to be electrocoagulatively removed from contaminated water 13. In the event contaminated water 13 requires pH adjustment, then, there is inclusion of a pH adjustment step for adjusting (i.e., increasing or decreasing) the pH of contaminated water 13. Such a pH adjustment step involves, for example, adding a base or an acid to contaminated water 13 at a stage prior to input unit 14 feeding contaminated water 13 to electrocoagulation reactor unit 16.

Input Unit, and, Supplying, Receiving, Holding, and Transferring, the Contaminated Water

In the electrocoagulative water removal system of the present invention, the input unit is configured and functions for receiving and transporting the contaminated water which is supplied from an external source. Accordingly, with reference to FIG. 1, in electrocoagulative water removal system 10, input unit 14 is configured and functions for receiving and transporting contaminated water 13 which is supplied from an external source.

Input unit 14 is also configured and functions for supplying an appropriate quantity and quality of the received contaminated water 13 to electrocoagulation reactor unit 16. For achieving appropriate quality of contaminated water 13, input unit 14 may additionally include optional equipment for performing procedures based on pre-treatment of contaminated water 13 prior to supplying contaminated water 13 to electrocoagulation reactor unit 16. Exemplary common pre-treatments are: (1) pH adjustment, to adjust pH of the input contaminated water 13, according to an optimum pH range of the electrocoagulation reactions taking place inside electrocoagulation reactor unit 16, (2) filtration, to filter the input contaminated water 13, for removing undesirably large sized solid (particulate), or/and solid-like (particulate-like), matter out of contaminated water 13 which otherwise may interfere with or/and reduce proper operation, performance, and efficiency of the various units (especially, electrocoagulation reactor unit 16), and components thereof, of electrocoagulative water contaminant removal system 10, (3) foam reduction/removal, to reduce or entirely remove foam (e.g., via pressure differentials, or/and chemical treatment) from the input contaminated water 13, since the presence of foam in contaminated water 13 may: (i) interfere with proper pump operation, (ii) decrease conductivity during the electrocoagulation reactions in electrocoagulation reactor unit 16, or/and (iii) interfere with the various secondary or/and tertiary solid-liquid separation (purification) processes taking place in output unit 18, and (4) water throughput adjustment, to adjust the throughput (flow rate and quantity) of the input contaminated water 13 being transported throughout the various units, and components thereof, of electrocoagulative water contaminant removal system 10.

For performing the preceding functions, in electrocoagulative water contaminant removal system 10, input unit 14 includes the main components of: (i) a first mixing and holding tank 22, (ii) a first holding tank 24, (iii) a second holding tank 26, (iv) a second mixing and holding tank 28, (v) water pumps 30, 32, and 34, (vi) automatic water (volumetric or mass) level monitoring (measuring) and controlling mechanisms 38, 40, and 42, (vii) a valve 44, (viii) a water flow rate measuring mechanism 46, and (ix) a foam reduction/removal tank 48. Input unit 14, optionally, and preferably, also includes a water filter assembly 50. Each main component of input unit 14 is configured for being operatively connected to power supply and process control unit 20, via input unit electronic input/output control signal communications line 52.

### First Mixing and Holding Tank

First mixing and holding tank 22 is configured and functions for holding or containing contaminated water 13 which is supplied from the external source and fed into input unit 14. First mixing and holding tank 22 includes an inlet assembly 54 for receiving contaminated water 13 supplied from the external source, and an outlet assembly 56 through which contaminated water 13 exits first mixing and holding tank 22, and enters first holding tank 24. First mixing and holding tank 22 includes another inlet assembly 58 for receiving (a relatively small amount of) recycle water which is transferred, via water pump 314, valve 320, and recycle line 330, from a filter press 310 of output unit 18, as further illustratively described hereinbelow in the section of the output unit. Accordingly, first mixing and holding tank 22 is also configured and functions for receiving and mixing the (relatively small amount of the) recycle water with contaminated water 13 supplied from the external source.

First mixing and holding tank 22 is also configured and functions for enabling measurement, and, if necessary, adjustment of pH of the input contaminated water 13 (mixed with the recycle water) therein, particularly for establishing a pH in an optimum pH range of the particular electrocoagulation reactions taking place inside electrocoagulation reactor unit 16. Desired operating pH of contaminated water 13 which is ultimately fed into electrocoagulation reactor unit 16 is determined, and if necessary, adjusted, according to the particular contaminant(s), and possible components thereof, which are to be electrocoagulatively removed from contaminated water 13. In the event contaminated water 13 requires pH adjustment, then, there is adjusting (i.e., increasing or decreasing) the pH of contaminated water 13, involving, for example, adding an appropriate reagent (i.e., base or acid, respectively) to contaminated water 13 inside of first mixing and holding tank 22.

Via water pump 30, contaminated water 13 is pumped from the external source and into first mixing and holding tank 22, and, the (pH adjusted) contaminated water 13 (mixed with the recycle water) is pumped from first mixing and holding tank 22 and into first holding tank 24. The instantaneous level, and therefore, the instantaneous amount, of (pH adjusted) contaminated water 13 (mixed with the recycle water) inside of first mixing and holding tank 22 is monitored (measured) and controlled by operation of automatic water level monitoring (measuring) and controlling mechanism 38 which is configured for being operatively connected to power supply and process control unit 20, via input unit electronic input/output control signal communications line 52. Automatic water level monitoring (measuring) and controlling mechanism 38 is preferably located inside of first mixing and holding tank 22, as shown in FIG. 1.

### First Holding Tank

First holding tank 24 is configured and functions for receiving (pH adjusted) contaminated water 13 (mixed with the recycle water) from first mixing and holding tank 22, and for holding or containing (pH adjusted) contaminated water 13 (mixed with the recycle water) until the pH is uniform or homogeneous throughout (pH adjusted) contaminated water 13 (mixed with the recycle water). First holding tank 24 includes an inlet assembly 60 for receiving (pH adjusted) contaminated water 13 (mixed with the recycle water) from first mixing and holding tank 22, and an outlet assembly 62 through which uniform or homogeneous (pH adjusted) contaminated water 13 (mixed with the recycle water) exits first holding tank 24, and enters second holding tank 26.

The instantaneous level, and therefore, the instantaneous amount, of uniform or homogeneous (pH adjusted) contaminated water 13 (mixed with the recycle water) inside of first holding tank 24 is monitored (measured) and controlled by operation of automatic water level monitoring (measuring) and controlling mechanism 40 which is configured for being operatively connected to power supply and process control unit 20, via input unit electronic input/output control signal communications line 52. Automatic water level monitoring (measuring) and controlling mechanism 40 is preferably located inside of first holding tank 24, as shown in FIG. 1.

### Optional Water Filter Assembly

Optional water filter assembly 50 is configured and functions for optionally, and preferably, filtering uniform or homogeneous (pH adjusted) contaminated water 13 (mixed with the recycle water), for removing undesirably large sized solid (particulate), or/and solid-like (particulate-like), matter therefrom which otherwise may interfere with or/and reduce proper operation, performance, and efficiency of the various units (particularly, electrocoagulation reactor unit 16, especially therein, regarding the various electrocoagulation reactions taking place on or/and immediately near the electrode surfaces), and components thereof, of electrocoagulative water contaminant removal system 10.

Water filter assembly 50 includes an inlet assembly 64 for receiving uniform or homogeneous (pH adjusted) contaminated water 13 (mixed with the recycle water) from first holding tank 24, and an outlet assembly 66 through which the filtered, uniform or homogeneous (pH adjusted) contaminated water 13 (mixed with the recycle water) exits water filter assembly 50, and enters second holding tank 26. Water pump 32 pumps the uniform or homogeneous (pH adjusted) contaminated water 13 (mixed with the recycle water) from first holding tank 24, via outlet assembly 62, into and through water filter assembly 50, via inlet and outlet assemblies 64 and 66, respectively, and then pumps the filtered, uniform or homogeneous (pH adjusted) contaminated water 13 (mixed with the recycle water) into second holding tank 26.

Herein, for brevity, optionally filtered, uniform or homogeneous (pH adjusted) contaminated water 13 (mixed with the recycle water) is referred to as contaminated water 13.

### Second Holding Tank

Second holding tank 26 is configured and functions for receiving contaminated water 13 from first holding tank 24, and holding or containing contaminated water 13 as a large volume supply to second mixing and holding tank 28, until the instantaneous level thereof inside second holding tank 26 increases to (i.e., equals) a pre-determined minimum level sufficient for operation of water pump 34.

Second holding tank 26 includes an inlet assembly 68 for receiving contaminated water 13 from first holding tank 24, optionally, and preferably, via (optional) water filter assembly 50, and an outlet assembly 70 through which contaminated water 13 exits second holding tank 26, and enters second mixing and holding tank 28.

The instantaneous level, and therefore, the instantaneous amount, of contaminated water 13 inside of second holding tank 26 is monitored (measured) and controlled by operation of automatic water level monitoring (measuring) and controlling mechanism 42 which is configured for being operatively connected to power supply and process control unit 20, via input unit electronic input/output control signal communications line 52. Automatic water level monitoring (measuring) and controlling mechanism 42 is preferably located inside of second holding tank 26, as shown in FIG. 1.

Second holding tank 26 is also configured and functions for receiving, collecting, and absorbing or/and dissolving, and thereby, reducing or entirely removing, foam which may be: (1) inside, expelled, and sent from second mixing and holding tank 28, (2) collected, expelled, and sent from foam reduction/removal tank 48, and (3) inside, expelled, and sent from receiving and holding tank 300 of output unit 18.

Accordingly, second holding tank 26 also includes a foam inlet assembly 72 for: (i) receiving foam sent from second mixing and holding tank 28, as illustrated in FIG. 1 by the foam transport conduit (i.e., pipe or tube) shown adjacent to the thick dashed arrow 74 drawn above foam outlet assembly 86 of second mixing and holding tank 28, (ii) receiving foam sent from foam reduction/removal tank 48, as illustrated in FIG. 1 by the foam transport conduit shown adjacent to the thick dashed curved arrow 76 drawn above inlet assembly 88 of foam reduction/removal tank 48, and (iii) receiving foam sent from receiving and holding tank 300 of output unit 18, as illustrated in FIG. 1 by the foam transport conduit shown adjacent to the thick dashed arrow 78 drawn to the right of first holding tank 24.

The preceding sources of foam are sent to, and received by, second holding tank 26, via the junction (T join) 79 of the respective foam transport conduits, and via foam inlet assembly 72. The foam is absorbed or/and dissolved inside second holding tank 26, as a result of electrocoagulative water contaminant removal system 10 being designed, constructed, and operated, such that negative air pressure continuously exists inside second holding tank 26.

### Second Mixing and Holding Tank

Second mixing and holding tank 28 is configured and functions for receiving and holding or containing contaminated water 13 which exits second holding tank 26, and which eventually exits from input unit 14, in the form of electrocoagulation reactor unit feed 15.

Second mixing and holding tank 28 is also configured and functions for receiving a second portion 19b of electrocoagulatively treated contaminated water 19 which may exit, typically, as a relatively small amount of overflow, from electrocoagulation reactor unit 16, and for mixing (overflow) second portion 19b of electrocoagulatively treated contaminated water 19 with contaminated water 13 received from second holding tank 26. In such a case, contaminated water 13, mixed with the overflow, i.e., second portion 19b of electrocoagulatively treated contaminated water 19, from electrocoagulation reactor unit 16, make up electrocoagulation reactor unit feed 15 which exits second mixing and holding tank 28 and is fed into electrocoagulation reactor unit 16.

Second mixing and holding tank 28 includes: (i) a first inlet assembly 80 for receiving contaminated water 13 exiting from second holding tank 26, via outlet assembly 70; (ii) a second inlet assembly 82 for receiving (overflow) second portion 19b of electrocoagulatively treated contaminated water 19 exiting from electrocoagulation reactor unit 16, via a reactor housing second outlet assembly 126; and (iii) an outlet assembly 84 through which electrocoagulation reactor unit feed 15 exits from second mixing and holding tank 28, and eventually exits from input unit 14, and is fed into electrocoagulation reactor unit 16.

Contaminated water 13 enters second holding tank 26 until the instantaneous level thereof inside second holding tank 26 increases to (i.e., equals) a pre-determined minimum level sufficient for operation of water pump 34. When the instantaneous level of contaminated water 13 inside second holding tank 26 increases to (i.e., equals) the pre-determined minimum level sufficient for operation of water pump 34, central programming and electronic input/output control signal processing assembly 504 of power supply and process control unit 20, via input unit electronic input/output control signal communications line 52, sends a {valve-open} process control signal to valve 44 for actuating and opening valve 44, and simultaneously sends a {pump-on} process control signal to water pump 34 for actuating and turning-on water pump 34, thereby initiating and directing electrocoagulation reactor unit feed 15 to flow from second mixing and holding tank 28, via outlet assembly 84, through water pump 34, through valve 44, then through water flow rate measuring mechanism 46, and into reactor housing bottom section 102b of electrocoagulation reactor housing assembly 102 of electrocoagulation reactor unit 16, via a reactor housing inlet assembly 120.

Electrocoagulation reactor unit feed 15, pumped by water pump 34 from second mixing and holding tank 28 and into electrocoagulation reactor unit 16, has a volumetric flow rate, preferably, in a range of between about 0.5 liter per hour (l/hr) [0.0005 cubic meter per hour (m³/hr)] and about 20,000 liters per hour (l/hr) [20 cubic meter per hour (m³/hr)], more preferably, in a range of between about 10 liters per hour (l/hr) [0.01 cubic meter per hour (m³/hr)] and about 10,000 liters per hour (l/hr) [10 cubic meters per hour (m³/hr)], most preferably, in a range of between about 100 liters per hour (l/hr) [0.1 cubic meter per hour (m³/hr)] and about 5000 liters per hour (l/hr) [5 cubic meters per hour (m³/hr)], with a most preferred flow rate of about 1000 liters per hour (l/hr) [1 cubic meter per hour (m³/hr)].

The (volumetric or mass) flow rate of electrocoagulation reactor unit feed 15 exiting from second mixing and holding tank 28 and entering electrocoagulation reactor unit 16 is controlled by valve 44, and is measured by water flow rate measuring mechanism 46, for example, a flow meter configured and operable for measuring flow rates of a liquid, particularly, water, such as water containing contaminants. Valve 44 and water flow rate measuring mechanism 46 are each configured for being operatively connected to power supply and process control unit 20, via input unit electronic input/output control signal communications line 52.

Second mixing and holding tank 28 is also configured and functions for expelling, and thereby, reducing or entirely removing, foam which may be present inside second mixing and holding tank 28, from second mixing and holding tank 28. Foam inside second mixing and holding tank 28 is expelled, and thereby, reduced or entirely removed, via positive air pressure continuously existing inside second mixing and holding tank 28, from second mixing and holding tank 28.

Accordingly, second mixing and holding tank 28 also includes a foam outlet assembly 86 for expelling foam inside second mixing and holding tank 28, from second mixing and holding tank 28, as illustrated in FIG. 1 by the foam transport conduit shown adjacent to the thick dashed arrow 74 drawn above foam outlet assembly 86 of second mixing and holding tank 28.

Foam which inside second mixing and holding tank 28, is expelled, and thereby reduced or entirely removed, from, second mixing and holding tank 28, as a result of electrocoagulative water contaminant removal system 10 being designed, constructed, and operated, such that positive air pressure continuously exists inside second mixing and holding tank 28. Foam expelled from second mixing and holding tank 28 is sent to, and received by, second holding tank 26, via foam transport conduit junction (T join) 79, and via foam inlet assembly 72. The foam is absorbed or/and dissolved inside second holding tank 26, as a result of electrocoagulative water contaminant removal system 10 being designed, constructed, and operated, such that negative air pressure continuously exists inside second holding tank 26.

### Foam Reduction/Removal Tank

In electrocoagulative water contaminant removal system 10, input unit 14 additionally includes a foam reduction/removal tank 48, for reducing or entirely removing foam which may co-transport with (overflow) second portion 19b of electrocoagulatively treated contaminated water 19 exiting from electrocoagulation reactor unit 16.

Foam reduction/removal tank 48 is configured and functions for receiving, collecting, and expelling, and thereby, reducing or entirely removing, foam which co-transports with (overflow) second portion 19b of electrocoagulatively treated contaminated water 19 exiting from electrocoagulation reactor unit 16, via reactor housing second outlet assembly 124, while at the same time, allowing transport and passage of (overflow) second portion 19b of electrocoagulatively treated contaminated water 19 exiting from electrocoagulation reactor unit 16, and entering into second mixing and holding tank 28.

Foam reduction/removal tank 48 includes: (i) an inlet assembly 88 for receiving (overflow) second portion 19b of electrocoagulatively treated contaminated water 19 exiting from electrocoagulation reactor unit 16, via reactor housing second outlet assembly 124, and (ii) an outlet assembly 90 for allowing transport and passage of (overflow) second portion 19b of electrocoagulatively treated contaminated water 19 into second mixing and holding tank 28, via second inlet assembly 82.

Foam which co-transports with (overflow) second portion 19b of electrocoagulatively treated contaminated water 19 exiting from electrocoagulation reactor unit 16, is received and collected by foam reduction/removal tank 48, and is expelled, and thereby, reduced or entirely removed, from (overflow) second portion 19b, as illustrated in FIG. 1 by the foam transport conduit shown adjacent to the thick dashed curved arrow 76 drawn above inlet assembly 88 of foam reduction/removal tank 48. Electrocoagulative water contaminant removal system 10 is designed, constructed, and operated, such that positive air pressure continuously exists inside foam reduction/removal tank 48. Foam expelled from foam reduction/removal tank 48 is sent to, and received by, second holding tank 26, via foam transport conduit junction (T join) 79, and via foam inlet assembly 72, and is absorbed or/and dissolved inside second holding tank 26, via negative air pressure continuously existing inside second holding tank 26.

As illustratively described hereinabove, electrocoagulative water contaminant removal system 10 is designed, constructed, and operated, wherein: (A) second holding tank 26 receives, collects, and absorbs or/and dissolves, and thereby, reduces or entirely removes, foam which may be: (1) inside, expelled, and sent from second mixing and holding tank 28, (2) collected, expelled, and sent from foam reduction/removal tank 48, and (3) inside, expelled, and sent from receiving and holding tank 300 of output unit 18; (B) second mixing and holding tank 28 expels, and thereby, reduces or entirely removes, foam inside second mixing and holding tank 28, from second mixing and holding tank 28; and (C) foam reduction/removal tank 48 receives, collects, and expels, and thereby, reduces or entirely removes, foam which co-transports with (overflow) second portion 19b of electrocoagulatively treated contaminated water 19 exiting from electrocoagulation reactor unit 16.

Foam reduction/removal equipment and procedures are included in the design, construction, and operation of electrocoagulative water contaminant removal system 10 in order to reduce or entirely remove foam from contaminated water 13, since the presence of foam in contaminated water 13 may: (i) interfere with proper pump operation, (ii) decrease conductivity during the electrocoagulation reactions in electrocoagulation reactor unit 16, or/and (iii) interfere with the various secondary or/and tertiary solid-liquid separation (purification) processes taking place in output unit 18.

Additional Structure, Function, and Operation of the Input Unit, and Components thereof.

Additional details regarding structure, function, and operation, of input unit 14, and components thereof, of electrocoagulative water contaminant removal system 10 shown in FIG. 1, which are relevant to implementing the herein illustratively described exemplary embodiments of the system for electrocoagulatively removing contaminants from contaminated water 13, for producing cleaned water 23 and sludge 21, of the present invention, are provided in the following.

Input unit 14 and components thereof include any additional necessary fluid transfer equipment (the main ones of which are illustratively described hereinabove), such as pipes, tubes, connecting elements, adaptors, fittings, screws, nuts, bolts, washers, o-rings, water pumps, valves, vents, and switches, as well as mechanisms, assemblies, components, and elements thereof, which are made of suitable materials, for fully enabling input unit 14 and components thereof to receive, filter, hold or contain, monitor (measure) and control, and transfer, water, such as contaminated water 13, which is supplied from an external source.

Automatic electronic monitoring (measuring) and controlling of operating parameters and conditions of input unit 14 and components thereof, are enabled by power supply and process control unit 20 and components thereof. Electronic input/output, feedforward and feedback transmission and reception of electronic control data, information, and command, communication signals between input unit 14 and components thereof, and, power supply and process control unit 20 and components thereof, are provided by an electronic input/output control data, information, and command, communications line, such as a cable or bundle of wires, or/and a wireless communications line, herein, generally indicated in FIG. 1 as input unit electronic input/output control signal communications line 52.

Input unit 14 includes any additional necessary mechanical, hydraulic, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of input unit 14 and components thereof, by power supply and process control unit 20 and components thereof.

Input unit 14 and components thereof are configured with, constructed of, and operate with, standard mechanical, hydraulic, electrical, electronic, electro-mechanical, and (wired or/and wireless) communications, mechanisms, assemblies, structures, components, elements, and materials, known in the art of automatically receiving, filtering, holding or containing, monitoring (measuring) and controlling, and transferring, water, such as contaminated water 13, which is supplied from an external source.

Input unit 14 and components thereof are preferably of configurations and constructions which are compatible with, and operated in accordance with, the physicochemical properties, parameters, and characteristics, of the particular contaminant specie(s) of contaminated water 13, as well as with the physicochemical properties, parameters, characteristics, and operating conditions, of the external source which supplies contaminated water 13 to input unit 14, as well as with the physicochemical properties, parameters, characteristics, and operating conditions, of the other units, in particular, electrocoagulation reactor unit 16, output unit 18, and, power supply and process control unit 20, of electrocoagulative water contaminant removal system 10, which together are configured and synchronously operated for electrocoagulatively removing contaminants from contaminated water 13, for producing cleaned water 23 and sludge 21.

### Electrocoagulation Reactor Unit, and Electrocoagulatively Treating the Contaminated Water

In the electrocoagulative water removal system of the present invention, the electrocoagulation reactor unit is operatively connected to the input unit, and is configured and functions for receiving and electrocoagulatively treating the contaminated water, for forming electrocoagulatively treated contaminated water. Accordingly, with reference to FIG. 1, in electrocoagulative water removal system 10, electrocoagulation reactor unit 16 is operatively connected to input unit 14, and is configured and functions for receiving and electrocoagulatively treating contaminated water 13, for forming electrocoagulatively treated contaminated water 19.

In a synchronous manner, at about the same time of, or shortly after, initiating and directing electrocoagulation reactor unit feed 15 to flow from second mixing and holding tank 28 and into reactor housing bottom section 102b of electrocoagulation reactor housing assembly 102 of electrocoagulation reactor unit 16, central programming and electronic input/output control signal processing assembly 504 sends a {power-on} process control signal to power supply monitoring (measuring) and controlling mechanism 500, for actuating (and turning-on) and controlling power supply assembly 502 in a manner such that power supply assembly 502 starts supplying power to the electrodes of an electrode set 100 of electrocoagulation reactor unit 16. Therein, various electrocoagulation (electrolytic, electrochemical) reactions and associated physicochemical processes are initiated for electrocoagulatively treating contaminated water 13, for forming electrocoagulatively treated contaminated water 19.

Electrocoagulation reactor unit feed 15 flows into a reactor unit feed distributor assembly 122 via a reactor housing inlet assembly 120, then upwardly flows out of reactor unit feed distributor assembly 122 via perforations or holes 138 (as indicated in FIG. 1 by the small wavy arrows vertically emerging from perforations or holes 138) and into reactor housing bottom section 102b of electrocoagulation reactor housing assembly 102 of electrocoagulation reactor unit 16, and continues to upwardly flow into and throughout the immediate vicinity of electrode set 100 and the electrodes therein. Therein, the various electrocoagulation (electrochemical, electrolytic) reactions and associated physicochemical processes take place, whereby the solid (particulate), solid-like (particulate-like), or even emulsive, matter in one or more forms of a solution, colloid, suspension, or emulsion, in contaminated water 13, is electrocoagulatively (electrochemically, electrolytically) coagulated, flocculated (flaked), precipitated, aggregated, agglomerated, or/and clumped, via any number and types of processes and mechanisms based on, or involving, coagulation, flocculation (flake formation), precipitation, aggregation, agglomeration, or/and clumping, respectively, for producing various different types, kinds, and forms, of solid and solid-like electrocoagulation reaction products [i.e., coagulates, flocculates (flocs or flakes), precipitates, aggregates (aggregations), agglomerates (agglomerations), or/and clumps), respectively] in electrocoagulatively treated contaminated water 19.

Electrocoagulation reactor unit 16 is configured for being operatively connected to input unit 14, output unit 18, and, power supply and process control unit 20. Electrocoagulation reactor unit 16 functions for electrocoagulatively treating contaminated water 13, via synchronized operation with input unit 14, output unit 18, and, power supply and process control unit 20, for forming electrocoagulatively treated contaminated water 19.

Electrocoagulation reactor unit 16 includes the main components of: (i) a set 100 of electrodes, herein, also referred to as an electrode set 100, and (ii) an electrocoagulation reactor housing assembly 102 (encompassing reactor housing top section 102a and reactor housing bottom section 102b). Electrocoagulation reactor unit 16 is configured for being operatively connected to power supply and process control unit 20, via electrocoagulation reactor unit electronic input/output control signal communications line 104.

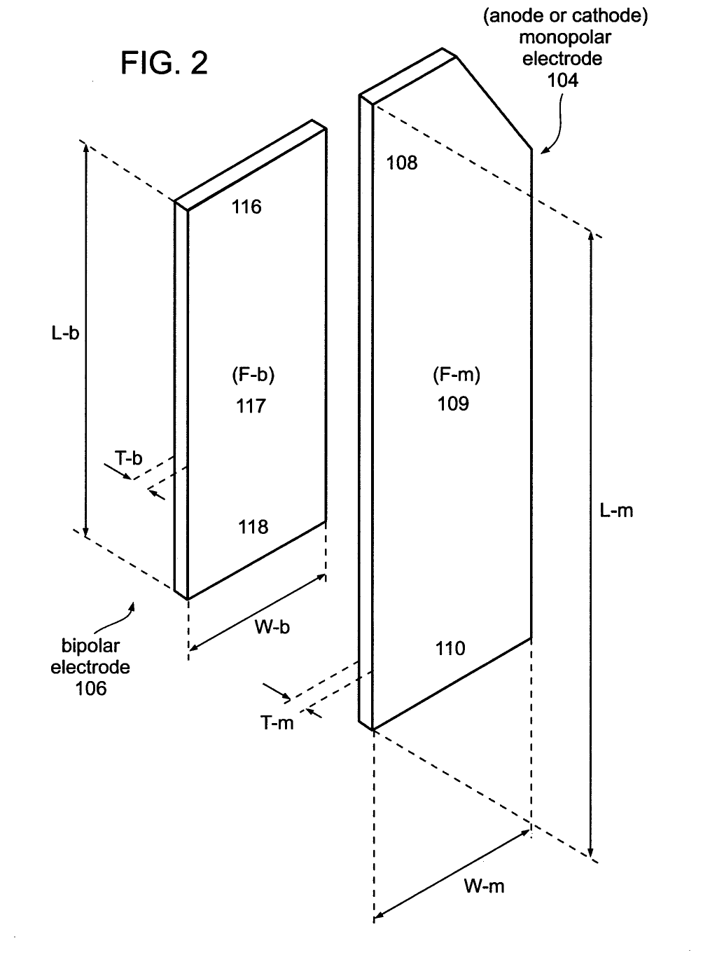

Along with reference to FIG. 1, reference is also made to the following figures, FIGS. 2-9.

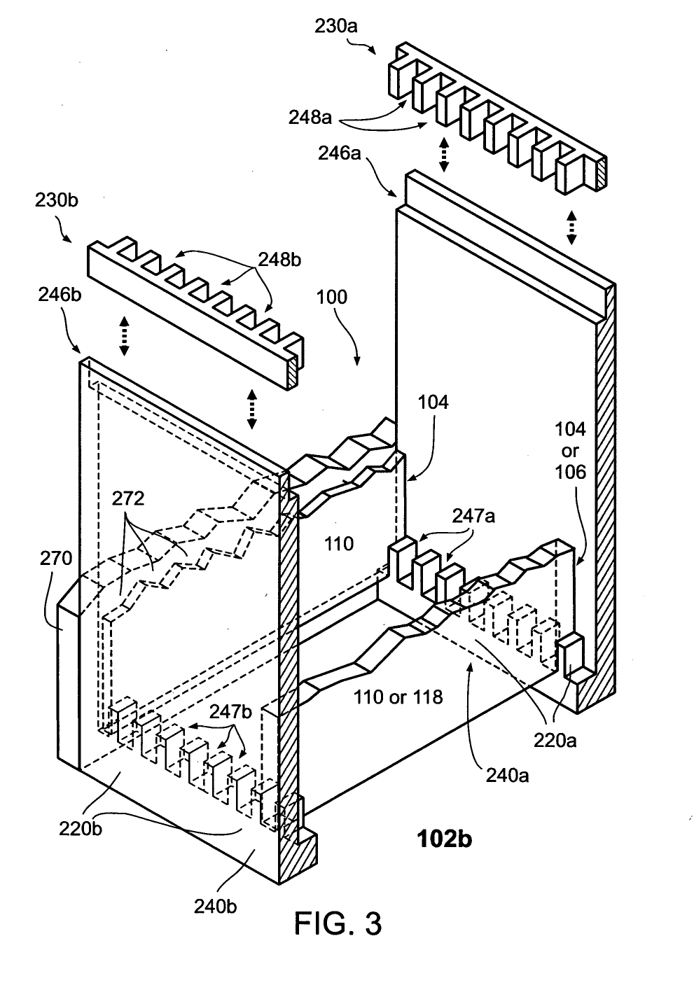

FIG. 2 is a schematic diagram illustrating a perspective view of an exemplary embodiment of a (anode or cathode) monopolar electrode 104 and of a bipolar electrode 106, which are representative of electrodes included in electrode set 100 of electrocoagulation reactor unit 16 included in electrocoagulative water contaminant removal system 10 illustrated in FIG. 1, and which are positioned, spaced, and held, via the complementary pairs of bottom and top electrode positioning, spacing, and holding elements, in (the bottom section 102b of) electrocoagulation reactor housing assembly 102 illustrated in FIG. 3.

FIG. 3 is a schematic diagram illustrating a perspective view of (part of) an exemplary embodiment of the bottom section 102b of the electrocoagulation reactor housing assembly 102, [highlighting (i) an exemplary embodiment of the lower pair of integrally configured and oppositely facing electrode positioning, spacing, and holding elements 220a and 220b, and an exemplary embodiment of the complementary upper pair of removably and replaceably configured and oppositely facing electrode positioning, spacing, and holding elements 230a and 230b, therein, and (ii) an exemplary embodiment of one zone 272 of the two zones of the end wall-electrode or electrode-end wall ‘electrocoagulatively unreactive’ sub-region therein], being part of the electrocoagulation reactor unit 16 included in the electrocoagulative water contaminant removal system 10 illustrated in FIG. 1.

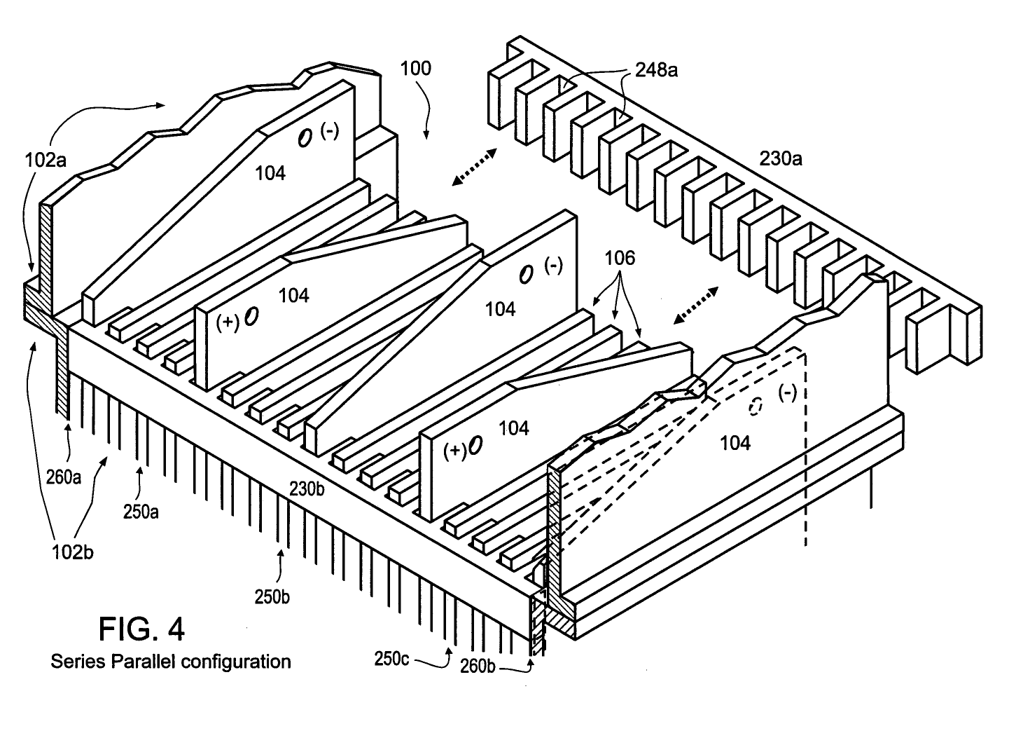

FIG. 4 is a schematic diagram illustrating a perspective view of (part of) an exemplary embodiment of a series parallel (spatial-electrical) configuration of (anode and cathode) monopolar electrodes 104 and bipolar electrodes 106 of a series parallel (spatially-electrically) configured electrode set 100, inside (the bottom section 102b of) the electrocoagulation reactor housing assembly 102 illustrated in FIG. 3, being part of the electrocoagulation reactor unit 16 included in the electrocoagulative water contaminant removal system 10 illustrated in FIG. 1, for additionally illustrating special technical (structural and functional) features and characteristics of the exemplary embodiments highlighted in FIG. 3.

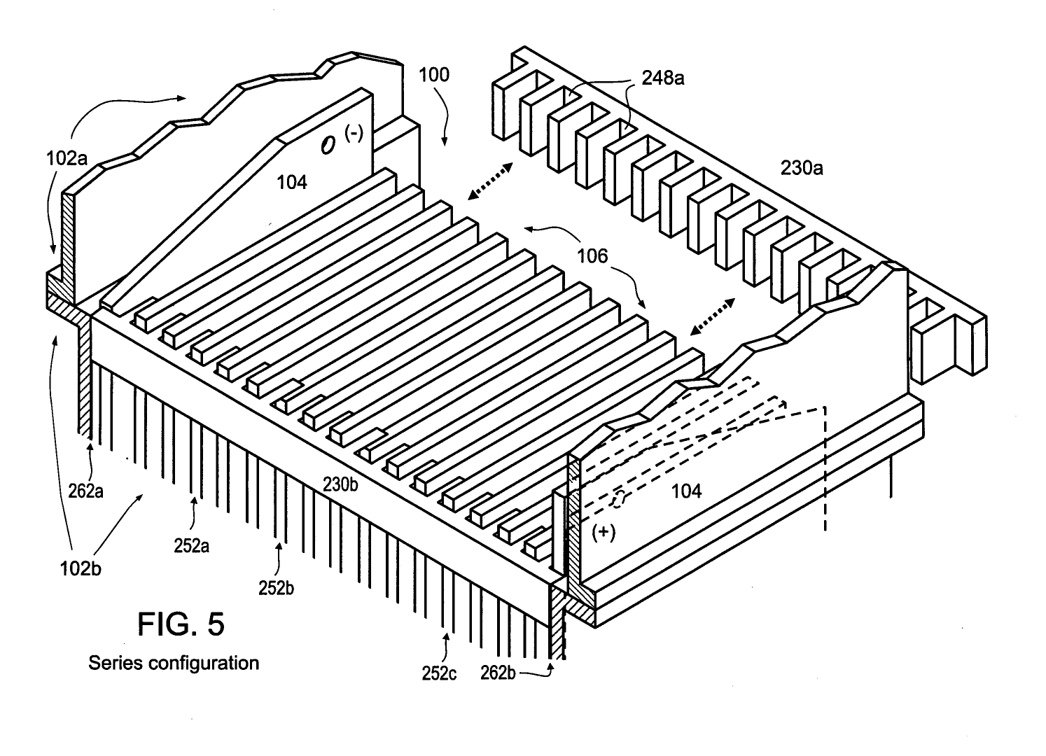

FIG. 5 is a schematic diagram illustrating a perspective view of (part of) an exemplary embodiment of a series (spatial-electrical) configuration of (anode and cathode) monopolar electrodes 104 and bipolar electrodes 106 of a series (spatially-electrically) configured electrode set 100, inside (the bottom section 102b of) the electrocoagulation reactor housing assembly 102 illustrated in FIG. 3, being part of the electrocoagulation reactor unit 16 included in the electrocoagulative water contaminant removal system 10 illustrated in FIG. 1, for additionally illustrating special technical (structural and functional) features and characteristics of the exemplary embodiments highlighted in FIG. 3.

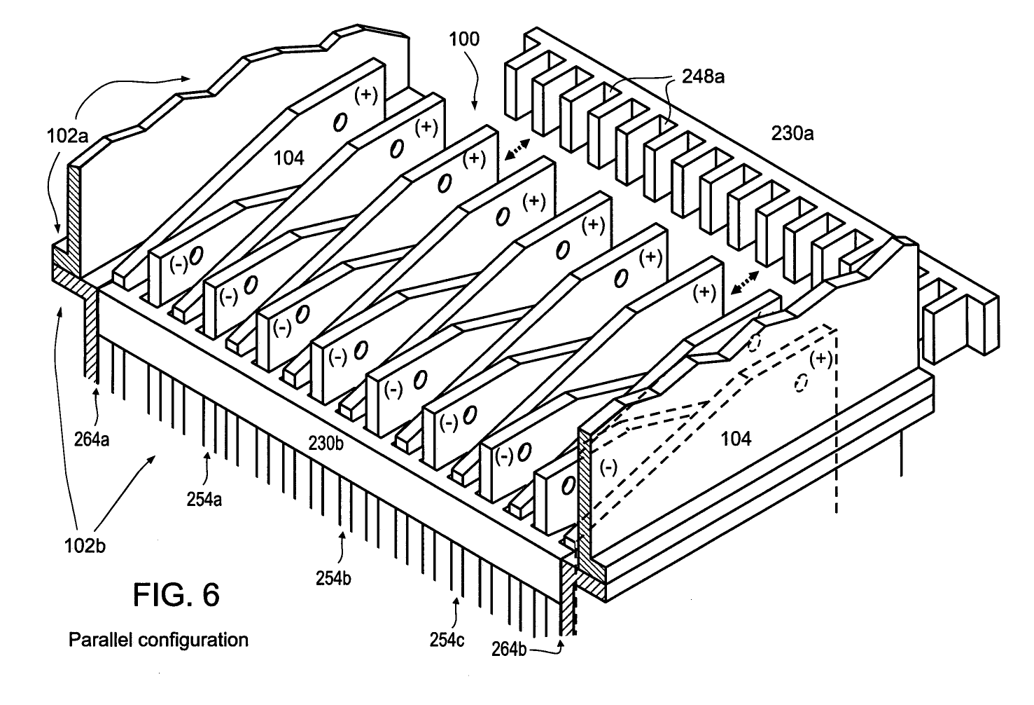

FIG. 6 is a schematic diagram illustrating a perspective view of (part of) an exemplary embodiment of a parallel (spatial-electrical) configuration of (anode and cathode) monopolar electrodes 104 (without bipolar electrodes) of a parallel (spatially-electrically) configured electrode set 100, inside (the bottom section 102b of) the electrocoagulation reactor housing assembly 102 illustrated in FIG. 3, being part of the electrocoagulation reactor unit 16 included in the electrocoagulative water contaminant removal system 10 illustrated in FIG. 1, for additionally illustrating special technical (structural and functional) features and characteristics of the exemplary embodiments highlighted in FIG. 3.

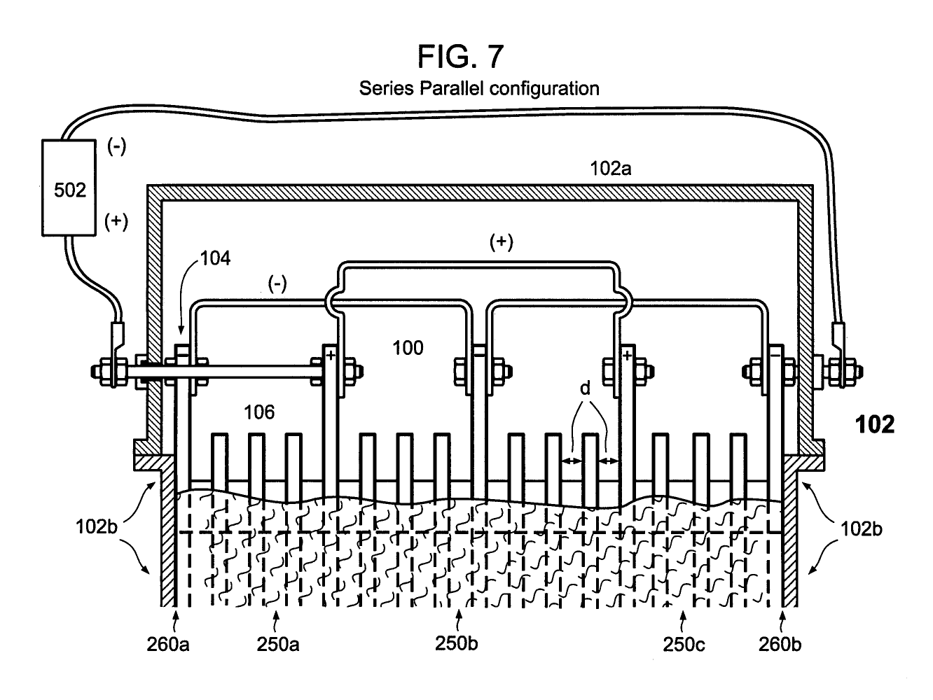

FIG. 7 is a schematic diagram illustrating a cut-away side view of an exemplary embodiment of a series parallel (spatial-electrical) configuration of (anode and cathode) monopolar electrodes 104 and bipolar electrodes 106 of a series parallel (electrically) configured electrode set 100, inside the electrocoagulation reactor housing assembly 102 illustrated in FIG. 3, which is associated with the spatial-electrical configuration illustrated in FIG. 4.

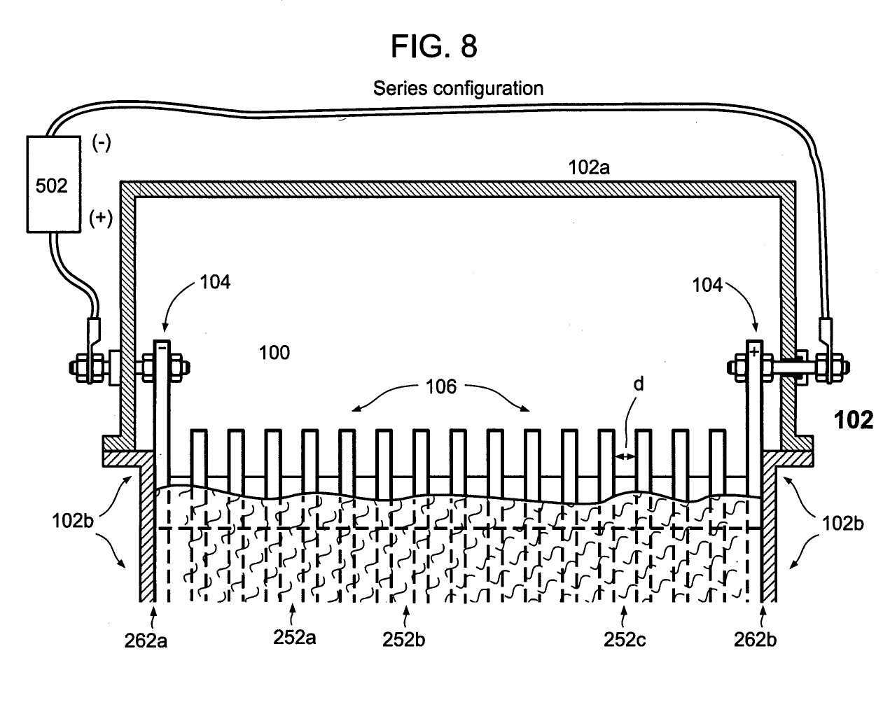

FIG. 8 is a schematic diagram illustrating a cut-away side view of an exemplary embodiment of a series (spatial-electrical) configuration of (anode and cathode) monopolar electrodes 104 and bipolar electrodes 106 of a series (electrically) configured electrode set 100, inside the electrocoagulation reactor housing assembly 102 illustrated in FIG. 3, which is associated with the spatial-electrical configuration illustrated in FIG. 5.

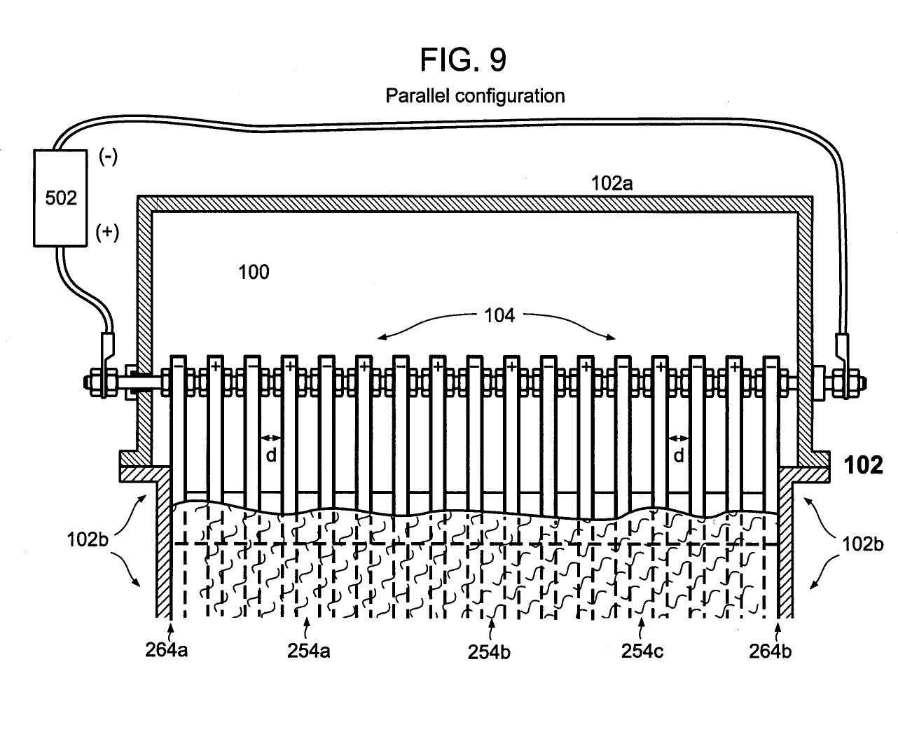

FIG. 9 is a schematic diagram illustrating a cut-away side view of an exemplary embodiment of a parallel (spatial-electrical) configuration of (anode and cathode) monopolar electrodes 104 (without bipolar electrodes) of a parallel (electrically) configured electrode set 100, inside the electrocoagulation reactor housing assembly 102 illustrated in FIG. 3, which is associated with the spatial-electrical configuration illustrated in FIG. 6.

Electrode Set, and Electrodes thereof.

In electrocoagulation reactor unit 16, an electrode set 100 of at least two, preferably more than two, for example, seventeen, separate plate, slab, or sheet, type shaped (anode and cathode) monopolar electrodes 104 and bipolar electrodes 106, appropriately positioned and spaced apart from each other, is housed inside electrocoagulation reactor housing assembly 102. Therein, the (anode and cathode) monopolar electrodes 104 and bipolar electrodes 106 of electrode set 100 are configured and positioned, for example (as shown in the figures), vertically [i.e., with electrode faces vertically lined up in parallel from one (e.g., left or right) end side wall to an opposite (e.g., right or left, respectively) end side wall], or, alternatively (not shown in the figures), horizontally [i.e., with electrode faces horizontally stacked in parallel from the top end wall to the bottom end wall].

In electrode set 100 of electrocoagulation reactor unit 16, with reference to FIG. 2, each (anode or cathode) monopolar electrode 104 has a top end portion 108, a middle portion 109, and a bottom end portion 110. The top end portion 108 of each (anode or cathode) monopolar electrode 104 is electrically connectable, for example, via respective positive (+) electrical leads 112 and negative (−) electrical leads 114 (as generally illustrated in FIG. 1, and specifically illustrated in FIGS. 7-9) to power supply assembly 502 of power supply and process control unit 20. As generally to illustrated in FIGS. 4-9, the ‘trapezoidal-like’ geometrical shape or form of the top end portion 108 of each (anode or cathode) monopolar electrode 104 includes at least one hole, and for example, a set of a number of, for example, three to five, holes, for enabling electro-mechanical connection of respective positive (+) electrical leads 112 and negative (−) electrical leads 114 to power supply assembly 502 of power supply and process control unit 20.

In electrode set 100 of electrocoagulation reactor unit 16, with reference to FIG. 2, each bipolar electrode 106 has a top end portion 116, a middle portion 117, and a bottom end portion 118. The bipolar electrodes 106 are symmetrical with respect to top and bottom end portions 116 and 118, respectively, and are not electrically connectable, via electrical leads, to power supply assembly 502 of power supply and process control unit 20.

During operation of electrode set 100 of electrocoagulation reactor unit 16, and while the various electrocoagulation reactions take place for electrocoagulatively treating contaminated water 13, the electrically connected top end portion 108 of each (anode or cathode) monopolar electrode 104 is ordinarily unexposed to electrocoagulation reactor unit feed 15 or electrocoagulatively treated contaminated water 19, while the bottom end portion 110 of each (anode or cathode) monopolar electrode 104 is ordinarily exposed to, and surrounded by, electrocoagulation reactor unit feed 15 and electrocoagulatively treated contaminated water 19.

In electrode set 100, the (anode and cathode) monopolar electrodes 104 and bipolar electrodes 106 are, for example, of the same material, which enables relatively easy cleaning of the electrodes by reversing the polarity (charge) of the electrodes. In general, the electrodes are of a material being essentially any elemental metal which dissolves to at least some extent in water, such as contaminated water 13. Exemplary anode and cathode electrode materials are elemental metals, for example, iron (Fe), and aluminum (Al), since these are well known as being excellent for electrocoagulatively treating contaminated water. The anodes can be of different material than the cathodes, however, such an embodiment would not be suitable for cleaning the electrodes via reversing electrode polarity.

An important objective during operation of electrocoagulation reactor unit 16 is to maximize the effectiveness of electrocoagulatively treating contaminated water 13 inside electrocoagulation reactor housing assembly 102, particularly within the regions wherein the (anode and cathode) monopolar electrodes 104 and bipolar electrodes 106 of electrode set 100 are contacted by contaminated water 13. Accordingly, for each of the three alternative (electrical) configurations [i.e., (i) series parallel, (ii) series, and (iii) parallel)] of electrode set 100, preferably, all of the (monopolar and bipolar) electrodes are made of material(s) which is/are suitable for effecting electrocoagulation type electrolytic processes that take place in water. Such material(s) typically is/are made of a pure metal, of a combination (e.g., composite or alloy) of two or more pure metals, where each metal is relatively soluble in water or aqueous solutions. Exemplary suitable pure metals are selected from the group consisting of iron [Fe], aluminum [Al], copper [Cu], nickel [Ni], and zinc [Zn]. An exemplary suitable composite of two pure metals is a composite of iron [Fe] and aluminum [Al].

The (anode and cathode) monopolar electrodes 104 and bipolar electrodes 106 are structured, and arranged inside electrocoagulation reactor housing assembly 102 of electrocoagulation reactor unit 16, according to specially determined combinations of ranges of geometrical dimensions (in particular, length, width, and thickness), and function according to specially determined combinations of ranges of operating parameters and conditions (in particular, current and voltage supplied to the electrodes, and electrode current density generated thereby). Electrocoagulation reactor unit feed 15 and electrocoagulatively treated contaminated water 19 flow and circulate throughout the total region encompassing the (anode and cathode) monopolar electrodes 104 and bipolar electrodes 106 positioned, spaced apart, and held inside electrocoagulation reactor housing assembly 102.

For a specific embodiment of a parallel (spatial-electrical) configuration of (anode and cathode) monopolar electrodes 104 (without bipolar electrodes) of a parallel (spatially-electrically) configured electrode set 100, inside electrocoagulation reactor housing assembly 102 (as shown in FIG. 9), preferably, a fixed metal rod extends through holes of, and electrically connects, same charge monopolar electrodes to each other (i.e., cathodes to cathodes, and anodes to anodes). The metal rod extends through a hole configured in the ‘trapezoidal-like’ geometrical shape or form of top end portion 108 of each (anode or cathode) monopolar electrode 104, and is held fixed via bolts and washers on the inner and outer sides of the top section 102a of electrocoagulation reactor housing assembly 102. Electrical cables or leads connected to, and extending from, the (anode and cathode) monopolar electrodes 104 are connected to the bolted rod outside of top section 102a of electrocoagulation reactor housing assembly 102, and are connected to power supply assembly 502 of power supply and process control unit 20.

As shown in FIGS. 2, and 4-6, in electrode set 100 of electrocoagulation reactor unit 16, the top end portion 108 of each (anode or cathode) monopolar electrode 104 is, for example, characterized by a ‘trapezoidal-like’ geometrical shape or form. The bottom end portion 110 of each (anode or cathode) monopolar electrode 104, and the bottom end portion 118 of each bipolar electrode 106, are generally characterized by a ‘rectangular’ geometrical shape or form. In alternative embodiments, the top end portion 108 of each (anode or cathode) monopolar electrode 104, and the top end portion 116 of each bipolar electrode 106, can be generally characterized by a rectangular geometrical shape or form.

For each (anode or cathode) monopolar electrode 104 and bipolar electrode 106, each face and each side extending therefrom, for example, has a flat and smooth surface. The geometrical dimensions of a (anode or cathode) monopolar electrode 104 or bipolar electrode 106 are defined by the geometrical dimensions of either of the two faces, and of a side extending between the two faces, thereof. More specifically, each (anode or cathode) monopolar electrode 104 and bipolar electrode 106 has a face whose length (L) and width (W) correspond to the length and width of either face, respectively, and has a thickness (T) corresponding to the thickness of a side extending between the two faces. Accordingly, each (anode or cathode) monopolar electrode 104 and bipolar electrode 106 has a face whose surface area [SA] is directly proportional to the product of the length (L) and the width (W) of that face, where the proportionality (that is, 1 or <1) is according to the actual geometrical shape or form (that is, rectangular or trapezoidal-like, respectively) of the top end portion of that face.

As shown in FIG. 2, a (anode or cathode) monopolar electrode 104 has a face (F-m) whose length (L-m) corresponds to the (vertical) distance spanning between the edge of the top end portion 108 and the edge of the bottom end portion 110 of the (anode or cathode) monopolar electrode 104, and whose width (W-m) corresponds to the (horizontal) distance spanning between the edge of one side to the edge of the opposite side of the face (F-m) of the (anode or cathode) monopolar electrode 104; and has a thickness (T-m) corresponding to the (horizontal) distance spanning between one side to the opposite side of the face (F-m) of the (anode or cathode) monopolar electrode 104. Accordingly, each (anode or cathode) monopolar electrode 104 has a face (F-m) whose surface area [SA(F-m)] is directly proportional to the product of the length (L-m) and the width (W-m) of that face, where the proportionality (i.e. 1 or <1) is according to the actual geometrical shape or form (i.e., rectangular or trapezoidal-like, respectively) of the top end portion 108 of that face.

A bipolar electrode 106 has a face (F-b) whose length (L-b) corresponds to the (vertical) distance spanning between the edge of the top end portion 116 and the edge of the bottom end portion 118 of the bipolar electrode 106, and whose width (W-b) corresponds to the (horizontal) distance spanning between the edge of one side to the edge of the opposite side of the face (F-b) of the bipolar electrode 106; and has a thickness (T-b) corresponding to the (horizontal) distance spanning between one side to the opposite side of the face (F-b) of the bipolar electrode 106. Accordingly, each bipolar electrode 106 has a face (F-b) whose surface area [SA(F-b)] equals the product of the length (L-b) and the width (W-b) of that face, according to the rectangular geometrical shape of that face.

Each (anode or cathode) monopolar electrode 104 has geometrical dimensions of length (L), width (W), thickness (T), and surface area [SA], which, in general, are of magnitudes different from, or equal to, the magnitudes of the corresponding geometrical dimensions of any other (anode or cathode) monopolar electrode 104 in electrode set 100 of electrocoagulation reactor unit 16. For example, each (anode or cathode) monopolar electrode 104 has geometrical dimensions which are of the same magnitudes as the magnitudes of the corresponding geometrical dimensions of each of the other (anode or cathode) monopolar electrodes 104 in electrode set 100.

Each bipolar electrode 106 has geometrical dimensions of length (L), width (W), thickness (T), and surface area [SA], which, in general, are of magnitudes different from, or equal to, the magnitudes of the corresponding geometrical dimensions of any other bipolar electrode 106 in electrode set 100 of electrocoagulation reactor unit 16. For example, each bipolar electrode 106 has geometrical dimensions which are of the same magnitudes as the magnitudes of the corresponding geometrical dimensions of each of the other bipolar electrodes 106 in electrode set 100.

In exemplary specific embodiments of electrode set 100 of electrocoagulation reactor unit 16, each (anode) monopolar electrode 104 has a length (L-m) of a magnitude which is equal to the same magnitude of the length (L-m) of each (cathode) monopolar electrode 104, and each (anode) monopolar electrode 104 has a width (W-m) of a magnitude which is equal to the same magnitude of the width (W-m) of each (cathode) monopolar electrode 104. In exemplary specific embodiments of electrode set 100 of electrocoagulation reactor unit 16, each bipolar electrode 106 has a length (L-b) of a magnitude which is equal to the same magnitude of the length (L-b) of each other bipolar electrode 106, and each bipolar electrode 106 has a width (W-b) of a magnitude which is equal to the same magnitude of the width (W-b) of each other bipolar electrode 106. Additionally, each (anode or cathode) monopolar electrode 104 has a length (L-m) of a magnitude which is larger, preferably, by about 10%-20%, than the magnitude of the length (L-b) of each bipolar electrode 106. Accordingly, in such embodiments, each (anode or cathode) monopolar electrode 104 has a face (F-m) whose surface area [SA(F-m)] is of a magnitude which is larger, preferably, by about 10%-20%, than the magnitude of the surface area [SA(F-b)] of a face (F-b) of each bipolar electrode 106.

Regarding the surface area of the electrodes, as previously illustratively described hereinabove, the top end portion 108 of each (anode or cathode) monopolar electrode 104 is electrically connected, for example, via respective positive (+) electrical leads 112 and negative (−) electrical leads 114, to power supply assembly 502 of power supply and process control unit 20, as particularly shown in FIGS. 1, 7-9, and during operation, are each ordinarily unexposed to electrocoagulation reactor unit feed 15 or electrocoagulatively treated contaminated water 19, while the bottom end portion 110 of each (anode or cathode) monopolar electrode 104 is ordinarily exposed to, and surrounded by, electrocoagulation reactor unit feed 15 and electrocoagulatively treated contaminated water 19. During operation of such an exemplary embodiment of electrode set 100 of electrocoagulation reactor unit 16, preferably, the surface area encompassing the middle portion 109 and bottom end portion 110 of each (anode or cathode) monopolar electrode 104 is about the same as the surface area encompassing the middle portion 117 and bottom end portion 118 of each bipolar electrode 106, wherein such surface area, preferably, is more than half of the total surface area [SA(F-m)] or [SA(F-b)] of each respective (anode or cathode) monopolar electrode 104 or bipolar electrode 106, which is exposed to, and surrounded by, electrocoagulation reactor unit feed 15 and electrocoagulatively treated contaminated water 19.

Exemplary specific ranges of magnitudes of the geometrical dimensions of length (L), width (W), thickness (T), and surface area [SA], of the (anode or cathode) monopolar electrodes 104 and bipolar electrodes 106 in electrode set 100 of electrocoagulation reactor unit 16, are as follows.

Each (anode or cathode) monopolar electrode 104 has a face (F-m), (a) whose length (L-m) is of a magnitude, for example, in a range of between about 100 mm (10 cm) and about 2000 mm (200 cm), and (b) whose width (W-m) is of a magnitude, for example, in a range of between about 20 mm (2 cm) and about 1000 mm (100 cm). Each (anode or cathode) monopolar electrode 104 has a thickness (T-m) of a magnitude, for example, in a range of between about 1 mm and about 20 mm. Accordingly, each (anode or cathode) monopolar electrode 104 has a face (F-m) whose surface area [SA(F-m)] is of a magnitude, for example, in a range of between about 20 cm² (0.0020 m²) and about 2000 cm² (0.2000 m²).

Each bipolar electrode 106 has a face (F-b), (a) whose length (L-b) is of a magnitude, for example, in a range of between about 90 mm (9 cm) and about 1800 mm (180 cm), and (b) whose width (W-b) is of a magnitude, for example, in a range of between about 20 mm (2 cm) and about 1000 mm (100 cm). Each bipolar electrode 106 has a thickness (T-b) of a magnitude, for example, in a range of between about 1 mm and about 20 mm. Accordingly, each bipolar electrode 106 has a face (F-b) whose surface area [SA(F-b)] is of a magnitude, for example, in a range of between about 18 cm² (0.0018 m²) and about 1800 cm² (0.1800 m²).

With reference to FIGS. 4-9 (particularly, FIGS. 7, 8, and 9), in general, an electrode [i.e., a (anode or cathode) monopolar electrode 104 or a bipolar electrode 106] and an adjacent, nearest-neighboring, parallel and oppositely facing, electrode [i.e., an oppositely charged (cathode or anode, respectively) monopolar electrode 104, or a bipolar electrode 106] are separated by an inter-electrode separation distance, d (in FIGS. 7, 8, 9, referenced as d), corresponding to the distance extending from the face (F-m) or (F-b) of a first monopolar or bipolar electrode 104 or 106, respectively, to the face (F-m) or (F-b) of a second monopolar or bipolar electrode 104 or 106, respectively.

In general, in electrode set 100 of electrocoagulation reactor unit 16, a given pair (e.g., monopolar∥monopolar, monopolar∥bipolar, bipolar∥monopolar, or bipolar∥bipolar) of a first electrode [i.e., a (anode or cathode) monopolar electrode 104 or a bipolar electrode 106] and an adjacent, nearest-neighboring, parallel and oppositely facing, second electrode [i.e., an oppositely charged (cathode or anode, respectively) monopolar electrode 104, or a bipolar electrode 106] has an inter-electrode separation distance, d, of magnitude which is different from, or the same as, the magnitude of an inter-electrode separation distance, d, of any other given pair (e.g., monopolar∥monopolar, monopolar∥bipolar, bipolar∥monopolar, or bipolar∥bipolar) of a first electrode [i.e., a (anode or cathode) monopolar electrode 104 or a bipolar electrode 106] and an adjacent, nearest-neighboring, parallel and oppositely facing, second electrode [i.e., an oppositely charged (cathode or anode, respectively) monopolar electrode 104, or a bipolar electrode 106]. Preferably, the magnitude of the inter-electrode separation distance, d, is the same for each pair (e.g., monopolar∥monopolar, monopolar∥bipolar, bipolar∥monopolar, or bipolar∥bipolar) of two adjacent, nearest-neighboring, parallel and oppositely facing, electrodes. The magnitude of the inter-electrode separation distance, d, of a given pair of (e.g., monopolar∥monopolar, monopolar∥bipolar, bipolar∥monopolar, or bipolar∥bipolar) adjacent, nearest-neighboring, parallel and oppositely facing, electrodes, is, preferably, in a range of between about 1 mm (0.1 cm) and about 20 mm (2.0 cm), and more preferably, in a range of between about 3 mm (0.3 cm) and about 12 mm (12.0 cm).

An important characteristic or property of the metal (anode or cathode) monopolar electrodes 104 and bipolar electrodes 106 in electrode set 100 of electrocoagulation reactor unit 16, is that the metal(s) comprising at least the entire external surface area of the faces and sides of the metal (anode or cathode) monopolar electrodes 104 and bipolar electrodes 106 be soluble (i.e., dissolvable) to at least some extent in water, such as contaminated water 13. Preferably, the metal (anode or cathode) monopolar electrodes 104 and bipolar electrodes 106 are oxidizable (e.g., via oxygen, chlorine, or some other oxidizing agent, present in electrocoagulation reactor unit feed 15 or/and in electrocoagulatively treated contaminated water 19 during exposure to electrocoagulation reactor unit feed 15 or/and electrocoagulatively treated contaminated water 19 in electrocoagulation reactor unit 16. Accordingly, the metal (anode or cathode) monopolar electrodes 104 and bipolar electrodes 106 are composed of one or more (pure, alloyed, or/and plated) metals which have this characteristic or property. Preferably, for example, the (anode or cathode) monopolar electrodes 104 and bipolar electrodes 106 are composed of elemental metals being iron (Fe), or aluminum (Al), since these metals are soluble and oxidizable in water, and thus, are excellent for electrocoagulatively treating contaminated water.

Electrocoagulation reactor unit 16, in general, and electrode set 100 and electrodes thereof, in particular, operate with electrical power supplied, monitored, and controlled, by power supply and process control unit 20. For example, during operation of electrocoagulation reactor unit 16, a controllable constant direct current (dc) provided to electrode set 100 and electrodes thereof, is supplied, monitored (measured), and controlled, via power supply assembly 502, power supply monitoring (measuring) and controlling mechanism 500, and central programming and electronic input/output control signal processing assembly 504, of power supply and process control unit 20. Electrocoagulation reactor unit 16, in general, and electrode set 100 and electrodes thereof, in particular, are configured for being operatively connected to power supply and process control unit 20, via electrocoagulation reactor unit electronic input/output control signal communications line 104.

Current and voltage supplied by power supply and process control unit 20 to electrode set 100 and electrodes thereof, can each be of a magnitude in a wide range of current and voltage magnitudes, and are functions primarily of the following operating parameters and conditions of electrocoagulation reactor unit 16: (1) electrical conductivity of the various types, kinds, or forms, of water present in electrocoagulation reactor unit 16: (i) electrocoagulation reactor unit feed 15 (i.e., contaminated water 13, and possible (overflow) second portion 19b of electrocoagulatively treated contaminated water 19), and (ii) electrocoagulatively treated contaminated water 19, and electrocoagulation reaction products thereof; (2) the size or geometrical dimensions [lengths (L), widths (W), thicknesses (T), surface areas (SA)] of the (anode and cathode) monopolar electrodes 104 and bipolar electrodes 106 in electrode set 100; and (3) the inter-electrode separation distance, d, between the faces (F-m), (F-b) of adjacent, nearest-neighboring, parallel and oppositely facing, monopolar electrodes 104 and bipolar electrodes 106.

The current [expressed in units of amperes (amp)] supplied by power supply and process control unit 20 to the ‘entire’ electrode set 100 of electrodes thereof, of electrocoagulation reactor unit 16, is, preferably, in a range of between about 10 amp and about 600 amp.

The electrode current density [expressed in units of amperes per square meter (amp/m²)] across the surface area of the face (F-m) of each (anode or cathode) monopolar electrode 104 and across the surface area of the face (F-b) of each bipolar electrode 106, is a function of the current which is supplied to the ‘entire’ electrode set 100, as well as being a function of the above stated operating parameters and conditions of electrocoagulation reactor unit 16.

The voltage [expressed in units of voltage (V)] supplied by power supply and process control unit 20 to electrode set 100 and electrodes thereof, of electrocoagulation reactor unit 16, is also a function of the current which is supplied to the ‘entire’ electrode set 100, and of the above stated operating parameters and conditions of electrocoagulation reactor unit 16.

### Electrocoagulation Reactor Housing Assembly

Electrocoagulation reactor housing assembly 102 of electrocoagulation reactor unit 16 has several functions, and appropriate configurations and components for enabling each function.

First, electrocoagulation reactor housing assembly 102 is configured and functions for housing (i.e., holding or containing) electrode set 100 and the electrodes therein, within whose immediate vicinity various electrocoagulation reactions and associated physicochemical processes take place for electrocoagulatively treating contaminated water 13.

Second, electrocoagulation reactor housing assembly 102 is configured and functions for housing various inlet and outlet assemblies, as follows:

(1) A reactor housing inlet assembly 120, for enabling transfer of electrocoagulation reactor unit feed 15 (i.e., contaminated water 13, and possible (overflow) second portion 19b of electrocoagulatively treated contaminated water 19) from second mixing and holding tank 28 to electrocoagulation reactor unit 16.

(2) A reactor housing first outlet assembly 122, for enabling transfer of first portion 19a of electrocoagulatively treated contaminated water 19 from electrocoagulation reactor unit 16 to a receiving and holding tank 300 of output unit 18.

(3) A reactor housing second outlet assembly 124, for enabling transfer of possible (overflow) second portion 19b of electrocoagulatively treated contaminated water 19 from electrocoagulation reactor unit 16 to second mixing and holding tank 28.

(4) A reactor housing gas/vapor vent outlet assembly 128, for enabling venting of electrocoagulation reaction product gases or/and vapors from electrocoagulation reactor unit 16 to air, or/and to an external gas/vapor receiver vessel, such as a tank or column, configured, for example, for receiving and storing or processing the electrocoagulation reaction product gases or/and vapors.

(5) A reactor housing drain outlet assembly 130, for enabling draining of liquid out from the bottom of electrocoagulation reactor housing assembly 102, particularly, for cleaning of electrocoagulation reactor housing assembly 102. Third, electrocoagulation reactor housing assembly 102 is configured and functions for holding or containing electrocoagulation reactor unit feed 15 which is fed into electrocoagulation reactor unit 16, and for holding or containing electrocoagulatively treated contaminated water 19 (of which first portion 19a and possible (overflow) second portion 19b exit from electrocoagulation reactor unit 16), while the various electrocoagulation reactions and associated physicochemical processes take place for electrocoagulatively treating contaminated water 13.

Fourth, electrocoagulation reactor housing assembly 102 is configured and functions for holding or containing a mixture of varying concentrations of electrocoagulation reaction product gases or/and vapors, for example, hydrogen [H₂], oxygen [O₂], nitrogen [N₂], water [H₂O], among other possible electrocoagulation reaction product gases or/and vapors, which exit from the top of electrocoagulation reactor housing assembly 102.

Fifth, electrocoagulation reactor housing assembly 102 is configured and functions for housing a reactor housing water flow separator assembly 126, which is specially configured and functions for separating electrocoagulatively treated contaminated water 19 from electrocoagulation reactor unit feed 15 flowing into electrocoagulation reactor unit 16. Specifically, reactor housing water flow separator assembly 126 is specially configured and functions for separating electrocoagulatively treated contaminated water 19 upwardly flowing along and within the immediate vicinities of the electrodes in electrode set 100 (i.e., the ‘water flowing and contacting region’, as described hereinabove in the ‘Background’ section, wherein the various electrocoagulation reactions and associated physicochemical processes take place for electrocoagulatively treating contaminated water 13), from electrocoagulation reactor unit feed 15 flowing into electrocoagulation reactor unit 16.

Electrocoagulation reactor housing assembly 102 has two main sections—a reactor housing top section 102a, and a reactor housing bottom section 102b. Electrode set 100 and the electrodes therein occupy space within both reactor housing top section 102a and reactor housing bottom section 102b. Accordingly, electrocoagulation reactor housing assembly 102 is of geometrical shape or form, and dimensions, which are suitable for housing electrode set 100 and the electrodes therein, having the above illustratively described geometrical dimensions and magnitudes thereof.

As particularly shown in FIGS. 4-9, each of the (anode or cathode) monopolar electrodes 104 and bipolar electrodes 106 of electrode set 100 are placed, positioned, spaced apart, and held (rigidly fixed) inside of reactor housing bottom section 102b, in a manner which enables operation of the above illustratively described exemplary embodiment of electrode set 100 of electrocoagulation reactor unit 16. Accordingly, the (anode or cathode) monopolar electrodes 104 and bipolar electrodes 106 of electrode set 100 are placed, positioned, spaced apart, and held (rigidly fixed) inside of reactor housing bottom section 102b, in a manner such that inside reactor housing bottom section 102b of electrocoagulation reactor housing assembly 102, the surface area encompassing the middle portion 109 and bottom end portion 110 of each (anode or cathode) monopolar electrode 104 is about the same as the surface area encompassing the middle portion 117 and bottom end portion 118 of each bipolar electrode 106, wherein such surface area, preferably, is more than half of the total surface area [SA(F-m)] or [SA(F-b)] of each respective (anode or cathode) monopolar electrode 104 or bipolar electrode 106, which is exposed to, and surrounded by, electrocoagulation reactor unit solution 15 and electrocoagulatively treated contaminated water 19.

Electrocoagulation reactor housing assembly 102 (encompassing reactor housing top section 102a and reactor housing bottom section 102b) includes the main components of: (i) a reactor housing inlet assembly 120, (ii) a reactor unit feed distributor assembly 122, (iii) a reactor housing first outlet assembly 124, (iv) a reactor housing second outlet assembly 126, (v) a reactor housing water flow separator assembly 128, (vi) a reactor housing gas/vapor vent outlet assembly 130, and (vii) a reactor housing drain outlet assembly 132.

### Reactor Housing Inlet Assembly

Reactor housing inlet assembly 120 is housed in the lower portion 133 (i.e., underneath or below electrode set 100) of reactor housing bottom section 102b, and is operatively connected to water flow rate measuring mechanism 46 of input unit 14. Reactor housing inlet assembly 120 is configured and functions for receiving electrocoagulation reactor unit feed 15 which is transferred and exits from second mixing and holding tank 28 to electrocoagulation reactor unit 16.

### Reactor Unit Feed Distributor Assembly

Reactor unit feed distributor assembly 122 is also housed in the lower portion 133 (i.e., underneath or below electrode set 100) of reactor housing bottom section 102b, and is operatively connected to reactor housing inlet assembly 120. Reactor unit feed distributor assembly 122 is configured and functions for receiving electrocoagulation reactor unit feed 15 from reactor housing inlet assembly 120, and for uniformly distributing electrocoagulation reactor unit feed 15 to the immediate vicinities of the electrodes in electrode set 100, i.e., to the ‘water flowing and contacting region’ (as described hereinabove in the ‘Background’ section), wherein the various electrocoagulation reactions and associated physicochemical processes take place for electrocoagulatively treating contaminated water 13.

Reactor unit feed distributor assembly 122 includes: (i) an inlet assembly 134 located at the first end of reactor unit feed distributor assembly 122, (ii) a closure assembly 136 located at the second end of reactor unit feed distributor assembly 122, and (iii) a plurality of perforations or holes 138 spaced apart from each other and located along the length of reactor unit feed distributor assembly 122. Electrocoagulation reactor unit feed 15 flows into reactor unit feed distributor assembly 122 via inlet assembly 134, then flows out of reactor unit feed distributor assembly 132 via perforations or holes 138 (as indicated in FIG. 1 by the small wavy arrows vertically emerging from perforations or holes 138 of reactor unit feed distributor assembly 122) and into reactor housing bottom section 102b of electrocoagulation reactor housing assembly 102, and subsequently upwardly flows into the immediate vicinity of the electrodes in electrode set 100, i.e., into the water flowing and contacting region, wherein the various electrocoagulation reactions and associated physicochemical processes take place for electrocoagulatively treating contaminated water 13.

### Reactor Housing First Outlet Assembly

Reactor housing first outlet assembly 124 is housed in reactor housing bottom section 102b, and is operatively connected to an inlet assembly of receiving and holding tank 300 of output unit 18. Reactor housing first outlet assembly 124 is configured and functions for transferring first portion 19a of electrocoagulatively treated contaminated water 19 from electrocoagulation reactor unit 16 to receiving and holding tank 300 of output unit 18.

### Reactor Housing Second Outlet Assembly

Reactor housing second outlet assembly 126 is housed in reactor housing bottom section 102b, and is operatively connected to inlet assembly 88 of foam reduction/removal tank 48 of input unit 14. Reactor housing second outlet assembly 126 is configured and functions for enabling transfer of (overflow) second portion 19b of electrocoagulatively treated contaminated water 19 from electrocoagulation reactor unit 16 to second mixing and holding tank 28, via foam reduction/removal tank 48, of input unit 14.

### Reactor Housing Water Flow Separator Assembly

Reactor housing water flow separator assembly 128 is housed in reactor housing bottom section 102b. Reactor housing water flow separator assembly 128 is configured and functions for separating, in a highly efficient manner, electrocoagulatively treated contaminated water 19 and electrocoagulation reaction products contained therein, from electrocoagulation reactor unit feed 15 which enters into the water flowing and contacting region, via reactor unit feed distributor assembly 122.

More specifically, during operation of electrocoagulation reactor unit 16, electrocoagulation reactor unit feed 15 which is fed from water holding and mixing vessel 28 and into reactor housing bottom section 102b of electrocoagulation reactor unit 16, along with electrocoagulatively treated contaminated water 19 formed therefrom, together flow and circulate within the water flowing and contacting region inside reactor housing bottom section 102b, in a manner such that only the subsequently formed electrocoagulatively treated contaminated water 19 (and not electrocoagulation reactor unit feed 15) flows and spills over reactor housing water flow separator assembly 128 in reactor housing bottom section 102b (indicated in FIG. 1 by the curved tail arrows extending over reactor housing water flow separator assembly 128 and into the upper region of electrocoagulatively treated contaminated water 19).

Reactor housing water flow separator assembly 128 is, preferably, a relatively thin wall-like structure extending across both end sides of reactor housing bottom section 102b. Reactor housing water flow separator assembly 128 has a width or depth (extending into the plane of the page, and not visible in FIG. 1) whose magnitude is, preferably, in a range of between about 1 mm and about 30 mm, more preferably, in a range of between about 5 mm and about 20 mm, and most preferably, in a range of between about 8 mm and about 12 mm, with a most preferred magnitude of about 10 mm.

### Reactor Housing Gas/Vapor Vent Outlet Assembly

Reactor housing gas/vapor vent outlet assembly 130 is housed at the top of reactor housing top section 102a. Reactor housing gas/vapor vent outlet assembly 130 is configured and functions as an exit of the mixture of varying concentrations of electrocoagulation reaction product gases or/and vapors, for example, hydrogen [H₂], oxygen [O₂], nitrogen [N₂], water [H₂O], among other possible electrocoagulation reaction product gases or/and vapors, from the top of reactor housing top section 102a of electrocoagulation reactor housing assembly 102. Such gases or/and vapors are produced by the various electrocoagulation reactions and associated physicochemical processes which take place during electrocoagulatively treating contaminated water 13 inside electrocoagulation reactor housing assembly 102 of electrocoagulation reactor unit 16.

### Reactor Housing Drain Outlet Assembly

Reactor housing drain outlet assembly 132 is housed at the bottom of the lower portion 133 (i.e., underneath or below reactor unit feed distributor assembly 122) of reactor housing bottom section 102b. Reactor housing drain outlet assembly 132 is configured and functions for enabling draining, via a valve, of liquids out from the bottom of reactor housing bottom section 102b of electrocoagulation reactor housing assembly 102.

### Complementary Pairs of Integrally, and Removably and Replaceably, Configured and Oppositely Facing Electrode Positioning, Spacing, and Holding Elements

Electrocoagulation reactor housing assembly 102, particularly reactor housing bottom section 102b therein, also includes the additional main components of: (ix) a lower pair of integrally configured and oppositely facing electrode positioning, spacing, and holding elements 220a and 220b, and (x) a complementary upper pair of removably and replaceably configured and oppositely facing electrode positioning, spacing, and holding elements 230a and 230b, as particularly shown in FIG. 3, and in FIGS. 4-6. The removable and replaceable characteristics of complementary upper pair of removably and replaceably configured and oppositely facing electrode positioning, spacing, and holding elements 230a and 230b, are indicated in FIGS. 3-6 by a pair of bi-directional double-headed dashed arrows extending from either below each electrode positioning, spacing, and holding element 230a or 230b (FIG. 3) or lateral to each electrode positioning, spacing, and holding element 230a (FIGS. 4-6).

FIG. 3 is a schematic diagram illustrating a perspective view of (part of) an exemplary embodiment of the bottom section 102b of the electrocoagulation reactor housing assembly 102, highlighting an exemplary embodiment of the lower pair of integrally configured and oppositely facing electrode positioning, spacing, and holding to elements 220a and 220b, and an exemplary embodiment of the complementary upper pair of removably and replaceably configured and oppositely facing electrode positioning, spacing, and holding elements 230a and 230b, therein, being part of electrocoagulation reactor unit 16 included in electrocoagulative water contaminant removal system 10 illustrated in FIG. 1.

### Lower Pair of Integrally Configured and Oppositely Facing Electrode Positioning, Spacing, and Holding Elements

Each one of the lower pair of integrally configured and oppositely facing electrode positioning, spacing, and holding elements 220a and 220b is integrally (i.e., permanently or immovably) designed, constructed, and configured, as an integral (i.e., permanent or immovable) part of reactor housing bottom section 102b of electrocoagulation reactor housing assembly 102, and functions for positioning, spacing, and holding (anode and cathode) monopolar electrodes 104 and bipolar electrodes 106 of electrode set 100 therein.

In an exemplary embodiment, as particularly shown in FIG. 3, each one of the lower pair of integrally configured and oppositely facing electrode positioning, spacing, and holding elements 220a and 220b is integrally designed, constructed, and configured, as part of a respective lower section 240a and 240b, respectively, of the end side walls of reactor housing bottom section 102b of electrocoagulation reactor housing assembly 102. Various other alternative embodiments of integrally designing, constructing, and configuring, the lower pair of integrally configured and oppositely facing electrode positioning, spacing, and holding elements 220a and 220b as part of reactor housing bottom section 102b of electrocoagulation reactor housing assembly 102, are clearly possible.

Each one of the lower pair of integrally configured and oppositely facing electrode positioning, spacing, and holding elements 220a and 220b includes a number of grooves (i.e., walled channels), for example, grooves 247a and 247b, respectively, as shown in FIG. 3, which are integrally (i.e., permanently or immovably) designed, constructed, and configured within and protrude from, and extend along (i.e., as part of), each respective one of the lower pair of integrally configured and oppositely facing electrode positioning, spacing, and holding elements 220a and 220b, respectively. According to at least the number of electrodes in electrode set 100 which are to be positioned, spaced, and held inside reactor housing bottom section 102b of electrocoagulation reactor housing assembly 102, there is designed, constructed, and configured, a corresponding number of parallel and oppositely positioned and facing ‘paired’ grooves, for example, pared grooves 247a and 247b, for positioning, spacing, and holding the electrodes with electrode faces vertically lined up in parallel from one (e.g., left or right) end side wall to an opposite (e.g., right or left, respectively) end side wall, within reactor housing bottom section 102b of electrocoagulation reactor housing assembly 102.

For example, as shown in FIG. 3, each one of the lower pair of integrally configured and oppositely facing electrode positioning, spacing, and holding elements 220a and 220b, including respective grooves 247a or 247b, is integrally designed, constructed, and configured, as part of a respective lower section 240a and 240b of the end side walls of reactor housing bottom section 102b of electrocoagulation reactor housing assembly 102, and functions for positioning, spacing, and holding (anode and cathode), monopolar electrodes 104 at corresponding monopolar electrode ‘bottom’ end portions 110 (FIGS. 3, 2) thereof, and bipolar electrodes 106 at corresponding bipolar electrode ‘bottom’ end portions 118 (FIGS. 3, 2) thereof, of electrode set 100 therein.

Types, kinds, forms, of materials of construction, and, geometrical shape and size dimensions, of the lower pair of integrally configured and oppositely facing electrode positioning, spacing, and holding elements 220a and 220b, and grooves 247a and 247b, respectively, included therein, can widely vary, and are selected according to a particular design, construction, and intended operation, of the (anode and cathode) monopolar electrodes 104 and bipolar electrodes 106 of electrode set 100, of electrocoagulation reactor housing assembly 102, and of the more encompassing electrocoagulation reactor unit 16.

### Complementary Upper Pair of Removably and Replaceably Configured and Oppositely Facing Electrode Positioning, Spacing, and Holding Elements

Each one of the complementary upper pair of removably and replaceably configured and oppositely facing electrode positioning, spacing, and holding elements 230a and 230b is removably and replaceably (i.e., non-permanently or movably, and replaceably) designed, constructed, and configured, as a removable (i.e., non-permanent or movable) and replaceable part of reactor housing bottom section 102b of electrocoagulation reactor housing assembly 102, and functions for positioning, spacing, and holding (anode and cathode) monopolar electrodes 104 and bipolar electrodes 106 of electrode set 100 therein. As particularly shown in FIG. 3, each one of the complementary upper pair of removably and replaceably configured and oppositely facing electrode positioning, spacing, and holding elements 230a and 230b is removably and replaceably designed, constructed, and configured, as part of reactor housing bottom section 102b, in a manner complementary to each one of the respective (i.e., complementary) lower pair of integrally configured and oppositely facing electrode positioning, spacing, and holding elements 220a and 220b, respectively.

In an exemplary embodiment, as particularly shown in FIG. 3, each one of the complementary upper pair of removably and replaceably configured and oppositely facing electrode positioning, spacing, and holding elements 230a and 230b is removably designed, constructed, and configured, as part of a respective upper section 246a and 246b, respectively, of the end side walls of reactor housing bottom section 102b of electrocoagulation reactor housing assembly 102. Various other alternative embodiments of removably and replaceably designing, constructing, and configuring, the complementary upper pair of removably and replaceably configured and oppositely facing electrode positioning, spacing, and holding elements 230a and 230b as part of reactor housing bottom section 102b of electrocoagulation reactor housing assembly 102, are clearly possible.

Each one of the complementary upper pair of removably and replaceably configured and oppositely facing electrode positioning, spacing, and holding elements 230a and 230b includes a complementary number of grooves (walled channels), for example, grooves 248a and 248b, respectively, as shown in FIG. 3, which are integrally (i.e., permanently or immovably) designed, constructed, and configured within and protrude from, and extend along (i.e., as part of), each respective one of the complementary upper pair of removably configured and oppositely facing electrode positioning, spacing, and holding elements 230a and 230b, respectively. According to at least the number of electrodes in electrode set 100 which are to be positioned, spaced, and held inside reactor housing bottom section 102b of electrocoagulation reactor housing assembly 102, there is designed, constructed, and configured, a corresponding number of parallel and oppositely positioned and facing ‘paired’ grooves, for example, paired grooves 248a and 248b, for positioning, spacing, and holding the electrodes with electrode faces vertically lined up in parallel from one (e.g., left or right) end side wall to an opposite (e.g., right or left, respectively) end side wall, within reactor housing bottom section 102b of electrocoagulation reactor housing assembly 102. As particularly shown in FIG. 3, the grooves 248a and 248b of each one of the complementary upper pair of removably and replaceably configured and oppositely facing electrode positioning, spacing, and holding elements 230a and 230b, respectively, are included therein, in a manner complementary to the grooves 247a and 247b of each one of the respective (i.e., complementary) lower pair of integrally configured and oppositely facing electrode positioning, spacing, and holding elements 220a and 220b, respectively.

For example, as shown in FIG. 3, each one of the complementary upper pair of removably and replaceably configured and oppositely facing electrode positioning, spacing, and holding elements 230a and 230b, including respective grooves 248a or 248b, is removably and replaceably designed, constructed, and configured, as part of a respective upper section 246a and 246b of the end side walls of reactor housing bottom section 102b of electrocoagulation reactor housing assembly 102, and functions for positioning, spacing, and holding (anode and cathode), monopolar electrodes 104 at corresponding monopolar electrode ‘top’ end portions 108 (FIG. 2) thereof, and bipolar electrodes 106 at corresponding bipolar electrode ‘top’ end portions 116 (FIG. 2) thereof, of electrode set 100 therein.

Types, kinds, forms, of materials of construction, and, geometrical shape and size dimensions, of the complementary upper pair of removably and replaceably configured and oppositely facing electrode positioning, spacing, and holding elements 230a and 230b, and grooves 248a and 248b, respectively, included therein, can widely vary, and are selected according to a particular design, construction, and intended operation, of the (anode and cathode) monopolar electrodes 104 and bipolar electrodes 106 of electrode set 100, of electrocoagulation reactor housing assembly 102, and of the more encompassing electrocoagulation reactor unit 16.

Exemplary specific embodiments of the complementary upper pair of removably and replaceably configured and oppositely facing electrode positioning, spacing, and holding elements 230a and 230b (including respective grooves 248a or 248b), which is removably and replaceably designed, constructed, and configured, as part of a respective upper section 246a and 246b of the end side walls of reactor housing bottom section 102b of electrocoagulation reactor housing assembly 102, and which functions for positioning, spacing, and holding (anode and cathode), monopolar electrodes 104 at corresponding monopolar electrode ‘top’ end portions 108 (FIG. 2) thereof, and bipolar electrodes 106 at corresponding bipolar electrode ‘top’ end portions 116 (FIG. 2) thereof, of electrode set 100 therein, are illustrated in FIGS. 4-6.

FIG. 4 is a schematic diagram illustrating a perspective view of (part of) an exemplary embodiment of a series parallel (spatial-electrical) configuration of (anode and cathode) monopolar electrodes 104 and bipolar electrodes 106 of a series parallel (spatially-electrically) configured electrode set 100, including upper pair of removably and replaceably configured and oppositely facing electrode positioning, spacing, and holding elements 230a and 230b (including respective grooves 248a or 248b), inside (the bottom section 102b of) electrocoagulation reactor housing assembly 102 illustrated in FIG. 3, being part of electrocoagulation reactor unit 16 included in electrocoagulative water contaminant removal system 10 illustrated in FIG. 1.

FIG. 5 is a schematic diagram illustrating a perspective view of (part of) an exemplary embodiment of a series (spatial-electrical) configuration of (anode and cathode) monopolar electrodes 104 and bipolar electrodes 106 of a series (spatially-electrically) configured electrode set 100, including upper pair of removably and replaceably configured and oppositely facing electrode positioning, spacing, and holding elements 230a and 230b (including respective grooves 248a or 248b), inside (the bottom section 102b of) electrocoagulation reactor housing assembly 102 illustrated in FIG. 3, being part of electrocoagulation reactor unit 16 included in electrocoagulative water contaminant removal system 10 illustrated in FIG. 1.

FIG. 6 is a schematic diagram illustrating a perspective view of (part of) an exemplary embodiment of a parallel (spatial-electrical) configuration of (anode and cathode) monopolar electrodes 104 (without bipolar electrodes) of a parallel (spatially-electrically) configured electrode set 100, including upper pair of removably and replaceably configured and oppositely facing electrode positioning, spacing, and holding elements 230a and 230b (including respective grooves 248a or 248b), inside (the bottom section 102b of) electrocoagulation reactor housing assembly 102 illustrated in FIG. 3, being part of electrocoagulation reactor unit 16 included in electrocoagulative water contaminant removal system 10 illustrated in FIG. 1.

For performing practical and economical maintenance (i.e., cleaning, removing, replacing, etc.) of ‘individual’ electrodes of electrode set 100 inside electrocoagulation reactor housing assembly 102, either one or both of the complementary upper pair of removably and replaceably configured and oppositely facing electrode positioning, spacing, and holding elements 230a and 230b (including respective grooves 248a or 248b), is/are readily removable from, and is/are readily replaceable in, each respective upper section 246a and 246b of the end side walls of reactor housing bottom section 102b of electrocoagulation reactor housing assembly 102.

As stated hereinabove in the ‘Background’ section, a significant problem or limitation associated with current teachings of electrocoagulatively removing contaminants from contaminated water, relates to impractical or/and process interfering configurations of positioning, spacing, and holding electrodes inside an electrocoagulation reactor housing assembly included in a more encompassing electrocoagulation reactor unit. Inside electrocoagulative water removal systems there are currently two well known main types of configurations, i.e., a groove type configuration, and a spacer type configuration, which are designed, constructed, and used for positioning, spacing, and holding electrodes inside the electrocoagulation reactor housing assembly of the electrocoagulation reactor unit.

For a ‘groove type configuration’, a well known significant problem or limitation is based on the phenomenon that during routine operation of the electrocoagulation reactor unit, a portion of the various different types, kinds, and forms, of solid (particulate), solid-like (particulate-like), or even emulsive, matter of the contaminated water, or/and of the various different types, kinds, and forms, of solid and solid-like electrocoagulation reaction products [i.e., coagulates, flocculates (flocs or flakes), precipitates, aggregates (aggregations), agglomerates (agglomerations), or/and clumps)] of the electrocoagulatively treated contaminated water, which flow and circulate, and contact the electrodes, throughout the inside of the electrocoagulation reactor housing assembly, and which are involved in the various electrocoagulation processes taking place therein, gets stuck or/and adheres, accumulates, and remains lodged along the groove walls which are (permanently or immovably) configured within or protruding from, and extending along, the inner walls of the electrocoagulation reactor housing assembly.

Such phenomenon and consequent problem or limitation, make it exceptionally difficult, impractical, or/and economically unfeasible, to maintain (i.e., clean, remove, replace, etc.) ‘individual’ electrodes of the electrode set inside the electrocoagulation reactor housing assembly. Such phenomenon, also, undesirably perturbs and interferes with the flow field and related fluid flow properties, characteristics, and behavior of the contaminated water which will be, is, or/and has been, electrocoagulatively treated inside the electrocoagulation reactor housing assembly of the electrocoagulation reactor unit. This additional interfering type of phenomenon translates into lower efficiency and less than optimal behavior and performance of the electrocoagulation reactor unit for electrocoagulatively removing contaminants from the contaminated water.

For a ‘spacer type configuration’, a well known significant problem or limitation is the need to lift the entire electrode-spacer supporting element up and out of the electrocoagulation reactor housing assembly in order to remove even one electrode from the entire electrode set inside the electrocoagulation reactor housing assembly. As for the ‘groove type configuration’, such a problem or limitation makes it exceptionally difficult, impractical, or/and economically unfeasible, to maintain (i.e., clean, remove, replace, etc.) ‘individual’ electrodes of the electrode set inside the electrocoagulation reactor housing assembly.

Additionally, it is common to have a case of a particular design, construction, and intended operation, of the electrodes, and of the electrocoagulation reactor housing assembly, wherein either part, or the entirety, of the non-conducting electrode-spacer supporting element is positioned in the region wherein the water flows and circulates, and contacts the electrodes, wherein take place the various electrocoagulation reactions and associated physicochemical processes, inside the electrocoagulation reactor housing assembly. In such a case, the non-conducting electrode-spacer supporting element may undesirably perturb and interfere with the flow field and related fluid flow properties, characteristics, and behavior of the contaminated water which will be, is, or/and has been, electrocoagulatively treated inside the electrocoagulation reactor housing assembly of the electrocoagulation reactor unit. As for the ‘groove type configuration’, this additional interfering type of phenomenon translates into lower efficiency and less than optimal behavior and performance of the electrocoagulation reactor unit for electrocoagulatively removing contaminants from the contaminated water.

The hereinabove illustratively described embodiments of the present invention, where, in electrocoagulative water contaminant removal system 10, and in electrocoagulation reactor unit 16, electrocoagulation reactor housing assembly 102 has therein: (i) a lower pair of integrally configured and oppositely facing electrode positioning, spacing, and holding elements 220a and 220b (including respective grooves 247a or 247b) integrally configured and oppositely facing each other along lower sections of two oppositely facing walls of electrocoagulation reactor housing assembly 102, and (ii) a complementary upper pair of removably and replaceably configured and oppositely facing electrode positioning, spacing, and holding elements 230a and 230b (including respective grooves 248a or 248b) removably and replaceably configured and oppositely facing each other along upper sections of the two oppositely facing walls of electrocoagulation reactor housing assembly 102, appropriately address and overcome the above described significant problem or limitation relating to impractical or/and process interfering configurations of positioning, spacing, and holding electrodes inside an electrocoagulation reactor housing assembly included in a more encompassing electrocoagulation reactor unit.

Electrode-Electrode (Inter-Electrode) ‘Electrocoagulatively Reactive’ Sub-Region, and End Wall-Electrode or Electrode-End Wall ‘Electrocoagulatively Unreactive’ Sub-Region, and Zones therein

In current teachings of electrocoagulative water removal systems, wherein an electrocoagulation reactor housing assembly is configured and functions for containing a plurality of plate, slab, or sheet, type shaped electrodes therein, which are configured and positioned vertically [i.e., with electrode faces vertically lined up in parallel from one (e.g., left or right) end side wall to an opposite (e.g., right or left, respectively) end side wall], or horizontally [i.e., with electrode faces horizontally stacked in parallel from the top end wall to the bottom end wall], contaminated water flows and circulates, and contacts the electrodes, throughout the ‘water flowing and contacting region’ wherein take place the various electrocoagulation reactions and associated physicochemical processes, inside the electrocoagulation reactor housing assembly. The ‘total’ water flowing and contacting region can be considered to generally include two types of sub-regions: a first, major, electrode-electrode (inter-electrode) ‘electrocoagulatively reactive’ sub-region within which there takes place essentially all of the electrocoagulation of the contaminated water, and a second, minor, end wall-electrode or electrode-end wall ‘electrocoagulatively unreactive’ sub-region within which there takes place essentially none of the electrocoagulation of the contaminated water.

The First, Major, Electrode-Electrode (Inter-Electrode) ‘Electrocoagulatively Reactive’ Sub-Region, and Zones therein

In electrocoagulative water removal system 10 of the present invention, in electrocoagulation reactor unit 16, the first, major, electrode-electrode (inter-electrode) ‘electrocoagulatively reactive’ sub-region is defined by, and encompasses, the sum of all the individual water flowing and contacting electrode-electrode (inter-electrode) ‘zones’ located inside electrocoagulation reactor housing assembly 102 (particularly, reactor housing bottom section 102b thereof), whose volume takes up ‘all’ of the total water flowing and contacting volume therein. In the first, major, sub-region, each water flowing and contacting electrode-electrode (inter-electrode) zone is made up of, and occupies, the volumetric space spanning in between a pair of two adjacent, nearest-neighboring, parallel and oppositely facing, and oppositely charged, faces (surfaces) of a respective pair of two adjacent, nearest-neighboring, parallel and oppositely facing, (monopolar-monopolar, monopolar-bipolar, or bipolar-bipolar) electrodes of electrode set 100. Accordingly, since each individual water flowing and contacting electrode-electrode (inter-electrode) zone contains a pair of two adjacent, nearest-neighboring, parallel and oppositely facing, and oppositely charged, electrode faces (surfaces), therefore, during operation of electrocoagulation reactor unit 16, each such individual water flowing and contacting electrode-electrode (inter-electrode) zone located inside reactor housing bottom section 102b of electrocoagulation reactor housing assembly 102 is ‘electrocoagulatively reactive’ for electrocoagulatively removing contaminants from contaminated water 13.

In electrocoagulative water removal system 10 of the present invention, in electrocoagulation reactor unit 16, and housed inside electrocoagulation reactor housing assembly 102, for example, as shown in each of FIGS. 4-9, each electrode spatial-electrical configuration has an electrode set 100 of a total of seventeen (17) separate plate, slab, or sheet, type shaped (anode and cathode) monopolar electrodes 104 and bipolar electrodes 106, appropriately positioned and spaced apart from each other. A total of sixteen (16) [i.e., 17−1] individual ‘electrocoagulatively reactive’ water flowing and contacting electrode-electrode (inter-electrode) zones are located inside reactor housing bottom section 102b of electrocoagulation reactor housing assembly 102, whose volume takes up ‘all’ of the total water flowing and contacting volume therein. Three examples of such electrode-electrode (inter-electrode) zones are referenced in each of FIGS. 4 and 7 as 250a, 250b, and 250c; in FIGS. 5 and 8 as 252a, 252b, and 252c; and in FIGS. 6 and 9 as 254a, 254b, and 254c. The combination (mixture) of contaminated water 13 and electrocoagulatively treated contaminated water 19 which flows and circulates, and contacts the electrodes of electrode set 100, throughout the ‘water flowing and contacting region’, is indicated in FIGS. 7-9 by the plurality of short ‘wavy’ or ‘curved’ lines (drawn overlaying the middle portions of the electrodes) located inside reactor housing bottom section 102b of electrocoagulation reactor housing assembly 102.

The Second, Minor, End Wall-Electrode or Electrode-End Wall ‘Electrocoagulatively Unreactive’ Sub-Region, and Zones therein

Additionally, in current teachings of electrocoagulative water removal systems, the second, minor, end wall-electrode or electrode-end wall ‘electrocoagulatively unreactive’ sub-region is defined by, and encompasses, the sum of (ordinarily) two individual water flowing and contacting end wall-electrode or electrode-end wall ‘zones’ located inside the electrocoagulation reactor housing assembly, whose volume takes up a relatively small portion (i.e., the minor portion) of the total water flowing and contacting volume inside the reactor housing assembly of the electrocoagulation reactor unit. In the second, minor, sub-region, each water flowing and contacting end wall-electrode or electrode-end wall zone is made up of, and occupies, the volumetric space spanning in between the (non-conductive, non-charged) interior face (surface) of one (e.g., left, right, top, or bottom) end side wall, and an adjacent, nearest-neighboring, parallel and oppositely facing, and (positively or negatively) charged, face (surface) of an adjacent, nearest-neighboring, parallel and oppositely facing, and (positively or negatively) charged, (monopolar) electrode. Accordingly, since each individual water flowing and contacting end wall-electrode or electrode-end wall zone contains the (non-conductive, non-charged) interior face (surface) of one (e.g., left, right, top, or bottom) end side wall, and only one adjacent, nearest-neighboring, parallel and oppositely facing, and (positively or negatively) charged, electrode face (surface), there is essentially no electrical or electrolytic activity (i.e., no conduction or charge flow [current] existing between electrode faces, since there is only one electrode face in the end wall-electrode or electrode-end wall zone). Therefore, during operation of the electrocoagulation reactor unit, each such individual water flowing and contacting end wall-electrode or electrode-end wall zone located inside the electrocoagulation reactor housing assembly is ‘electrocoagulatively unreactive’ and does not participate in, or contribute to, electrocoagulatively removing contaminants from the contaminated water.

During operation of such electrocoagulation reactor units, contaminated water flows and circulates, and contacts electrodes, throughout the total water flowing and contacting region, and preceding described two types of sub-regions thereof. Contaminated water flows and circulates, and contacts (intermediately positioned, non-end side wall) electrodes, throughout the electrocoagulatively reactive zones of the first, major, electrode-electrode (inter-electrode) ‘electrocoagulatively reactive’ sub-region within which there takes place essentially all of the electrocoagulation of the contaminated water, within the volume that takes up the relatively large (major) portion of the total water flowing and contacting volume inside the reactor housing assembly of the electrocoagulation reactor unit. At the same time, contaminated water also flows and circulates, and contacts (end side wall) electrodes, throughout the two electrocoagulatively unreactive zones of the second, minor, end wall-electrode or electrode-end wall ‘electrocoagulatively unreactive’ sub-region within which there takes place essentially none of the electrocoagulation of the contaminated water, and whose volume takes up the relatively small (minor) portion of the total water flowing and contacting volume inside the reactor housing assembly of the electrocoagulation reactor unit. Alternatively stated, at the same time, the contaminated water which also flows and circulates, and contacts (end side wall) electrodes, throughout the two electrocoagulatively unreactive zones of the second, minor, end wall-electrode or electrode-end wall ‘electrocoagulatively unreactive’ sub-region, is not subjected to electrocoagulation processes, and therefore, is not electrocoagulatively treated. From the above description, it is clearly understood that during operation of such electrocoagulation reactor units, essentially all of the electrocoagulation of the contaminated water is effected within the first, major, electrode-electrode (inter-electrode) ‘electrocoagulatively reactive’ sub-region (and zones thereof) inside the electrocoagulation reactor housing assembly, while, by strong contrast, at the same time, essentially none of the electrocoagulation of the contaminated water is effected within the second, minor, end wall-electrode or electrode-end wall ‘electrocoagulatively unreactive’ sub-region (and zones thereof) inside the electrocoagulation reactor housing assembly.

For the purpose of studying, and analyzing, the preceding described phenomena, the applicant/assignee of the present invention performed extensive experimentation, and analyzed extensive amounts of experimental data and information, of electrocoagulatively removing contaminants from contaminated water using the above described known types or kinds of electrocoagulative water removal systems and electrocoagulation reactor units. The applicant/assignee observed and concluded that the existence of the second, minor, end wall-electrode or electrode-end wall ‘electrocoagulatively unreactive’ sub-region (and zones thereof) inside the electrocoagulation reactor housing assembly of the electrocoagulation reactor unit, in addition to not participating in, or contributing to, the overall electrocoagulation of the contaminated water, also, undesirably interferes with the flow field and related fluid flow properties, characteristics, and behavior of the contaminated water which will be, is, or/and has been, electrocoagulatively treated within neighboring ‘electrocoagulatively reactive’ zones of the first, major, electrode-electrode (inter-electrode) ‘electrocoagulatively reactive’ sub-region inside the electrocoagulation reactor housing assembly of the electrocoagulation reactor unit. The applicant/assignee observed and concluded that this additional interfering type of phenomenon translates into lower efficiency and less than optimal behavior and performance of the total water flowing and contacting region inside the electrocoagulation reactor housing assembly of the electrocoagulation reactor unit, for electrocoagulatively removing contaminants from the contaminated water.

The preceding described existence, and characteristics, of the second, minor, end wall-electrode or electrode-end wall ‘electrocoagulatively unreactive’ sub-region (and the two zones thereof), inside an electrocoagulation reactor housing assembly of an electrocoagulation reactor unit, is the basis of the hereinabove stated significant problem or limitation relating to existence of electrocoagulatively unreactive zones within the electrocoagulation reactor housing assembly (containing electrodes), associated with current teachings of electrocoagulatively removing contaminants from contaminated water.

In view of such a significant problem or limitation, the applicant/assignee of the present invention performed additional extensive experimentation, and analysis of extensive amounts of experimental data and information, of electrocoagulatively removing contaminants from contaminated water using the above described types or kinds of electrocoagulative water removal systems and electrocoagulation reactor units. The applicant/assignee of the present invention conceived of, and reduced to practice, the following new and inventive embodiments of configuring electrodes inside an electrocoagulation reactor housing assembly of an electrocoagulation reactor unit, particularly with respect to the second, minor, end wall-electrode or electrode-end wall ‘electrocoagulatively unreactive’ sub-region (and zones thereof) inside the electrocoagulation reactor housing assembly.

### Two Zones of the End Wall-Electrode or Electrode-End Wall ‘Electrocoagulatively Unreactive’ Sub-Region

In electrocoagulative water removal system 10 of the present invention, in to electrocoagulation reactor unit 16, the second, minor, end wall-electrode or electrode-end wall electrocoagulatively unreactive sub-region, is defined by, and encompasses, the sum of two individual water ‘non-flowing’ and ‘non-contacting’ end wall-electrode or electrode-end wall zones located inside electrocoagulation reactor housing assembly 102 (particularly, reactor housing bottom section 102b thereof), whose volume takes up ‘none’ (i.e., no portion) of the total water flowing and contacting volume inside electrocoagulation reactor housing assembly 102 of electrocoagulation reactor unit 16.

In accordance with the preceding definition of the second, minor, end wall-electrode or electrode-end wall electrocoagulatively unreactive sub-region, therefore, in electrocoagulative water removal system 10 of the present invention, in electrocoagulation reactor unit 16, the electrocoagulation reactor housing assembly 102 (particularly, reactor housing bottom section 102b thereof) has therein an end wall-electrode or electrode-end wall electrocoagulatively unreactive sub-region, wherein each of two individual water ‘non-flowing’ and ‘non-contacting’ zones in the unreactive sub-region includes a (non-conductive, non-charged) interior face (surface) of one (left or right) end side wall configured flush against and directly contacting adjacent, nearest-neighboring, parallel and oppositely facing, and (positively or negatively) charged, face (surface) of an adjacent, nearest-neighboring, parallel and oppositely facing, and (positively or negatively) charged, (monopolar) electrode 104, thereby preventing contaminated water 13 and electrocoagulatively treated contaminated water 19 from flowing and making contact therebetween, that is, within the end wall-electrode or electrode-end wall electrocoagulatively unreactive sub-region.

In electrocoagulative water removal system 10 of the present invention, in electrocoagulation reactor unit 16, for example, as shown in each of FIGS. 4-9, in each electrode spatial-electrical configuration, there are two individual ‘electrocoagulatively unreactive’ water non-flowing and non-contacting end wall-electrode or electrode-end wall zones [referenced in FIGS. 4 and 7 as 260a and 260b; in FIGS. 5 and 8 as 262a and 262b; and in FIGS. 6 and 9 as 264a and 264b] located inside reactor housing bottom section 102b of electrocoagulation reactor housing assembly 102. These two zones take up no volume (i.e., no portion) of the total water flowing and contacting volume therein.

Another exemplary view of an exemplary embodiment of one zone of the two individual ‘electrocoagulatively unreactive’ water non-flowing and non-contacting end wall-electrode or electrode-end wall zones located inside reactor housing bottom section 102b of electrocoagulation reactor housing assembly 102, is provided in FIG. 3. FIG. 3 is a schematic diagram illustrating a perspective view of (part of) an exemplary embodiment of bottom section 102b of electrocoagulation reactor housing assembly 102, [highlighting (i) an exemplary embodiment of lower pair of integrally configured and oppositely facing electrode positioning, spacing, and holding elements 220a and 220b, and an exemplary embodiment of complementary upper pair of removably and replaceably configured and oppositely facing electrode positioning, spacing, and holding elements 230a and 230b, therein, and (ii) an exemplary embodiment of one zone 272 of the two water ‘non-flowing’ and ‘non-contacting’ zones of the end wall-electrode or electrode-end wall ‘electrocoagulatively unreactive’ sub-region therein], being part of electrocoagulation reactor unit 16 included in electrocoagulative water contaminant removal system 10 illustrated in FIG. 1.

As shown in FIG. 3, in reactor housing bottom section 102b, the one zone 272 of the two water ‘non-flowing’ and ‘non-contacting’ zones of the end wall-electrode or electrode-end wall ‘electrocoagulatively unreactive’ sub-region therein, includes a (non-conductive, non-charged) interior face (surface) of one (left or right) end side wall 270 configured flush against and directly contacting adjacent, nearest-neighboring, parallel and oppositely facing, and (positively or negatively) charged, face (surface) of an adjacent, nearest-neighboring, parallel and oppositely facing, and (positively or negatively) charged, (monopolar) electrode 104 (particularly showing bottom end portion 110 thereof), for preventing contaminated water 13 and electrocoagulatively treated contaminated water 19 from flowing and making contact therebetween.

Accordingly, in electrocoagulation reactor unit 16, by way of electrocoagulation reactor housing assembly 102 (particularly, reactor housing bottom section 102b thereof) having therein the above illustratively described end wall-electrode or electrode-end wall electrocoagulatively unreactive sub-region, including two individual ‘electrocoagulatively unreactive’ water non-flowing and non-contacting end wall-electrode or electrode-end wall zones [for example, as shown in FIGS. 4 and 7 as 260a and 260b; in FIGS. 5 and 8 as 262a and 262b; and in FIGS. 6 and 9 as 264a and 264b], for preventing contaminated water 13 and electrocoagulatively treated contaminated water 19 from flowing and making contact therebetween, there is precluding or preventing the occurrence of the above described undesirable interference with the flow field and related fluid flow properties, characteristics, and behavior of the contaminated water which will be, is, or/and has been, electrocoagulatively treated within neighboring ‘electrocoagulatively reactive’ zones of the first, major, electrode-electrode (inter-electrode) ‘electrocoagulatively reactive’ sub-region inside electrocoagulation reactor housing assembly 102 of electrocoagulation reactor unit 16.

The applicant/assignee observed and concluded that the above illustratively described embodiments of configuring electrodes inside an electrocoagulation reactor housing assembly of an electrocoagulation reactor unit, particularly with respect to the second, minor, end wall-electrode or electrode-end wall ‘electrocoagulatively unreactive’ sub-region (and zones thereof) therein, translates into higher efficiency and improved optimal behavior and performance of the total water flowing and contacting region inside the electrocoagulation reactor housing assembly of the electrocoagulation reactor unit, for electrocoagulatively removing contaminants from the contaminated water. These embodiments, and aspects thereof, of the present invention, therefore, appropriately address and overcome the above described significant problem or limitation relating to existence of electrocoagulatively unreactive zones inside an electrocoagulation reactor housing assembly (containing electrodes).

Materials of Construction of Electrocoagulation Reactor Housing Assembly and Components thereof.

Electrocoagulation reactor housing assembly 102 (encompassing reactor housing top section 102a and reactor housing bottom section 102b, and all components thereof) of electrocoagulation reactor unit 16, is made, preferably, ‘entirely’ of non-conductive materials, such as plastics, for example, polyethylene, polypropylene, Teflon®, or/and similar types of plastics. Accordingly, electrocoagulation reactor housing assembly 102 components, including hereinabove illustratively described main components (i)-(vii), being: (i) reactor housing inlet assembly 120, (ii) reactor unit feed distributor assembly 122, (iii) reactor housing first outlet assembly 124, (iv) reactor housing second outlet assembly 126, (v) reactor housing water flow separator assembly 128, (vi) reactor housing gas/vapor vent outlet assembly 130, and (vii) reactor housing drain outlet assembly 132, and, additional main components (ix) and (x), being: (ix) lower pair of integrally configured and oppositely facing electrode positioning, spacing, and holding elements 220a and 220b, and (x) complementary upper pair of removably and replaceably configured and oppositely facing electrode positioning, spacing, and holding elements 230a and 230b, are each made, preferably, ‘entirely’ of non-conductive materials, such as plastics, for example, polyethylene, polypropylene, Teflon®, or/and similar types of plastics.

Additional Structure, Function, and Operation of the Electrocoagulation Reactor Unit, and Components thereof.

Additional details regarding structure, function, and operation, of electrocoagulation reactor unit 16, and components thereof, of electrocoagulative water contaminant removal system 10 shown in FIG. 1, which are relevant to implementing the herein illustratively described exemplary embodiments of the system for electrocoagulatively removing contaminants from contaminated water 13, for producing cleaned water 23 and sludge 21, of the present invention, are provided in the following.

Electrocoagulation reactor unit 16 and components thereof include any additional necessary fluid transfer equipment (the main ones of which are illustratively described hereinabove), such as pipes, tubes, connecting elements, adaptors, fittings, screws, nuts, bolts, washers, o-rings, water pumps, valves, vents, and switches, as well as mechanisms, assemblies, components, and elements thereof, which are made of suitable materials, for fully enabling electrocoagulation reactor unit 16 and components thereof to electrocoagulatively treat contaminated water 13, for forming electrocoagulatively treated contaminated water 19 exiting electrocoagulation reactor unit 16.

Automatic electronic monitoring (measuring) and controlling of operating parameters and conditions of electrocoagulation reactor unit 16 and components thereof, are enabled by power supply and process control unit 18 and components thereof. Electronic input/output, feedforward and feedback transmission and reception of electronic control data, information, and command, communication signals between electrocoagulation reactor unit 16 and components thereof, and, power supply and process control unit 20 and components thereof, are provided by an electronic input/output control data, information, and command, communications line, such as a cable or bundle of wires, or/and a wireless communications line, herein, generally indicated in FIG. 1 as electrocoagulation reactor unit electronic input/output control signal communications line 104.

Electrocoagulation reactor unit 16 and components thereof include any additional necessary mechanical, hydraulic, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of electrocoagulation reactor unit 16 and components thereof, by power supply and process control unit 20 and components thereof.

Electrocoagulation reactor unit 16 and components thereof are preferably of configurations and constructions which are compatible with, and operated in accordance with, the physicochemical properties, parameters, and characteristics, of the variety of different types, kinds, or forms, of contaminants, in forms of an aqueous solution, colloid, suspension, or/and emulsion, in electrocoagulation reactor unit feed 15 flowing into electrocoagulation reactor unit 16, and, of electrocoagulatively treated contaminated water 19 and electrocoagulation reaction product gases or/and vapors thereof, exiting electrocoagulation reactor unit 16, as well as with the physicochemical properties, parameters, characteristics, and operating conditions, of the other units, in particular, input unit 14, output unit 18, and, power supply and process control unit 20, of electrocoagulative water contaminant removal system 10, which together are configured and synchronously operated for electrocoagulatively removing contaminants from contaminated water 13, for producing cleaned water 23 and sludge 21.

Output Unit, and Separating Solid and Solid-Like Electrocoagulation Reaction Products Out from the Electrocoagulatively Treated Contaminated Water

In the electrocoagulative water removal system of the present invention, the to output unit is operatively connected to the electrocoagulation reactor input unit, and is configured and functions for receiving and transporting the electrocoagulatively treated contaminated water, and for separating solid and solid-like electrocoagulation reaction products out from the electrocoagulatively treated contaminated water, for forming sludge and cleaned water. Accordingly, with reference to FIG. 1, in electrocoagulative water removal system 10, output unit 18 is operatively connected to electrocoagulation reactor unit 16, and is configured and functions for receiving and transporting electrocoagulatively treated contaminated water 19 (particularly, first portion 19a thereof), and for separating solid and solid-like electrocoagulation reaction products out from electrocoagulatively treated contaminated water 19 (particularly, first portion 19a thereof), for forming sludge 21 and cleaned water 23.

In electrocoagulative water removal system 10, output unit 18 includes downstream, post-electrocoagulation reactor unit equipment and procedures for receiving and forwarding electrocoagulatively treated contaminated water 19 (particularly, first portion 19a thereof) which exits electrocoagulation reactor unit 16 to at least one type of ‘secondary’ or ‘tertiary’ solid-liquid separation process based on ‘gravity-type’-sedimentation, settling, or [water] clarification.

Via operation of such ‘gravity-type’ sedimentation, settling, or [water] clarification, equipment and procedures, a portion or fraction of the various different types, kinds, and forms, of solid and solid-like electrocoagulation reaction products [i.e., coagulates, flocculates (flocs or flakes), precipitates, aggregates (aggregations), agglomerates (agglomerations), or/and clumps)], produced and contained within electrocoagulatively treated contaminated water 19 (particularly, first portion 19a thereof), is separated (i.e., sedimented, settled, or clarified) out from electrocoagulatively treated contaminated water 19 (particularly, first portion 19a thereof), for forming various possible different electrocoagulative water removal system output ‘preliminary’ separation (purification) products. Such ‘preliminary’ separation (purification) products contain, singly or in combination, different degrees, types, and forms (e.g., mixtures, suspensions, solutions), of (i) solid and solid-like (waste) matter (i.e., sediments, settled solids and semi-solids) mixed with, suspended in, or/and dissolved in, a relatively small amount of water, commonly known as ‘sludge’, (ii) partially cleaned, purified, or clarified, electrocoagulatively treated contaminated water with relatively small amounts of solid and solid-like (waste) matter (i.e., sediments, settled solids and semi-solids), and (iii) fully cleaned, purified, or clarified, water.

The various possible different electrocoagulative water removal system output ‘preliminary’ separation (purification) products, singly or in combination, are then subjected to any number of various further downstream collection, or/and additional ‘secondary’ or ‘tertiary’ (solid-liquid or/and solid-solid) separation, and water treatment or purification, processes, for ultimately forming various possible different electrocoagulative water removal system output ‘final’ separation (purification) products. Such ‘final’ separation (purification) products contain, singly, different degrees, types, and forms of (i) sludge, being the solid and solid-like (waste) matter (i.e., sediments, settled solids and semi-solids) mixed with, suspended in, or/and dissolved in, a relatively small amount of water, and (ii) fully cleaned, purified, or clarified, water.

For performing the preceding functions, in electrocoagulative water contaminant removal system 10, output unit 18 is configured for being operatively connected to electrocoagulation reactor unit 16, and, power supply and process control unit 20. Output unit 18 functions for receiving and transporting electrocoagulatively treated contaminated water 19 (particularly, first portion 19a thereof), and for separating solid and solid-like electrocoagulation reaction products out from electrocoagulatively treated contaminated water 19 (particularly, first portion 19a thereof), via synchronized operation with electrocoagulation reactor unit 16, and, power supply and process control unit 20, for forming for forming sludge 21 and cleaned water 23.

Output unit 18 includes the main components of: (i) a receiving and holding tank 300, (ii) a first or primary sedimentation, settling, or [water] clarification column (Primary Sedimentation Column (SC1)) 302, (iii) a second or secondary sedimentation, settling, or [water] clarification column (Secondary Sedimentation Column (SC2)) 304, (iv) a sludge collection tank 306, (v) a cleaned water tank 308, (vi) a filter press 310, (vii) water pumps 312, 314, (viii) valves 316, 318, 320, (ix) an automatic water (volumetric or mass) level monitoring (measuring) and controlling mechanism 322, and (x) a water flow rate measuring mechanism 324. Each main component of output unit 18 is configured for being operatively connected to power supply and process control unit 20, via output unit electronic input/output control signal communications line 326.

Although not formally included as a designated component of output unit 18, or as a designated component of input unit 14, of electrocoagulative water contaminant removal system 10, included therein is a recycle line 330 having the first end operatively connected to valve 320 of output unit 18, and the second end operatively connected to inlet assembly 58 of first mixing and holding tank 22 of input unit 14. Recycle line 330 is configured and functions as a fluid communication ‘linking’ or connecting component for linking or connecting, and thereby providing, fluid communication between output unit 18 and input unit 14.

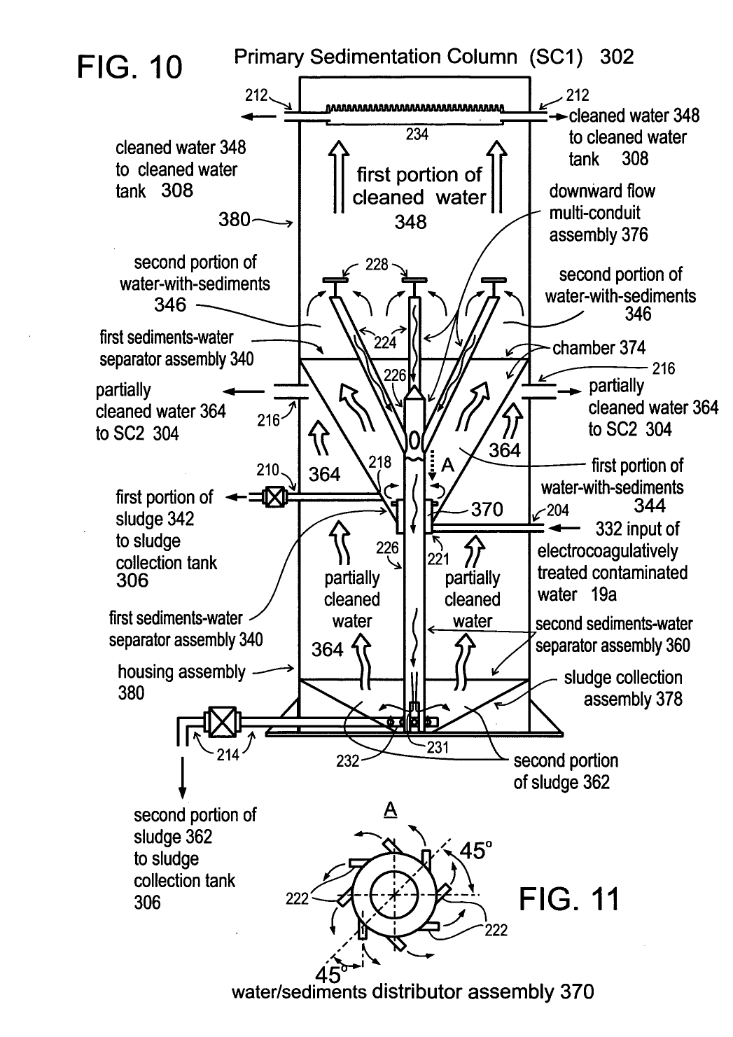

Along with reference to FIG. 1, reference is also made to the following figures, FIGS. 10, 11, and 12.

FIG. 10 is a schematic diagram illustrating a cut-away side view of an exemplary embodiment of the (first or primary) ‘gravity-type’ sedimentation, settling, or [water] clarification column (Primary Sedimentation Column (SC1)) 302, [highlighting an exemplary embodiment of the main components of the internal structure and operation thereof, for effecting the various (primary) ‘gravity-type’ sedimentation, settling, or [water] clarification, solid-liquid separation processes therein], being part of the output unit 18 included in the electrocoagulative water contaminant removal system 10 illustrated in FIG. 1.

FIG. 11 is a schematic diagram illustrating a cut-away top view (A) of an exemplary embodiment of the water/sediments distributor assembly 370 [highlighting special technical (structural and functional) features and characteristics thereof], included in the first sediments-water separator assembly 340 configured inside the (first or primary) ‘gravity-type’ sedimentation, settling, or [water] clarification column (Primary Sedimentation Column (SC1)) 302 illustrated in FIG. 10.

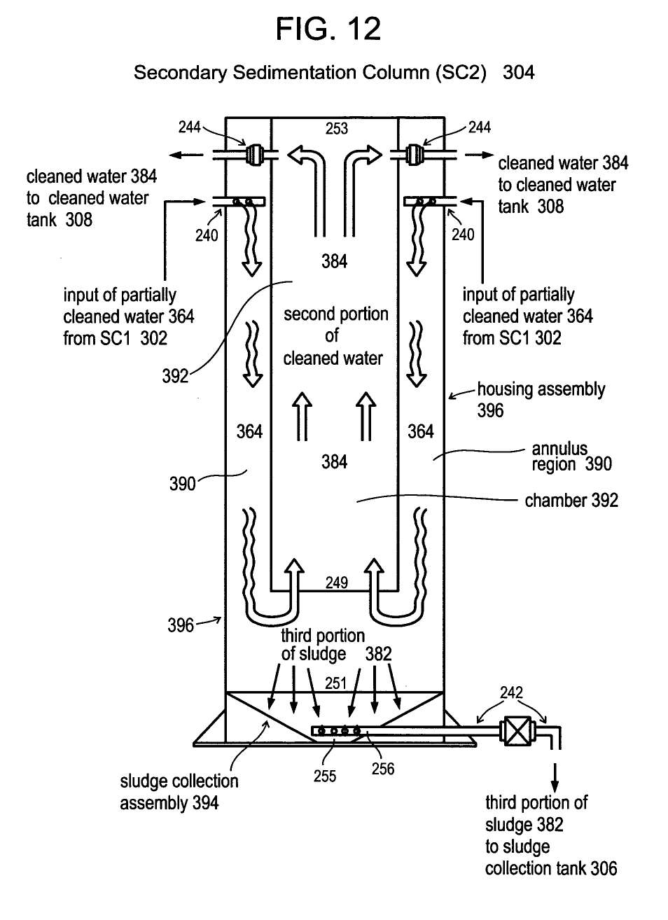

FIG. 12 is a schematic diagram illustrating a cut-away side view of an exemplary embodiment of the (second or secondary) ‘gravity-type’ sedimentation, settling, or [water] clarification column (Secondary Sedimentation Column (SC2)) 304, [highlighting an exemplary embodiment of the main components of the internal structure and operation thereof, for effecting the various (secondary) ‘gravity-type’ sedimentation, settling, or [water] clarification, solid-liquid separation processes therein], being part of the output unit 18 included in the electrocoagulative water contaminant removal system 10 illustrated in FIG. 1.

Hereinafter, for brevity, first or primary sedimentation, settling, or [water] clarification column (Primary Sedimentation Column (SC1)) 302, is also referred to as Primary Sedimentation Column (SC1) 302, and second or secondary sedimentation, settling, or [water] clarification column (Secondary Sedimentation Column (SC2)) 304, is also referred to as Secondary Sedimentation Column (SC2) 304.

### Receiving and Holding Tank

Receiving and holding tank 300 is configured and functions for receiving electrocoagulatively treated contaminated water 19 (particularly, first portion 19a thereof) and electrocoagulation reaction products thereof, from electrocoagulation reactor unit 16, and for holding or containing electrocoagulatively treated contaminated water 19a for a pre-determined period of (holding) time, prior to transferring and forwarding electrocoagulatively treated contaminated water 19a to first or primary sedimentation, settling, or [water] clarification column (Primary Sedimentation Column (SC1)) 302 of output unit 18.

The (holding) time period allows the various different types, kinds, and forms, of solid and solid-like electrocoagulation reaction products [i.e., coagulates, flocculates (flocs or flakes), precipitates, aggregates (aggregations), agglomerates (agglomerations), or/and clumps)], produced and contained within electrocoagulatively treated contaminated water 19a, to ‘grow’ and increase in size and weight (mass). Such ‘growth’ and increase in size and weight (mass) provides for a more effective, and therefore, more efficient, ‘gravity-type’ sedimentation, settling, or [water] clarification, of the solid and solid-like electrocoagulation reaction products out from electrocoagulatively treated contaminated water 19a, via operation of output unit 18 and components thereof, in general, and via operation of Primary Sedimentation Column (SC1) 302, and via operation of Secondary Sedimentation Column (SC2) 304, in particular, for forming the above stated various possible different electrocoagulative water removal system output ‘preliminary’ and ‘final’ separation (purification) products, for ultimately forming sludge 21 and cleaned water 23.

Receiving and holding tank 300 is also configured and functions for receiving and holding or containing electrocoagulatively treated contaminated water 19a as a large volume supply to Primary Sedimentation Column (SC1) 302, until the instantaneous level of electrocoagulatively treated contaminated water 19a inside receiving and holding tank 300 increases to (i.e., equals) a pre-determined minimum level sufficient for operation of water pump 312.

Receiving and holding tank 300 includes an inlet assembly 200 for receiving electrocoagulatively treated contaminated water 19 (particularly, first portion 19a thereof) and electrocoagulation reaction products thereof, from electrocoagulation reactor unit 16, via reactor housing first outlet assembly 124, and an outlet assembly 202 through which electrocoagulatively treated contaminated water 19a exits receiving and holding tank 300, and enters Primary Sedimentation Column (SC1) 302.

The instantaneous level, and therefore, the instantaneous amount, of electrocoagulatively treated contaminated water 19a inside of receiving and holding tank 300 is monitored (measured) and controlled by operation of automatic water level monitoring (measuring) and controlling mechanism 322 which is configured for being operatively connected to power supply and process control unit 20, via output unit electronic input/output control signal communications line 326. Automatic water level monitoring (measuring) and controlling mechanism 322 is preferably located inside of receiving and holding tank 300, as shown in FIG. 1.

When the instantaneous level of electrocoagulatively treated contaminated water 19a inside of receiving and holding tank 300 increases to (i.e., equals) the pre-determined minimum level sufficient for operation of water pump 312, central programming and electronic input/output control signal processing assembly 504 of power supply and process control unit 20, via output unit electronic input/output control signal communications line 326, sends a {valve-open} process control signal to valve 316 for actuating and opening valve 316, and simultaneously sends a {pump-on} process control signal to water pump 312 for actuating and turning-on water pump 312, thereby initiating and directing electrocoagulatively treated contaminated water 19a to flow from receiving and holding tank 300, via an outlet assembly 202 thereof, through valve 316, through water flow rate measuring mechanism 324, then through water pump 312, and into Primary Sedimentation Column (SC1) 302, via an inlet assembly 204 thereof.

The (volumetric or mass) flow rate of electrocoagulatively treated contaminated water 19a exiting from receiving and holding tank 300 and entering Primary Sedimentation Column (SC1) 302 is controlled by valve 316, and is measured by water flow rate measuring mechanism 324, for example, a flow meter configured and operable for, measuring flow rates of a liquid, particularly, water, such as electrocoagulatively treated contaminated water 19a. Valve 316 and water flow rate measuring mechanism 324 are each configured for being operatively connected to power supply and process control unit 20, via output unit electronic input/output control signal communications line 326.

Receiving and holding tank 300 is also configured and functions for expelling, and thereby, reducing or entirely removing, foam which may be present inside receiving and holding tank 300, from receiving and holding tank 300. Foam inside receiving and holding tank 300 is expelled, and thereby, reduced or entirely removed, via positive air pressure continuously existing inside receiving and holding tank 300, from receiving and holding tank 300.

Accordingly, receiving and holding tank 300 also includes a foam outlet assembly 206 for expelling foam inside receiving and holding tank 300, from receiving and holding tank 300, as illustrated in FIG. 1 by the foam transport conduit shown adjacent to the thick dashed arrow 208 drawn above foam outlet assembly 206 of receiving and holding tank 300.

Foam which is present inside receiving and holding tank 300, is expelled, and thereby reduced or entirely removed, from, receiving and holding tank 300, via foam outlet assembly 206, as a result of electrocoagulative water contaminant removal system 10 being designed, constructed, and operated, such that positive air pressure continuously exists inside receiving and holding tank 300. Foam expelled from receiving and holding tank 300 is sent to, and received by, second holding tank 26, via foam transport conduit junction (T join) 79, and via foam inlet assembly 72, of input unit 14. The foam is absorbed or/and dissolved inside second holding tank 26, as a result of electrocoagulative water contaminant removal system 10 being designed, constructed, and operated, such that negative air pressure continuously exists inside second holding tank 26.

### First or Primary Sedimentation, Settling, or [Water] Clarification Column (Primary Sedimentation Column (SC1))

As shown in FIG. 1, in output unit 18, first or primary sedimentation, settling, or [water] clarification column (Primary Sedimentation Column (SC1)) 302 is located downstream from receiving and holding tank 300. With additional reference made to FIG. 10, First or primary sedimentation, settling, or [water] clarification column (Primary Sedimentation Column (SC1)) 302 is configured and functions for: (i) receiving and separating electrocoagulatively treated contaminated water 19a into a first portion of sludge 342, a first portion of water-with-sediments 344, (ii) separating first portion of water-with-sediments 344 into a second portion of water-with-sediments 346, and a first portion of cleaned water 348, and (iii) receiving and separating second portion of water-with-sediments 346 into a second portion of sludge 362, and partially cleaned water 364.

Primary Sedimentation Column (SC1) 302 is also configured and functions for: (iv) enabling first portion of sludge 342 to exit and be transferred (i.e., pumped, via water pump 314) from Primary Sedimentation Column (SC1) 302 to sludge collection tank 306, (v) enabling first portion of cleaned water 348 to exit and be transferred from Primary Sedimentation Column (SC1) 302 to cleaned water tank 308, (vi) enabling second portion of sludge 362 to exit and be transferred from Primary Sedimentation Column (SC1) 302 to sludge collection tank 306, and (vii) enabling partially cleaned water 364 to exit and be transferred from Primary Sedimentation Column (SC1) 302 to Secondary Sedimentation Column (SC2) 304.

Primary Sedimentation Column (SC1) 302 includes the following main components: (a) a first sediments-water separator assembly 340, and (b) a second sediments-water separator assembly 360. Primary Sedimentation Column (SC1) 302 further includes additional components: (c) a housing assembly 380, (d) a column inlet assembly 204, (e) a sludge first outlet assembly 210, (f) at least one cleaned water receiver and outlet assembly 212, (g) a sludge second outlet assembly 214, and (h) at least one partially cleaned water outlet assembly 216.

### First Sediments-Water Separator Assembly

With reference to FIG. 10, in Primary Sedimentation Column (SC1) 302, first sediments-water separator assembly 340 is configured and functions for (i) receiving and separating electrocoagulatively treated contaminated water 19a into first portion of sludge 342, and first portion of water-with-sediments 344, and (ii) separating first portion of water-with-sediments 344 into second portion of water-with-sediments 346, and first portion of cleaned water 348.

First sediments-water separator assembly 340 is also configured and functions for enabling first portion of sludge 342 to exit and be transferred from first sediments-water separator assembly 340 to sludge collection tank 306 which collects first portion of sludge 342.

First sediments-water separator assembly 340 includes the following main components: (i) a water/sediments distributor assembly 370, (ii) a chamber 374, and (iii) a sludge outlet port 218.

### Water/Sediments Distributor Assembly

Water/sediments distributor assembly 370 is configured and functions for receiving, and, laterally and circularly distributing, in a ‘fixed’ manner, electrocoagulatively treated contaminated water 19a, which is input (indicated in FIGS. 1 and 10 by 332) from receiving and holding tank 300, via column inlet assembly 204, throughout the bottom section of first sediments-water separator assembly 340. Water/sediments distributor assembly 370 is, preferably, located in, and configured fixed to, the bottom section of open chamber 374 of first sediments-water separator assembly 340.

Reference is again made to FIG. 11, a schematic diagram illustrating a cut-away top view (A) of an exemplary embodiment of water/sediments distributor assembly 370 [highlighting special technical (structural and functional) features and characteristics thereof], included in the first sediments-water separator assembly 340 configured inside (first or primary) ‘gravity-type’ sedimentation, settling, or [water] clarification column (Primary Sedimentation Column (SC1)) 302 illustrated in FIG. 10.

As shown in FIGS. 10 and 11, water/sediments distributor assembly 370 is, for example, of a cylindrical geometrical shape or form, and includes: (i) an inlet assembly X221X, for receiving electrocoagulatively treated contaminated water 19a from receiving and holding tank 300, via column inlet assembly 204, via valve 316, water flow rate measuring mechanism 324, and water pump 312, and (ii) a plurality of at least two, for example, at least four, angularly spaced apart, water distributing elements 222 that are configured and function for effecting the distributing of electrocoagulatively treated contaminated water 19a throughout the bottom section of chamber 374 of first sediments-water separator assembly 340.

Water/sediments distributor assembly 370 includes, in general, any number of angularly spaced apart, structurally fixed, rigid or/and flexible, and, for example, hollow cylindrical or tubular geometrically shaped or formed, water distributing elements 222; and includes, for example, at least four, six, or eight, angularly spaced apart, water distributing elements 222, wherein the open (i.e., outlet) end portions of two adjacent, nearest-neighboring water distributing elements 222 are spaced apart by an angle of at least about 10° (i.e., 10 degrees). In the exemplary embodiment of water/sediments distributor assembly 370 shown in FIG. 11, water/sediments distributor assembly 370 includes eight, angularly spaced apart from each other, structurally fixed, rigid or/and flexible, and, for example, each hollow cylindrical or tubular geometrically shaped or formed, water distributing elements 222, wherein the open (i.e., outlet) end portions of two adjacent, nearest-neighboring water distributing elements 222 are spaced apart by an angle of 45°.

### Chamber

Chamber 374 is configured and functions for: (i) housing water/sediments distributor assembly 370 in the bottom section thereof, and (ii) providing sufficient volumetric space in the remaining sections thereof for effecting separation of electrocoagulatively treated contaminated water 19a into first portion of sludge 342 and first portion of water-with-sediments 344, and for effecting separation of first portion of water-with-sediments 344 into second portion of water-with-sediments 346 and first portion of cleaned water 348.

Chamber 374 is also configured and functions for housing sludge outlet port or assembly 218, for enabling first portion of sludge 342 to exit and be transferred (i.e., pumped, via water pump 314) from the bottom section of chamber 374, through sludge first outlet assembly 210 of housing assembly 380, and into sludge collection tank 306.

As shown in FIG. 10, chamber 374 is, for example, of a hollow conical geometrical shape or form, whose top end is open, and whose bottom section houses water/sediments distributor assembly 370.

Summary of the Overall, Sequential Operation and Main Components thereof, of the First Sediments-Water Separator Assembly

In Primary Sedimentation Column (SC1) 302, during operation of first sediments-water separator assembly 340, electrocoagulatively treated contaminated water 19a is input (332, FIGS. 1 and 10) from receiving and holding tank 300 and into the bottom section of water/sediments distributor assembly 370. Thereafter, electrocoagulatively treated contaminated water 19a upwardly flows through water/sediments distributor assembly 370, then, laterally and circularly flows and is distributed out of water/sediments distributor assembly 370 into the bottom section of chamber 374. Therein, electrocoagulatively treated contaminated water 19a separates into first portion of sludge 342 and first portion of water-with-sediments 344. First portion of sludge 342 is transferred (i.e., pumped, via water pump 314) out of the bottom section of chamber 374, through sludge outlet port or assembly 218 of chamber 374 and through sludge first outlet assembly 210 of housing assembly 380, and into sludge collection tank 306. First portion of water-with-sediments 344 upwardly flows through and exits the open top section of chamber 374, and flows into the upper middle section of housing assembly 380 of Primary Sedimentation Column (SC1) 302, while separating into second portion of water-with-sediments 346 and first portion of cleaned water 348.

### Second Sediments-Water Separator Assembly

With reference to FIG. 10, in Primary Sedimentation Column (SC1) 302, second sediments-water separator assembly 360 is configured and functions for receiving and separating second portion of water-with-sediments 346 into second portion of sludge 362, and partially cleaned water 364. More specifically, second sediments-water separator assembly 360 receives second portion of water-with-sediments 346 from first sediments-water separator assembly 340, via the open top section of chamber 374, and separates second portion of water-with-sediments 346 into second portion of sludge 362, and partially cleaned water 364.

Second sediments-water separator assembly 360 is also configured and functions for: (i) enabling second portion of sludge 362 to exit and be transferred (i.e., pumped, via water pump 314) from second sediments-water separator assembly 360 to sludge collection tank 306 which collects second portion of sludge 362, and (ii) enabling partially cleaned water 364 to exit and be transferred from second sediments-water separator assembly 360 to the bottom and middle sections of housing assembly 380 of Primary Sedimentation Column (SC1) 302.

Second sediments-water separator assembly 360 includes the following main components: (i) a downward flow multi-conduit assembly 376, and (ii) a sludge collection assembly 378.

### Downward Flow Multi-Conduit Assembly

Downward flow multi-conduit assembly 376 is configured and functions for: (i) receiving second portion of water-with-sediments 346 from the upper middle section of housing assembly 380 of Primary Sedimentation Column (SC1) 302, and (ii) directing downward flow of second portion of water-with-sediments 346 to the bottom section of sludge collection assembly 378.

Downward flow multi-conduit assembly 376 includes: (i) a plurality of at least two, for example, four (as shown), branch conduit assemblies 224, and (ii) a trunk conduit assembly 226.

Each branch conduit assembly 224 is configured and functions for: (i) receiving second portion of water-with-sediments 346 from the upper middle section of housing assembly 380 of Primary Sedimentation Column (SC1) 302, and (ii) directing downward flow of second portion of water-with-sediments 346 into the upper portion of trunk conduit assembly 226.

As shown in FIG. 10, each branch conduit assembly 224 is, for example, structurally fixed, rigid, and, for example, of a hollow cylindrical or tubular geometrical shape or form, having two ends. The first (i.e., the top) end of each branch conduit assembly 224 is operatively connected to a baffle type assembly 228 which is configured and functions for effecting the receiving (via catching or baffling, and downwardly directing) second portion of water-with-sediments 346 from the upper middle section of housing assembly 380 of Primary Sedimentation Column (SC1) 302. The second (i.e., the bottom) end of each branch conduit assembly 224 is operatively connected to the upper portion of trunk conduit assembly 226.

Trunk conduit assembly 226 is configured and functions for: (i) receiving second portion of water-with-sediments 346 from the bottom ends of the plurality of at least two, preferably, four, branch conduit assemblies 224, and (ii) directing downward flow of second portion of water-with-sediments 346 to the bottom section of sludge collection assembly 378.

As shown in FIG. 10, trunk conduit assembly 226 is, for example, structurally fixed, rigid, and of a hollow cylindrical or tubular geometrical shape or form, having two ends. The first (i.e., the top) end of trunk conduit assembly 226 is closed. The second (i.e., the bottom) end of trunk conduit assembly 226 includes an outlet port or assembly 231 which is located in the bottom section of sludge collection assembly 378.

### Sludge Collection Assembly

Sludge collection assembly 378 is configured and functions for: (i) receiving second portion of water-with-sediments 346 which downwardly flows through downward flow multi-conduit assembly 376 and exits from outlet port or assembly 230 located in the second (i.e., the bottom) end of trunk conduit assembly 226, (ii) providing sufficient volumetric space therein for effecting separation of second portion of water-with-sediments 346 into second portion of sludge 362, and partially cleaned water 364, and (iii) collecting second portion of sludge 362 in the bottom section of sludge collection assembly 378.

Sludge collection assembly 378 is also configured and functions for: (iv) enabling second portion of sludge 362 to exit and be transferred (i.e., pumped, via water pump 314) from the bottom section of sludge collection assembly 378, into and through sludge second outlet assembly 214 of housing assembly 380, and into sludge collection tank 306 which collects second portion of sludge 362, and (v) enabling partially cleaned water 364 to upwardly flow, exit, and be transferred, through the open top end of sludge collection assembly 378 to the bottom and middle sections of housing assembly 380 of Primary to Sedimentation Column (SC1) 302. For enabling the exit and transfer of (iv) above, sludge collection assembly 378 is configured and functions for housing the inlet end portion 232 of sludge second outlet assembly 214 of housing assembly 380. For example, the bottom section of sludge collection assembly 378 is operatively connected to the inlet end portion 232 of sludge second outlet assembly 214 which is housed in housing assembly 380 of Primary Sedimentation Column (SC1) 302.

As shown in FIG. 10, sludge collection assembly 378 is, for example, of a hollow conical geometrical shape or form. The top end of sludge collection assembly 378 is open. The bottom section of sludge collection assembly 378 houses the second (i.e., the bottom) end of trunk conduit assembly 226 and outlet port or assembly 230 thereof.

Summary of the Overall, Sequential Operation and Main Components thereof, of the Second Sediments-Water Separator Assembly

In Primary Sedimentation Column (SC1) 302, during operation of second sediments-water separator assembly 360, second portion of water-with-sediments 346 flows from the upper middle section of housing assembly 380 of Primary Sedimentation Column (SC1) 302, is caught or baffled, and downwardly directed, by baffle type assemblies 228 of branch conduit assemblies 224 of downward flow multi-conduit assembly 376, into branch conduit assemblies 224. Then, second portion of water-with-sediments 346 downwardly flows through branch conduit assemblies 224 and trunk conduit assembly 226 to the bottom section of sludge collection assembly 378. Therein, second portion of water-with-sediments 346 is separated into second portion of sludge 362, and partially cleaned water 364. Then, second portion of sludge 362 collects in, and, exits and is transferred (i.e., pumped, via water pump 314) from, the bottom section of sludge collection assembly 378, into and through sludge second outlet assembly 214 of housing assembly 380, and into sludge collection tank 306 which collects second portion of sludge 362. At the same time, partially cleaned water 364 upwardly flows, exits, and is transferred, through the open top end of sludge collection assembly 378 to the bottom and middle sections of housing assembly 380 of Primary Sedimentation Column (SC1) 302.

### Housing Assembly

In Primary Sedimentation Column (SC1) 302, housing assembly 380 is configured and functions for housing: (i) column inlet assembly 204, for receiving (332) input of electrocoagulatively treated contaminated water 19a from receiving and holding tank 300, (ii) sludge first outlet assembly 210, for enabling first portion of sludge 342 to exit and be transferred from the bottom section of chamber 374 of first sediments-water separator assembly 340, and into sludge collection tank 306, (iii) the at least one cleaned water receiver and outlet assembly 212 (which includes, for example, a comb or comb-like shaped intermediate assembly 234), for enabling first portion of cleaned water 348 to exit and be transferred from the top section of housing assembly 380, and into cleaned water tank 308, (iv) sludge second outlet assembly 214, for enabling second portion of sludge 362 to exit and be transferred from the bottom section of sludge collection assembly 378, and into sludge collection tank 306, and (v) the at least one partially cleaned water outlet assembly 216, for enabling partially cleaned water 364 to exit and be transferred from the middle section of housing assembly 380, and into Secondary Sedimentation Column (SC2) 304.

Second or Secondary Sedimentation, Settling, or [Water] Clarification column (Secondary Sedimentation Column (SC2))

As shown in FIG. 1, in output unit 18, second or secondary sedimentation, settling, or [water] clarification column (Secondary Sedimentation Column (SC2)) 304 is located downstream from first or primary sedimentation, settling, or [water] clarification column (Primary Sedimentation Column (SC1)) 302. With additional reference made to FIGS. 12 and 10, second or secondary sedimentation, settling, or [water] clarification column (Secondary Sedimentation Column (SC2)) 304 is configured and functions for: receiving and separating partially cleaned water 364 into a third portion of sludge 382, and a second portion of cleaned water 384.

Secondary Sedimentation Column (SC2) 304 is also configured and functions for enabling third portion of sludge 382 to exit and be transferred (i.e., pumped, via water pump 314) from Secondary Sedimentation Column (SC2) 304 to sludge collection tank 306, and for enabling second portion of cleaned water 384 to exit and be transferred from Secondary Sedimentation Column (SC2) 304 to cleaned water tank 308.

Secondary Sedimentation Column (SC2) 304 includes the following main components: (a) an annulus region 390, (b) a chamber 392, and (c) a sludge collection assembly 394. Secondary Sedimentation Column (SC2) 304 further includes additional components: (d) at least one column inlet assembly 240, (e) a sludge outlet assembly 242, (f) at least one cleaned water outlet assembly 244, and (g) a housing assembly 396.

### Annulus Region

Annulus region 390 is configured and functions for: (i) receiving partially cleaned water 364 which is input into Secondary Sedimentation Column (SC2) 304 upon exiting from the middle section of housing assembly 380, via the at least one partially cleaned water outlet assembly 216, of Primary Sedimentation Column (SC1) 302 (FIG. 11), and (ii) providing sufficient volumetric space inside of Secondary Sedimentation Column (SC2) 304 for effecting separation of partially cleaned water 364 into third portion of sludge 382, and second portion of cleaned water 384.

As shown in FIG. 12, annulus region 390 encompasses the volumetric space contained between the perimeter (i.e., circumference) of the housing assembly 396 of Secondary Sedimentation Column (SC2) 304 and the perimeter (i.e., circumference) of chamber 392, and also encompasses the volumetric space spanning from underneath the open bottom end 249 of chamber 392 to the open top end 251 of sludge collection assembly 394. The top section 253 of annulus region 390 is operatively connected to the at least one column inlet assembly 240 which is housed in housing assembly 396 of Secondary Sedimentation Column (SC2) 304, for enabling receiving the input of partially cleaned water 364 from the at least one partially cleaned water outlet assembly 216 of Primary Sedimentation Column (SC1) 302.

### Chamber

Chamber 392 is configured and functions for: (i) receiving second portion of cleaned water 384 which flows out of annulus region 390, (ii) providing sufficient volumetric space therein for second portion of cleaned water 384 to upwardly flow through chamber 392, and (iii) enabling second portion of cleaned water 384 to exit and be transferred from Secondary Sedimentation Column (SC2) 304 to cleaned water tank 308.

As shown in FIG. 12, the open bottom end 249 of chamber 392 shares an interface, and is in fluid communication, with the top level of the bottom portion volumetric space of annulus region 390. The top section 253 of chamber 392 is operatively connected to the at least one cleaned water outlet assembly 244 which is housed in housing assembly 396 of Secondary Sedimentation Column (SC2) 304, for enabling second portion of cleaned water 384 to exit and be transferred from Secondary Sedimentation Column (SC2) 304 to cleaned water tank 308.

### Sludge Collection Assembly

Sludge collection assembly 394 is configured and functions for: (i) receiving third portion of sludge 382 which separates out from partially cleaned water 364 that flows downward through annulus region 390, and (ii) collecting third portion of sludge 382 in the bottom section 255 of sludge collection assembly 394.

Sludge collection assembly 394 is also configured and functions for: (iii) enabling third portion of sludge 382 to exit and be transferred (i.e., pumped, via water pump 314) from bottom section 255 of sludge collection assembly 394, into and through sludge outlet assembly 242 of housing assembly 396 of Secondary Sedimentation Column (SC2) 304, and into sludge collection tank 306 which collects third portion of sludge 382. For enabling this exit and transfer, the bottom section 255 of sludge collection assembly 394 is operatively connected to the inlet end portion 256 of sludge outlet assembly 242 which is housed in housing assembly 396 of Secondary Sedimentation Column (SC2) 304.

### Housing Assembly

In Secondary Sedimentation Column (SC2) 304, housing assembly 396 is configured and functions for housing: (i) the at least one column inlet assembly 240, (ii) sludge outlet assembly 242, and (iii) the at least one cleaned water outlet assembly 244.

Summary of the Overall, Sequential Operation and Main Components thereof, of the Secondary Sedimentation Column (SC2)

In output unit 18, during operation of second or secondary sedimentation, settling, or [water] clarification column (Secondary Sedimentation Column (SC2)) 304, partially cleaned water 364 exits from the middle section of housing assembly 380, via the at least one partially cleaned water outlet assembly 216, of Primary Sedimentation Column (SC1) 302, and is input into the top section of annulus region 390, via the at least one column inlet assembly 240 of Secondary Sedimentation Column (SC2) 304. Therein, partially cleaned water 364 downwardly flows through annulus region 390, and separates into third portion of sludge 382, and second portion of cleaned water 384. Third portion of sludge 382 is collected in bottom section 255 of sludge collection assembly 394. Then, third portion of sludge 382 exits and is transferred (i.e., pumped, via water pump 314) from bottom section 255 of sludge collection assembly 394, into and through sludge outlet assembly 242 of housing assembly 396 of Secondary Sedimentation Column (SC2) 304, and into sludge collection tank 306 which collects third portion of sludge 382. At the same time, second portion of cleaned water 384 upwardly flows through the bottom portion volumetric space of annulus region 390, and into open bottom end 249 of chamber 392. Second portion of cleaned water 384 upwardly flows through, and, exits and is transferred from, top section 253 of chamber 392, via the at least one cleaned water outlet assembly 244 of Secondary Sedimentation Column (SC2) 304, and flows into cleaned water tank 308.

### Operating Characteristics, Behavior, Performance, and Efficiency, of the Primary Sedimentation Column (SC1) and the Secondary Sedimentation Column (SC2)

As stated hereinabove in the ‘Background’ section, a significant problem or limitation associated with current teachings of electrocoagulatively removing contaminants from contaminated water, relates to inefficient structure and operation (limited separation performance, efficiency) of a ‘gravity-type’ sedimentation, settling, or [water] clarification, column. This significant problem or limitation particularly pertains to those types or kinds of electrocoagulative water removal systems which include downstream, post-electrocoagulation reactor unit equipment and procedures for receiving and forwarding the electrocoagulatively treated contaminated water which exits the electrocoagulation reactor unit to at least one type of ‘secondary’ or ‘tertiary’ solid-liquid separation process based on ‘gravity-type’ sedimentation, settling, or [water] clarification.

As also discussed in the ‘Background’ section, a given particular design and construction of the inside of a ‘gravity-type’ sedimentation, settling, or [water] clarification column, directly influence the various aspects and parameters relating to the flow field and related fluid flow properties, characteristics, and behavior, of the electrocoagulatively treated contaminated water, in general, and of the various different types, kinds, and forms, of solid and solid-like electrocoagulation reaction products [i.e., coagulates, flocculates (flocs or flakes), precipitates, aggregates (aggregations), agglomerates (agglomerations), or/and clumps)], produced and contained therein.

These aspects and parameters, in turn, directly influence the various aspects and parameters relating to physicochemical characteristics and behavior of the various ‘gravity-type’ sedimentation, settling, or [water] clarification, solid-liquid separation processes which take place inside of the sedimentation, settling, or [water] clarification column.

All of the preceding aspects and parameters collectively, ultimately influence the overall operating characteristics, behavior, performance, and efficiency, of the sedimentation, settling, or [water] clarification column, for effecting separation (sedimentation, settling, clarification) of the solid and solid-like electrocoagulation reaction products out from the electrocoagulatively treated contaminated water, for forming the above described various possible different electrocoagulative water removal system output ‘preliminary’ and ‘final’ separation (purification) products.

In general, performance, and efficiency, of a sedimentation, settling, or [water] clarification column, can be characterized by a (sedimentation, settling, clarification) separation efficiency parameter which is defined as the ratio of: (a) the weight of sludge, being the solid and solid-like (waste) matter (i.e., sediments, settled solids and semi-solids) with a relatively small amount of water, output from the sedimentation, settling, or [water] clarification column, and (b) the ‘total’ weight of solid and solid-like electrocoagulation reaction products [i.e., coagulates, flocculates (flocs or flakes), precipitates, aggregates (aggregations), agglomerates (agglomerations), or/and clumps)] of the electrocoagulatively treated contaminated water, input to the sedimentation, settling, or [water] clarification column.

During operation of an overall electrocoagulative water removal system, it is a clear objective and goal to have a value of the (sedimentation, settling, clarification) separation efficiency parameter be as close as possible to 1.0, which, of course, ultimately translates into contributing to achieving as high as possible overall performance, and efficiency, of the overall electrocoagulative water removal system for electrocoagulatively removing the contaminants from the contaminated water.

For prior art ‘gravity-type’ sedimentation, settling, or [water] clarification columns, the (sedimentation, settling, clarification) separation efficiency parameter has values in the range of between about 0.50 and about 0.85. This means that of the total weight of the solid and solid-like electrocoagulation reaction products produced and contained in the electrocoagulatively treated contaminated water which is input to the sedimentation, settling, or [water] clarification column, between about 50% and about 85% is, and between about 50% and about 15%, respectively, is not, separated (i.e., sedimented, settled, or clarified) out from the electrocoagulatively treated contaminated water inside of, and eventually output from, the sedimentation, settling, or [water] clarification column. It is clearly understood that prior art ‘gravity-type’ sedimentation, settling, or [water] clarification columns have a (sedimentation, settling, clarification) separation efficiency parameter whose values can be quite far from the ideal value of 1.0. This, then, corresponds to a significant problem or limitation of the overall) operating characteristics, behavior, performance, and efficiency, of a typical currently designed, constructed, and used, ‘gravity-type’ sedimentation, settling, or [water] clarification column, which, in turn, translates into a significant problems or limitation of the overall performance, and efficiency, of an overall electrocoagulative water removal system for electrocoagulatively removing contaminants from contaminated water. Moreover, it is also understood from the above discussion that these significant problems or limitations are, therefore, directly traceable back to significant problems or limitations relating to the design and construction of the inside of a ‘gravity-type’ sedimentation, settling, or [water] clarification column.

During operation of electrocoagulative water contaminant removal system 10, wherein output unit 18 includes the ‘gravity-type’ sedimentation, settling, or [water] clarification columns of embodiments of the present invention, namely, first or primary sedimentation, settling, or [water] clarification column (Primary Sedimentation Column (SC1)) 302 (and components thereof), and second or secondary sedimentation, settling, or [water] clarification column (Secondary Sedimentation Column (SC2)) 304 (and components thereof), the applicant/assignee of the present invention has measured and determined that the (sedimentation, settling, clarification) separation efficiency parameter has values in the range of between about 0.85 and about 0.93. This means that of the total weight of the solid and solid-like electrocoagulation reaction products produced and contained in the electrocoagulatively treated contaminated water which is input to the sedimentation, settling, or [water] clarification columns [i.e., Primary Sedimentation Column (SC1) 302 and Secondary Sedimentation Column (SC2) 304], between about 85% and about 93% is, and between about 15% and about 7%, respectively, is not, separated (i.e., sedimented, settled, or clarified) out from the electrocoagulatively treated contaminated water inside of, and eventually output from, Primary Sedimentation Column (SC1) 302 or/and from Secondary Sedimentation Column (SC2) 304. It is clearly understood that the ‘gravity-type’ sedimentation, settling, or [water] clarification columns of embodiments of the present invention have a (sedimentation, settling, clarification) separation efficiency parameter whose values can be significantly closer to the ideal value of 1.0 compared to values for prior art ‘gravity-type’ sedimentation, settling, or [water] clarification columns.

Accordingly, the hereinabove illustratively described embodiments of the present invention, where, in electrocoagulative water contaminant removal system 10, output unit 18 includes first or primary sedimentation, settling, or [water] clarification column (Primary Sedimentation Column (SC1)) 302 (and components thereof), and includes second or secondary sedimentation, settling, or [water] clarification column (Secondary Sedimentation Column (SC2)) 304 (and components thereof), appropriately address and overcome the above described significant problem or limitation relating to inefficient structure and operation (limited separation performance, efficiency) of a ‘gravity-type’ sedimentation, settling, or [water] clarification, column. Such particularly pertains to those types or kinds of electrocoagulative water removal systems which include downstream, post-electrocoagulation reactor unit equipment and procedures for receiving and forwarding the electrocoagulatively treated contaminated water which exits the electrocoagulation reactor unit to at least one type of ‘secondary’ or ‘tertiary’ solid-liquid separation process based on ‘gravity-type’ sedimentation, settling, or [water] clarification.

### Sludge Collection Tank

As shown in FIG. 1, in output unit 18, sludge collection tank 306 is located downstream from both Primary Sedimentation Column (SC1) 302 and Secondary Sedimentation Column (SC2) 304. With additional reference to FIGS. 10 and 12, sludge collection tank 306 is configured and functions for: (i) receiving and collecting first portion of sludge 342, which is transferred (i.e., pumped, via water pump 314) out of the bottom section of, and through sludge outlet port or assembly 218 of, chamber 374 of first sediments-water separator assembly 340, and through sludge first outlet assembly 210 of housing assembly 380, of Primary Sedimentation Column (SC1) 302, (ii) receiving and collecting second portion of sludge 362, which is transferred (i.e., pumped, via water pump 314) out of the bottom section of sludge collection assembly 378, and, into and through sludge second outlet assembly 214 of housing assembly 380, of Primary Sedimentation Column (SC1) 302, and (iii) receiving and collecting third portion of sludge 382, which is transferred (i.e., pumped, via water pump 314) from bottom section 255 of sludge collection assembly 394, and, into and through sludge outlet assembly 242 of housing assembly 396 of Secondary Sedimentation Column (SC2) 304.

Sludge collection tank 306 is also configured and functions for: (iv) combining and mixing the received and collected first portion of sludge 342, second portion of sludge 362, and third portion of sludge 382, for forming a combined or mixed collected sludge, indicated in FIG. 1 as sludge 21, inside of sludge collection tank 306.

Sludge collection tank 306 is also configured and functions for: (v) transferring (i.e., pumping, via water pump 314, and valve 318) the combined or mixed collected sludge, i.e., sludge 21, from sludge collection tank 306, and into filter press 310.

Sludge collection tank 306 includes the following main components: (i) a sludge first inlet assembly 260, for enabling (i) above (i.e., receiving and collecting first portion of sludge 342); (ii) a sludge second inlet assembly 263, for enabling (ii) above (i.e., receiving and collecting second portion of sludge 362); (iii) a sludge third inlet assembly 265, for enabling (iii) above (i.e., receiving and collecting third portion of sludge 382); and (iv) a sludge outlet assembly 266, for enabling (v) above (i.e., combining and mixing the received and collected first, second, and third portions of sludge 342, 362, and 382, respectively, for forming combined or mixed collected sludge 21).

### Cleaned Water Tank

As shown in FIG. 1, in output unit 18, cleaned water tank 308 is also located downstream from both Primary Sedimentation Column (SC1) 302 and Secondary Sedimentation Column (SC2) 304. Cleaned water tank 308 is configured and functions for: (i) receiving and collecting first portion of cleaned water 348 which is transferred from the top section of housing assembly 380, via the at least one cleaned water receiver and outlet assembly 212 (including, for example, comb or comb-like shaped intermediate assembly 234) of Primary Sedimentation Column (SC1) 302, and (ii) receiving and collecting second portion of cleaned water 384 which is transferred from the top section 253 of chamber 392, via the at least one cleaned water outlet assembly 244, of Secondary Sedimentation Column (SC2) 304.

Cleaned water tank 308 is also configured and functions for: (iii) combining and mixing the received and collected first portion of cleaned water 348 and second portion of cleaned water 384, for forming a combined or mixed cleaned water, indicated in FIG. 1 as cleaned water 23, inside of cleaned water tank 308.

Cleaned water tank 308 is also configured and functions for: (iv) transferring the combined or mixed cleaned water, i.e., cleaned water 23, from cleaned water tank 308, and into an external sink, such as a storage or/and transfer tank or vessel, configured, for example, for receiving and storing or/and transferring cleaned water 23 for additional or/and future use.

Cleaned water tank 308 includes the following main components: (i) a cleaned water first inlet assembly 271, for enabling (i) above (i.e., receiving and collecting first portion of cleaned water 348); (ii) a cleaned water second inlet assembly 273, for enabling (ii) above (i.e., receiving and collecting second portion of cleaned water 384); and (iii) a cleaned water outlet assembly 274, for enabling (iv) above (i.e., combining and mixing the received and collected first and second portions of cleaned water 348 and 384, respectively, for forming combined or mixed cleaned water 23).

### Cleaned Water

As stated hereinabove, in an exemplary non-limiting manner, contaminated water 13 which is supplied from the external source and fed into input unit 14, and which may contain any combination of any number of a wide variety of different forms of heavy metal species, has exemplary ‘typical’ input heavy metal species concentrations as follows:

>chromium [Cr]: 320 milligrams per liter (mg/l) [320 parts per million (ppm)].
>copper [Cu]: 160 milligrams per liter (mg/l) [160 parts per million (ppm)].
>nickel [Ni]: 100 milligrams per liter (mg/l) [100 parts per million (ppm)].
>zinc [Zn]: 100 milligrams per liter (mg/l) [100 parts per million (ppm)].
>tin [Sn]: 100 milligrams per liter (mg/l) [100 parts per million (ppm)].
>antimony [Sb]: 100 milligrams per liter (mg/l) [100 parts per million (ppm)].
>aluminum [Al]: 30 milligrams per liter (mg/l) [30 parts per million (ppm)].
>lead [Pb]: 60 milligrams per liter (mg/l) [60 parts per million (ppm)].
>manganese [Mn]: 15 milligrams per liter (mg/l) [15 parts per million (ppm)].
>molybdenum [Mo]: 12 milligrams per liter (mg/l) [12 parts per million (ppm)].
>cobalt [Co]: 12 milligrams per liter (mg/l) [12 parts per million (ppm)].
tungsten [W]: 12 milligrams per liter (mg/l) [12 parts per million (ppm)].

The result of subjecting contaminated water 13 to electrocoagulative water contaminant removal system 10 for electrocoagulatively removing contaminants from contaminated water 13, is the production of cleaned water 23. For the exemplary case wherein contaminated water 13 is supplied from the external source and fed into input unit 14, and which has the preceding stated exemplary ‘typical’ input heavy metal species concentrations, then, the result of subjecting contaminated water 13 to electrocoagulative water contaminant removal system 10 for electrocoagulatively removing contaminants from contaminated water 13, is the production of cleaned water 23 which has respective exemplary ‘typical’ output heavy metal species concentrations as follows:

>chromium [Cr]: 0.2 milligram per liter (mg/l) [0.2 part per million (ppm)].
>copper [Cu]: 0.5 milligram per liter (mg/l) [0.5 part per million (ppm)].
>nickel [Ni]: 0.6 milligram per liter (mg/l) [0.6 part per million (ppm)].
>zinc [Zn]: 0.2 milligram per liter (mg/l) [0.2 part per million (ppm)].
>tin [Sn]: 0.5 milligram per liter (mg/l) [0.5 part per million (ppm)].
>antimony [Sb]: 0.5 milligram per liter (mg/l) [0.5 part per million (ppm)].
>aluminum [Al]: 5 milligrams per liter (mg/l) [5 parts per million (ppm)].
>lead [Pb]: 0.5 milligram per liter (mg/l) [0.5 part per million (ppm)].
>manganese [Mn]: 0.5 milligram per liter (mg/l) [0.5 part per million (ppm)].
>molybdenum [Mo]: 0.5 milligram per liter (mg/l) [0.5 part per million (ppm)].
>cobalt [Co]: 0.5 milligram per liter (mg/l) [0.5 part per million (ppm)].
>tungsten [W]: 0.5 milligram per liter (mg/l) [0.5 part per million (ppm)].

Thus, cleaned water 23 produced by electrocoagulative water contaminant removal system 10 and contained inside cleaned water tank 308 is readily usable in any of a wide variety of numerous different industrial or commercial applications which require ‘clean water’ having, for example, extremely low heavy metal species concentrations.

The preceding illustrative exemplary case of subjecting contaminated water to the electrocoagulative water contaminant removal system, for electrocoagulatively removing contaminants from the contaminated water, in accordance with the present invention, is based on an average of a significant number of results obtained by the applicant/assignee of the present invention, after performing extensive experimentation, analyzing extensive amounts of experimental data and information, and reducing the present invention to practice.

### Filter Press

As shown in FIG. 1, in output unit 18, filter press 310 is located downstream from sludge collection tank 306. Filter press 310 is configured and functions for receiving and filter pressing the combined or mixed collected sludge, i.e., sludge 21, from sludge collection tank 306, for forming waste sludge and recycle water. The waste sludge is appropriately disposed of, while the recycle water is transferred (i.e., pumped, via water pump 314, and valve 320) through recycle line 330 and into first mixing and holding tank 22, via inlet assembly 58 thereof, of input unit 14. First mixing and holding tank 22 receives and mixes the recycle water with contaminated water 13 supplied from the external source.

Filter press 310 includes the following main components: (i) a sludge inlet assembly 280, operatively connected to water pump 314, for receiving, via valve 318, the combined or mixed collected sludge, i.e., sludge 21, from sludge collection tank 306, (ii) a filter press mechanism 282, for filter pressing the received sludge 21, and (iii) a recycle water outlet assembly 284, operatively connected to valve 320, for enabling the transfer of the recycle water from filter press 310 to first mixing and holding tank 22 of input unit 14.

### Recycle Line

As stated hereinabove, although not formally included as a designated component of output unit 18, or as a designated component of input unit 14, of electrocoagulative water contaminant removal system 10, recycle line 330 is included therein as a fluid communication ‘linking’ or connecting component for linking or connecting, and thereby providing, fluid communication between output unit 18 and input unit 14. As shown in FIG. 1, recycle line 330 has the first end operatively connected to valve 320 of output unit 18, and the second end operatively connected to inlet assembly 58 of first mixing and holding tank 22 of input unit 14, for enabling the transfer of the recycle water from filter press 310 to first mixing and holding tank 22 of input unit 14.

### Recycle Water

The recycle water formed in, and transferred from, filter press 310, is significantly ‘cleaner’ than the original or initial input contaminated water 13 processed by electrocoagulative water contaminant removal system 10, however, the recycle water is significantly less ‘clean’ than cleaned water 23 received by, and contained in, cleaned water tank 308.

Typically, for a given amount (volume or mass) of contaminated water 13 processed by electrocoagulative water contaminant removal system 10 for electrocoagulatively removing contaminants from contaminated water 13, the proportion or ratio between the amount of recycle water formed in, and transferred from, filter press 310, and the amount of cleaned water 23 received by, and contained in, cleaned water tank 308, is typically about 5/95. Thus, the amount of recycle water formed is relatively very small compared to the amount of cleaned water 23 formed, via operation of electrocoagulative water contaminant removal system 10.

Additional Structure, Function, and Operation of the Output Unit, and Components thereof.

Additional details regarding structure, function, and operation, of output unit 18, and components thereof, of electrocoagulative water contaminant removal system 10 shown in FIG. 1, and in FIGS. 10-12, which are relevant to implementing the herein illustratively described exemplary embodiments of the system for electrocoagulatively removing contaminants from contaminated water 13, for producing cleaned water 23 and sludge 21, of the present invention, are provided in the following.

Output unit 18 and components thereof include any additional necessary fluid transfer equipment (the main ones of which are illustratively described hereinabove), such as pipes, tubes, connecting elements, adaptors, fittings, screws, nuts, bolts, washers, o-rings, water pumps, valves, vents, and switches, as well as mechanisms, assemblies, components, and elements thereof, which are made of suitable materials, for fully enabling output unit 18 and components thereof to receive, hold or contain, monitor (measure) and control, and transfer, electrocoagulatively treated contaminated water 19 (particularly, first portion 19a thereof) exiting from electrocoagulation reactor unit 16, and, to contain, store or/and transfer, cleaned water 23, sludge 21, and the recycle water, formed in output unit 18.

Automatic electronic monitoring (measuring) and controlling of operating parameters and conditions of output unit 18 and components thereof, are enabled by power supply and process control unit 20 and components thereof. Electronic input/output, feedforward and feedback transmission and reception of electronic control data, information, and command, communication signals between output unit 18 and components thereof, and, power supply and process control unit 20 and components thereof, are provided by an electronic input/output control data, information, and command, communications line, such as a cable or bundle of wires, or/and a wireless communications line, herein, generally indicated in FIG. 1 as output unit electronic input/output control signal communications line 326.

Output unit 18 and components thereof include any additional necessary mechanical, hydraulic, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of output unit 18 and components thereof, by power supply and process control unit 20 and components thereof.

Output unit 18 and components thereof are configured with, constructed of, and operate with, standard mechanical, hydraulic, electrical, electronic, electro-mechanical, and (wired or/and wireless) communications, mechanisms, assemblies, structures, components, elements, and materials, known in the art of automatically receiving, holding or containing, monitoring (measuring) and controlling, and transferring, water, such as electrocoagulatively treated contaminated water 19 (particularly, first portion 19a thereof) exiting from electrocoagulation reactor unit 16, and, cleaned water 23, sludge 21, and the recycle water, formed in output unit 18, known in the art of automatically receiving, holding or containing, monitoring (measuring) and controlling, and transferring, such types of water and sludge.

Output unit 18 and components thereof are preferably of configurations and constructions which are compatible with, and operated in accordance with, the physicochemical properties, parameters, and characteristics, of electrocoagulatively treated contaminated water 19 (particularly, first portion 19a thereof) exiting from electrocoagulation reactor unit 16, and, cleaned water 23, sludge 21, and the recycle water, formed in output unit 18, as well as with the physicochemical properties, parameters, characteristics, and operating conditions, of the other units, in particular, input unit 14, electrocoagulation reactor unit 16, and, power supply and process control unit 20, of electrocoagulative water contaminant removal system 10, which together are configured and synchronously operated for electrocoagulatively removing contaminants from contaminated water 13, for producing cleaned water 23 and sludge 21.

Power Supply and Process Control Unit, and, Supplying Power to, and Controlling Processes of, the Input Unit, the Electrocoagulation Reactor Unit, and the Output Unit.

In electrocoagulative water contaminant removal system 10, power supply and process control unit 20 is configured for being operatively connected to each of the other units, namely, input unit 14, electrocoagulation reactor unit 16, and output unit 18, of electrocoagulative water contaminant removal system 10. Power supply and process control unit 20 functions for supplying and controlling electrical power to, and for monitoring and controlling process operating parameters and conditions of, each unit of electrocoagulative water contaminant removal system 10. Power supply and process control unit 20 includes the main components of: a power supply assembly 502, a power supply monitoring (measuring) and controlling mechanism 500, and, a central programming and electronic input/output control signal processing assembly 504.

Power supply assembly 502 includes, for example, a multi-functional, multi-operational type of power supply, for supplying power according to any of various different types of spatial or/and temporal power configurations, modes, formats, schemes, and schedules, involving synchronous supply of power in the form of dc or/and ac voltage or/and current, to each unit, and components thereof, of electrocoagulative water contaminant removal system 10.

Power supply monitoring (measuring) and controlling mechanism 500 is for automatically monitoring (measuring) and controlling power supply assembly 502, and therefore, is for automatically monitoring (measuring) and controlling power supplied to each unit of electrocoagulative water contaminant removal system 10, according to any of various different types of spatial or/and temporal power configurations, modes, formats, schemes, and schedules, involving synchronous supply of power in the form of dc or/and ac voltage or/and current.

Central programming and electronic input/output control signal processing assembly 504 is configured, for example, as one or more computers which are part of a centralized computer work station. Central programming and electronic input/output control signal processing assembly 504 functions for: (1) centrally housing computerized software programs which are used for operating and controlling all computerized functions of electrocoagulative water contaminant removal system 10 and units thereof, according to any of various different types of spatial or/and temporal configurations, modes, formats, schemes, and schedules, and (2) centrally housing a computerized processing assembly which processes and manages all of the electronic input/output, feedforward and feedback transmission and reception of electronic control data, information, and command, communication signals between power supply and process control unit 20 and components thereof, and, each of the units and components thereof of electrocoagulative water contaminant removal system 10.

Power supply and process control unit 20, and components thereof, are electronically linked or connected to electronically operable components of each of the other units, namely, input unit 14, electrocoagulation reactor unit 16, and output unit 18, of electrocoagulative water contaminant removal system 10, via input unit electronic input/output control signal communications lines, such as cables or bundles of wires, or/and, a wireless network of wireless communications lines, generally indicated in FIG. 1 as input unit, electrocoagulation reactor unit, and output unit, electronic input/output control signal communications lines 52, 104, and 326, respectively. Such wired or/and wireless electronic linkages or connections enable electronic feedforward and feedback transmission and reception of electronic data, information, and command, communication signals between the electronically operable components of each unit of electrocoagulative water contaminant removal system 10, with power supply and process control unit 20 and components thereof. This, in turn, enables automatic electronic monitoring (measuring) and controlling of operating parameters and conditions of each unit of electrocoagulative water contaminant removal system 10, by power supply and process control unit 20 and components thereof.

For example, regarding operation of electrocoagulation reactor unit 16, as shown in FIG. 1, electrocoagulation reactor unit 16, in general, and electrode set 100 and electrodes thereof, in particular, are configured for being operatively connected to power supply and process control unit 20, via electrocoagulation reactor unit electronic input/output control signal communications line 104. In electrode set 100 of electrocoagulation reactor unit 16, the top end portion 108 of each (anode or cathode) monopolar electrode 104 is electrically connected, for example, via respective positive (+) electrical leads 112 and negative (−) electrical leads 114, to power supply assembly 502 of power supply and process control unit 20, as particularly shown in FIGS. 1, 7-9. During operation of electrocoagulation reactor unit 16, a controllable constant direct current (dc) provided to electrode set 100 and electrodes thereof, is supplied, monitored (measured), and controlled, via power supply assembly 502, power supply monitoring (measuring) and controlling mechanism 500, and central programming and electronic input/output control signal processing assembly 504, of power supply and process control unit 20.

Power supply and process control unit 20 and components thereof include any additional necessary mechanical, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of the electronically operable components of each of the other units, namely, input unit 14, electrocoagulation reactor unit 16, and output unit 18, of electrocoagulative water contaminant removal system 10, by power supply and process control unit 20 and components thereof.

Power supply and process control unit 20 and components thereof are configured with, constructed of, and operate with, standard mechanical, electrical, electronic, electro-mechanical, and (wired or/and wireless) communications, mechanisms, assemblies, structures, components, elements, and materials, known in the art of automatically supplying, monitoring (measuring), and controlling, electrical power to electronically operable components, and known in the art of automatically monitoring (measuring) and controlling operating parameters and conditions of electronically operable components, such as electronically operable valves, water pumps, automatic water (volumetric or mass) input level monitoring (measuring) and controlling mechanisms, electrodes, redox potential measuring mechanisms, power supply assemblies, power supply monitoring (measuring) and controlling mechanisms, central programming and electronic input/output control signal processing assemblies, which are included in the various units of electrocoagulative water contaminant removal system 10.

By way of the electrocoagulation reactor unit being a main component and sub-combination of the electrocoagulative water contaminant removal system, the present invention also features a device, corresponding to the electrocoagulation reactor unit, for electrocoagulatively treating contaminated water.

Thus, with reference to FIGS. 1-9, another main aspect of the present invention is provision of an electrocoagulation reactor unit 16 for electrocoagulatively treating contaminated water 13, including the following main components and functionalities thereof: (a) a reactor housing input assembly 120, for receiving the contaminated water 13; (b) an electrocoagulation reactor housing assembly 102 operatively connected to the reactor housing input assembly 120, for housing a set 100 of electrodes (104, 106), and wherein takes place electrocoagulative treatment of the contaminated water 13, for forming electrocoagulatively treated contaminated water 19; and (c) a reactor housing output assembly 124, operatively connected to the electrocoagulation reactor housing assembly 102, for receiving and outputting the electrocoagulatively treated contaminated water 19.

As for electrocoagulative water contaminant removal system 10, in electrocoagulation reactor unit 16, electrocoagulation reactor housing assembly 102 has therein: (i) a lower pair of electrode positioning, spacing, and holding elements (220a, 220b), integrally configured and oppositely facing each other along lower sections (240a, 240b, respectively) of two oppositely facing walls of the electrocoagulation reactor housing assembly 102, and (ii) a complementary upper pair of electrode positioning, spacing, and holding elements (230a, 230b), removably and replaceably configured and oppositely facing each other along upper sections (246a, 246b, respectively) of the two oppositely facing walls of the electrocoagulation reactor housing assembly 102.

Additionally, as for electrocoagulative water contaminant removal system 10, in electrocoagulation reactor unit 16, electrocoagulation reactor housing assembly 102, particularly reactor housing bottom section 102b therein, also includes the additional main components of: a lower pair of integrally configured and oppositely facing electrode positioning, spacing, and holding elements 220a and 220b, and a complementary upper pair of removably and replaceably configured and oppositely facing electrode positioning, spacing, and holding elements 230a and 230b, as particularly shown in FIG. 3, and in FIGS. 4-6.

Assemblies, sub-assemblies, mechanisms, structures, components, elements, and configurations, and, peripheral equipment, utilities, accessories, chemical reagents, and materials, steps or procedures, sub-steps or sub-procedures, as well as operation, and implementation, of exemplary embodiments, alternative embodiments, specific configurations, and, additional and optional aspects, characteristics, or features, thereof, of the electrocoagulation reactor unit 16 and main components thereof; for electrocoagulatively treating contaminated water, according to embodiments of the present invention, are fully provided hereinabove in the context of the illustrative description and accompanying drawings of the electrocoagulative water removal system 10 and main components thereof (i.e., particularly, the electrocoagulation reactor unit, and the primary sedimentation column) for electrocoagulatively removing contaminants from contaminated water, according to embodiments of the present invention.

By way of the output unit being a main component, and sub-combination of the electrocoagulative water contaminant removal system, the present invention also features another device, corresponding to the (first or primary) sedimentation, settling, or [water] clarification column (Primary Sedimentation Column (SC1)) of the output unit, for separating solid and solid-like electrocoagulation reaction products out from electrocoagulatively treated contaminated water.

Thus, with reference to FIGS. 1, 10, and 11, another main aspect of the present invention is provision of a sedimentation, settling, or [water] clarification column 302 for separating solid and solid-like electrocoagulation reaction products out from electrocoagulatively treated contaminated water 19, including the following main components and functionalities thereof: (a) a first sediments-water separator assembly 340, for (i) receiving and separating the electrocoagulatively treated contaminated water 19 into a first portion of sludge 342, and a first portion of water-with-sediments 344, and (ii) separating the first portion of water-with-sediments 344 into a second portion of water-with-sediments 346, and a portion of cleaned water 348; and (b) a second sediments-water separator assembly 360, for receiving and separating the second portion of water-with-sediments 346 into a second portion of sludge 362, and partially cleaned water 364.

Assemblies, sub-assemblies, mechanisms, structures, components, elements, and configurations, and, peripheral equipment, utilities, accessories, chemical reagents, and materials, steps or procedures, sub-steps or sub-procedures, as well as operation, and implementation, of exemplary embodiments, alternative embodiments, specific configurations, and, additional and optional aspects, characteristics, or features, thereof, of the sedimentation, settling, or [water] clarification column 302 and main components thereof, for separating solid and solid-like electrocoagulation reaction products out from electrocoagulatively treated contaminated water, according to embodiments of the present invention, are fully provided hereinabove in the context of the illustrative description and accompanying drawings of the overall electrocoagulative water removal system 10 and main components thereof (i.e., particularly, the electrocoagulation reactor unit, and the primary sedimentation column) for electrocoagulatively removing contaminants from contaminated water, according to embodiments of the present invention.

The present invention, as illustratively described and exemplified hereinabove, has several beneficial and advantageous aspects, characteristics, and features.

The present invention of the electrocoagulative water contaminant removal system, and of the two main components thereof, being an electrocoagulation reactor unit, and a (‘gravity type’, primary) sedimentation column, are particularly applicable to electrocoagulatively removing contaminants from contaminated water. The two main components, namely, an electrocoagulation reactor unit, and a (‘gravity type’, primary) sedimentation column, although included and operative as integral parts of the electrocoagulative water contaminant removal system of the present invention, can also be included and operative, either singly or in combination, as parts of other electrocoagulative water contaminant removal systems.

The present invention is particularly applicable for electrocoagulatively removing contaminants from contaminated water produced during a high volume throughput (for example, on the order of at least about 1000 liters per hour (l/hr) [1 cubic meter per hour (m³/hr)]) commercial scale industrial process, involving, for example, metallic electro-etching, plating, or coating, of materials or components; manufacturing of electrical, electronic, or semiconductor, materials or components; mining or/and processing of minerals or metals; or, manufacturing or/and processing of pulp or paper. The present invention, although particularly directed to, and applicable for, removing heavy metal type contaminants composed of or including heavy metals (such as chromium, copper, nickel, zinc, tin, antimony, lead, manganese, and cadmium) from contaminated water, is also directed to, and applicable for, removing non-metallic type contaminants composed of or including non-metals (such as organic chemical species [e.g., hydrocarbons—oils, fats, greases] or/and biological species [e.g., microorganisms—bacteria]) from contaminated water. The present invention is readily commercially applicable, practical, and economically feasible to implement.

The scope, and fields or areas of application, of the present invention, are directed to appropriately addressing, and overcoming, several significant problems or limitations relating to design, construction, and operation, of and within an electrocoagulation reactor housing assembly included in an electrocoagulation reactor unit, and, of and within a ‘gravity-type’ sedimentation, settling, or [water] clarification, column, of an overall electrocoagulative water contaminant removal system. Specifically, three specific significant problems or limitations associated with current teachings of electrocoagulatively removing contaminants from contaminated water, which are appropriately addressed and overcome by the present invention, relate to: (1) impractical or/and process interfering configurations of positioning, spacing, and holding electrodes inside an electrocoagulation reactor housing assembly, (2) existence of electrocoagulatively unreactive zones inside an electrocoagulation reactor housing assembly (containing electrodes), and (3) inefficient structure and operation (limited separation performance, efficiency) of a ‘gravity-type’ sedimentation, settling, or [water] clarification, column.

The present invention successfully addresses and overcomes various shortcomings and problems or limitations, and widens the scope, of currently known techniques in the relevant fields and arts of the invention, as relating to electrocoagulatively, removing contaminants from contaminated water.

The present invention is readily commercially applicable to a wide variety of different industries.

It is to be fully understood that certain aspects, characteristics, and features, of the present invention, which are illustratively described and presented in the context or format of a plurality of separate embodiments, may also be illustratively described and presented in any suitable combination or sub-combination in the context or format of a single embodiment. Conversely, various aspects, characteristics, and features, of the present invention, which are illustratively described and presented in combination or sub-combination in the context or format of a single embodiment, may also be illustratively described and presented in the context or format of a plurality of separate embodiments.

Although the present invention has been illustratively described and presented by way of specific exemplary embodiments, and examples thereof, it is evident that many alternatives, modifications, and variations, thereof, will be apparent to those skilled in the art. Accordingly, it is intended that all such alternatives, modifications, and variations, fall within, and are encompassed by, the scope of the appended claims.

All patents, patent applications, and publications, cited or referred to in this specification are herein incorporated in their entirety by reference into the specification, to the same extent as if each individual patent, patent application, or publication, was specifically and individually indicated to be incorporated herein by reference. In addition, citation or identification of any reference in this specification shall not be construed or understood as an admission that such reference represents or corresponds to prior art of the present invention.

### REFERENCES

1. Wikipedia® web page, http:/en.wikipedia.org/wiki/Electrocoagulation, last modified on Feb. 25, 2008, as viewed on Apr. 25, 2008, for: search and GO of ‘electrocoagulation’.
2. Powell Water Systems, Inc. (Colorado, USA) web page, http://www.powellwater.com/, web page section link entitled: “Electrocoagulation Technology”, as viewed on Apr. 25, 2008.
3. U.S. Pat. Appl. Pub. No. 2007-0017874, “Effluent Treatment Method And Apparatus”, Renaud, C. P., et al.
4. U.S. Pat. No. 6,800,206, “Electrolysis Based Water Treatment”, Robinson.
5. U.S. Pat. Appl. Pub. No. 2007-006826, “Electrocoagulation Reactor”, Morkovsky, et al.
6. U.S. Pat. Appl. Pub. No. 2004-0079650, “Electrocoagulation Reactor”, Morkovsky, et al.
7. U.S. Pat. No. 6,663,783, “Electrochemical Cell For Removing Contaminants From A Wastewater Stream”, Stephenson, et al.
8. U.S. Pat. No. 6,797,179, “Method For Removing Dissolved Metals From Wastewater By Electrocoagulation”, Arnaud.
9. U.S. Pat. No. 6,582,592, “Apparatus For Removing Dissolved Metals From Wastewater By Electrocoagulation”, Arnaud.
10. U.S. Pat. Appl. Pub. No. 2005-0230321, “Apparatus And Process For Treating Effluents”, Berrak, A., et al.
11. U.S. Pat. No. 6,719,894, “Process For Electrocoagulating Waste Fluids”, Gavrel, et al.
12. U.S. Pat. Appl. Pub. No. 2007-0131621, “Method And System For Treating Radioactive Waste Water”, Denton, M. S.
13. U.S. Pat. No. 6,689,271, “Process And Apparatus For Electrocoagulative Treatment Of Industrial Waste Water”, Morkovsky, et al.
14. U.S. Pat. No. 6,294,061, “Process And Apparatus For Electrocoagulative Treatment Of Industrial Waste Water”, Morkovsky, et al.
15. U.S. Pat. No. 5,928,493, “Process And Apparatus For Electrocoagulative Treatment Of Industrial Waste Water”, Morkovsky, et al.
16. U.S. Pat. No. 7,211,185, “Method And Apparatus For Electrocoagulation Of Liquids”, Powell.
17. U.S. Pat. No. 6,139,710, “Apparatus For Electrocoagulation Of Liquids”, Powell.
18. U.S. Pat. Appl. Pub. No. 2007-0199868, “Wastewater Purification Method”, Volpe.
19. U.S. Pat. Appl. Pub. No. 2006-0096853, “Electrocoagulation System”, King.
20. U.S. Pat. No. 6,846,393, “Electrolysis Cells”, King.
21. U.S. Pat. Appl. Pub. No. 2005-0224338, “Water Treatment Reactor For Simultaneous Electrocoagulation And Advanced Oxidation Processes”, Kin, Kon-Tsu, et al.
22. U.S. Pat. No. 6,866,757, “Electrocoagulation Reaction Chamber And Method”, Gilmore.
23. U.S. Pat. No. 6,746,593, “High Volume Electrolytic Water Treatment System And Process For Treating Wastewater”, Herbst.
24. U.S. Pat. No. 6,613,202, “Tank Batch Electrochemical Water Treatment Process, Herbst.
25. U.S. Pat. No. 6,241,861, “Waste Water Treatment Tank Using An Electrochemical Treatment Process”, Herbst.
26. U.S. Pat. No. 5,611,907, “Electrolytic Treatment Device And Method For Using Same”, Herbst, et al.
27. U.S. Pat. No. 5,043,050, “Electrolytic Treatment Apparatus”, Herbst.
28. U.S. Pat. No. 4,872,959, “Electrolytic Treatment Of Liquids”, Herbst, et al.
29. U.S. Pat. No. 5,879,546, “Water Purification And Recovery System”, Buford.
30. U.S. Pat. No. 5,558,755, “Method For Removing Contaminants From An Aqueous Medium”, Gardner-Clayson, et al.
31. U.S. Pat. No. 5,372,690, “Apparatus For Removing Contaminants From An Aqueous Medium”, Gardner-Clayson, et al.

What is claimed is:

1. A system for electrocoagulatively removing contaminants from contaminated water, comprising:
an input unit, suitable for receiving and transporting the contaminated water;
an electrocoagulation reactor unit operatively connected to said input unit, suitable for receiving and electrocoagulatively treating the contaminated water, for forming electrocoagulatively treated contaminated water;
an output unit operatively connected to said electrocoagulation reactor unit, suitable for receiving and transporting said electrocoagulatively treated contaminated water, and for separating solid and solid-like electrocoagulation reaction products out from said electrocoagulatively treated contaminated water, for forming sludge and cleaned water; and
a power supply and process control unit, suitable for supplying power to, and controlling processes of, said input unit, said electrocoagulation reactor unit, and said output unit;
wherein said electrocoagulation reactor unit includes an electrocoagulation reactor housing assembly having therein: (i) a lower pair of electrode positioning, spacing, and holding elements, integrally configured and oppositely facing each other along lower sections of two oppositely facing walls of said electrocoagulation reactor housing assembly, and (ii) a complementary upper pair of electrode positioning, spacing, and holding elements, removably and replaceably configured and oppositely facing each other along upper sections of said two oppositely facing walls of said electrocoagulation reactor housing assembly.

2. The system of claim 1, wherein said integrally configured lower pair of electrode positioning, spacing, and holding elements, and, said complementary removably and replaceably configured upper pair of electrode positioning, spacing, and holding elements, are made of non-conductive materials.

3. The system of claim 1, wherein said integrally configured lower pair of electrode positioning, spacing, and holding elements, includes grooves for positioning, spacing, and holding electrodes at electrode bottom end portions thereof.

4. The system of claim 1, wherein said removably and replaceably configured upper pair of electrode positioning, spacing, and holding elements, includes grooves for positioning, spacing, and holding electrodes at electrode top end portions thereof.

5. The system of claim 1, wherein said integrally configured lower pair of electrode positioning, spacing, and holding elements, and, said complementary removably and replaceably configured upper pair of electrode positioning, spacing, and holding elements, are for positioning, spacing, and holding electrodes with electrode faces vertically lined up in parallel from one end side wall to an opposite end side wall within said electrocoagulation reactor housing assembly.

6. The system of claim 1, wherein said electrocoagulation reactor housing assembly has therein an end wall-electrode or electrode-end wall electrocoagulatively unreactive sub-region, wherein each of two individual water non-flowing and non-contacting zones in said unreactive sub-region comprises a non-conductive, non-charged interior face of one end side wall configured flush against and directly contacting adjacent, nearest-neighboring, parallel and oppositely facing, and charged, face of an adjacent, nearest-neighboring, parallel and oppositely facing, and charged, monopolar electrode, thereby preventing the contaminated water and said electrocoagulatively treated contaminated water from flowing and making contact therebetween.

7. The system of claim 1, wherein said output unit includes at least one gravity-type sedimentation, settling, or [water] clarification column, suitable for effecting said separating solid and solid-like electrocoagulation reaction products out from said electrocoagulatively treated contaminated water.

8. The system of claim 7, wherein a said sedimentation, settling, or [water] clarification column is suitable for: (i) receiving and separating said electrocoagulatively treated contaminated water into a first portion of sludge, and a first portion of water-with-sediments, (ii) separating said first portion of water-with-sediments into a second portion of water-with-sediments, and a portion of cleaned water, and (iii) separating said second portion of water-with-sediments into a second portion of sludge, and partially cleaned water.

9. The system of claim 7, wherein a said sedimentation, settling, or [water] clarification column includes:
a first sediments-water separator assembly, suitable for (i) receiving and separating said electrocoagulatively treated contaminated water into a first portion of sludge, and a first portion of water-with-sediments, and (ii) separating said first portion of water-with-sediments into a second portion of water-with-sediments, and a portion of cleaned water; and
a second sediments-water separator assembly, suitable for receiving and separating said second portion of water-with-sediments into a second portion of sludge, and partially cleaned water.

10. The system of claim 7, wherein a said sedimentation, settling, or [water] clarification column includes a sediments-water separator assembly having a water/sediments distributor assembly suitable for receiving, and, laterally and circularly distributing said electrocoagulatively treated contaminated water throughout bottom section of said sediments-water separator assembly.

11. The system of claim 10, wherein said water/sediments distributor assembly is configured as a cylindrical geometrical shape or form.

12. The system of claim 10, wherein said water/sediments distributor assembly includes a plurality of water distributing elements suitable for effecting said distributing said electrocoagulatively treated contaminated water throughout said bottom section of said sediments-water separator assembly.

13. The system of claim 12, wherein said water distributing elements are angularly spaced apart from each other.

14. The system of claim 12, wherein said water distributing elements are structurally fixed and, rigid or/and flexible.

15. The system of claim 12, wherein said water distributing elements are hollow cylindrical or tubular geometrically shaped or formed.

16. The system of claim 12, wherein open end portions of two adjacent, nearest-neighboring said water distributing elements are spaced apart by an angle of at least about 10 degrees.

17. The system of claim 7, wherein a said sedimentation, settling, or [water] clarification column includes a sediments-water separator assembly having a downward flow multi-conduit assembly suitable for receiving a portion of water-with-sediments of said electrocoagulatively treated contaminated water, and, for directing downward flow of said portion of water-with-sediments to bottom section of said sediments-water separator assembly.

18. The system of claim 9, wherein said first sediments-water separator assembly includes a water/sediments distributor assembly suitable for receiving, and, laterally and circularly distributing said electrocoagulatively treated contaminated water throughout bottom section of said first sediments-water separator assembly.

19. The system of claim 18, wherein said water/sediments distributor assembly includes a plurality of water distributing elements suitable for effecting said distributing said electrocoagulatively treated contaminated water throughout said bottom section of said first sediments-water separator assembly.

20. The system of claim 9, wherein said second sediments-water separator assembly includes a downward flow multi-conduit assembly suitable for effecting said receiving said second portion of water-with-sediments, and, for directing downward flow of said second portion of water-with-sediments to bottom section of said second sediments-water separator assembly.

21. The system of claim 8, wherein an additional said sedimentation, settling, or [water] clarification column is suitable for receiving and separating said partially cleaned water into a third portion of sludge, and an additional portion of cleaned water.

22. The system of claim 21, wherein said additional sedimentation, settling, or [water] clarification column includes a sludge collection assembly suitable for effecting said separating said partially cleaned water into said third portion of sludge, and said additional portion of cleaned water.

23. The system of claim 1, wherein said output unit includes two gravity-type sedimentation, settling, or [water] clarification columns, suitable for effecting said separating solid and solid-like electrocoagulation reaction products out from said electrocoagulatively treated contaminated water.

24. The system of claim 23, wherein a first or primary said sedimentation, settling, or [water] clarification column is suitable for: (i) receiving and separating said electrocoagulatively treated contaminated water into a first portion of sludge, and a first portion of water-with-sediments, (ii) separating said first portion of water-with-sediments into a second portion of water-with-sediments, and a first portion of cleaned water, and (iii) separating said second portion of water-with-sediments into a second portion of sludge, and partially cleaned water.

25. The system of claim 23, wherein a first or primary said sedimentation, settling, or [water] clarification column includes:
a first sediments-water separator assembly, suitable for (i) receiving and separating said electrocoagulatively treated contaminated water into a first portion of sludge, and a first portion of water-with-sediments, and (ii) separating said first portion of water-with-sediments into a second portion of water-with-sediments, and a portion of cleaned water; and
a second sediments-water separator assembly, suitable for receiving and separating said second portion of water-with-sediments into a second portion of sludge, and partially cleaned water.

26. The system of claim 23, wherein a first or primary said sedimentation, settling, or [water] clarification column includes a sediments-water separator assembly having a water/sediments distributor assembly suitable for receiving, and, laterally and circularly distributing said electrocoagulatively treated contaminated water throughout bottom section of said sediments-water separator assembly.

27. The system of claim 26, wherein said water/sediments distributor assembly includes a plurality of water distributing elements suitable for effecting said distributing said electrocoagulatively treated contaminated water throughout said bottom section of said sediments-water separator assembly.

28. The system of claim 23, wherein a first or primary said sedimentation, settling, or [water] clarification column includes a sediments-water separator assembly having a downward flow multi-conduit assembly suitable for receiving a portion of water-with-sediments of said electrocoagulatively treated contaminated water, and, for directing downward flow of said portion of water-with-sediments to bottom section of said sediments-water separator assembly.

29. The system of claim 25, wherein said first sediments-water separator assembly includes a water/sediments distributor assembly suitable for receiving, and, laterally and circularly distributing said electrocoagulatively treated contaminated water throughout bottom section of said first sediments-water separator assembly.

30. The system of claim 29, wherein said water/sediments distributor assembly includes a plurality of water distributing elements suitable for effecting said distributing said electrocoagulatively treated contaminated water throughout said bottom section of said first sediments-water separator assembly.

31. The system of claim 25, wherein said second sediments-water separator assembly includes a downward flow multi-conduit assembly suitable for effecting said receiving said second portion of water-with-sediments, and, for directing downward flow of said second portion of water-with-sediments to bottom section of said second sediments-water separator assembly.

32. The system of claim 24, wherein a second or secondary said sedimentation, settling, or [water] clarification column is suitable for receiving and separating said partially cleaned water into a third portion of sludge, and a second portion of cleaned water.

33. The system of claim 32, wherein said second or secondary sedimentation, settling, or [water] clarification column includes a sludge collection assembly suitable for effecting said separating said partially cleaned water into said third portion of sludge, and said second portion of cleaned water.

34. An electrocoagulation reactor unit for electrocoagulatively treating contaminated water, comprising:
a reactor housing input assembly, suitable for receiving the contaminated water;
an electrocoagulation reactor housing assembly operatively connected to said reactor housing input assembly, suitable for housing a set of electrodes, and wherein takes place electrocoagulative treatment of the contaminated water, for forming electrocoagulatively treated contaminated water; and
a reactor housing output assembly, operatively connected to said electrocoagulation reactor housing assembly, suitable for receiving and outputting said electrocoagulatively treated contaminated water;
wherein said electrocoagulation reactor housing assembly includes: (i) a lower pair of electrode positioning, spacing, and holding elements, integrally configured and oppositely facing each other along lower sections of two oppositely facing walls of said electrocoagulation reactor housing assembly, and (ii) a complementary upper pair of electrode positioning, spacing, and holding elements, replaceably configured and oppositely facing each other along upper sections of said two oppositely facing walls of said electrocoagulation reactor housing assembly.

35. The electrocoagulation reactor unit of claim 34, wherein said integrally configured lower pair of electrode positioning, spacing, and holding elements, and, said complementary removably and replaceably configured upper pair of electrode positioning, spacing, and holding elements, are made of non-conductive materials.

36. The electrocoagulation reactor unit of claim 34, wherein said integrally configured lower pair of electrode positioning, spacing, and holding elements, includes grooves for positioning, spacing, and holding electrodes at electrode bottom end portions thereof.

37. The electrocoagulation reactor unit of claim 34, wherein said removably and replaceably configured upper pair of electrode positioning, spacing, and holding elements, includes grooves for positioning, spacing, and holding electrodes at electrode top end portions thereof.

38. The electrocoagulation reactor unit of claim 34, wherein said integrally configured lower pair of electrode positioning, spacing, and holding elements, and, said complementary removably and replaceably configured upper pair of electrode positioning, spacing, and holding elements, are for positioning, spacing, and holding electrodes with electrode faces vertically lined up in parallel from one end side wall to an opposite end side wall within said electrocoagulation reactor housing assembly.

39. The electrocoagulation reactor unit of claim 34, wherein said electrocoagulation reactor housing assembly has therein an end wall-electrode or electrode-end wall electrocoagulatively unreactive sub-region, wherein each of two individual water ‘non-flowing’ and ‘non-contacting’ zones in said unreactive sub-region comprises a non-conductive, non-charged interior face of one end side wall configured flush against and directly contacting adjacent, nearest-neighboring, parallel and oppositely facing, and charged, face of an adjacent, nearest-neighboring, parallel and oppositely facing, and charged, monopolar electrode, thereby preventing the contaminated water and said electrocoagulatively treated contaminated water from flowing and making contact therebetween.

40. A sedimentation, settling, or [water] clarification column for separating solid and solid-like electrocoagulation reaction products out from electrocoagulatively treated contaminated water, comprising:
a first sediments-water separator assembly, suitable for (i) receiving and separating the electrocoagulatively treated contaminated water into a first portion of sludge, and a first portion of water-with-sediments, and (ii) separating said first portion of water-with-sediments into a second portion of water-with-sediments, and a portion of cleaned water; and
a second sediments-water separator assembly, suitable for receiving and separating said second portion of water-with-sediments into a second portion of sludge, and partially cleaned water.

41. The sedimentation column of claim 40, wherein said first sediments-water separator assembly includes a water/sediments distributor assembly suitable for receiving, and, laterally and circularly distributing the electrocoagulatively treated contaminated water throughout bottom section of said first sediments-water separator assembly.

42. The sedimentation column of claim 41, wherein said water/sediments distributor assembly includes a plurality of water distributing elements suitable for effecting said distributing the electrocoagulatively treated contaminated water throughout said bottom section of said first sediments-water separator assembly.

43. The sedimentation column of claim 42, wherein said water distributing elements are angularly spaced apart from each other.

44. The sedimentation column of claim 42, wherein said water distributing elements are structurally fixed and, rigid or/and flexible.

45. The sedimentation column of claim 42, wherein said water distributing elements are hollow cylindrical or tubular geometrically shaped or formed.

46. The sedimentation column of claim 42, wherein open end portions of two adjacent, nearest-neighboring said water distributing elements are spaced apart by an angle of at least about 10 degrees.

47. The sedimentation column of claim 40, wherein said second sediments-water separator assembly includes a downward flow multi-conduit assembly suitable for effecting said receiving said second portion of water-with-sediments, and, for directing downward flow of said second portion of water-with-sediments to bottom section of said second sediments-water separator assembly.
